(19) United States
(12) Patent Application Publication
(10) Pub. No.: US 2024/0392220 A1
(43) Pub. Date: Nov. 28, 2024

(54) BRANDY REPLICAS

(71) Applicant: Ava Food Labs, Inc., San Francisco, CA (US)

(72) Inventors: Daniel Assad Saad, Dallas, TX (US); Samuel Ryo, Singapore (SG); Lucas Baker, San Francisco, CA (US); Mardonn Carl Chua, Ann Arbor, MI (US); Lindsay Loretta Smith, San Francisco, CA (US)

(21) Appl. No.: 18/696,600

(22) PCT Filed: Sep. 28, 2022
(86) PCT No.: PCT/US2022/045041

§ 371 Date: Mar. 28, 2024

Related U.S. Application Data
(60) Provisional application No. 63/249,462, filed on Sep. 28, 2021.

(51) Int. Cl. C12G 3/07

(52) U.S. Cl. CPC C12G 3/07

(57) ABSTRACT

Materials and methods for producing brandy-like alcoholic beverages from individual components (e.g., brandy replicas that contain individually added volatile and non-volatile organic compounds) are provided herein.

### CROSS-REFERENCE TO RELATED APPLICATIONS

This application claims priority from U.S. Provisional Application Ser. No. 63/249,462, filed Sep. 28, 2021. The disclosure of the prior application is considered part of (and is incorporated by reference in) the disclosure of this application.

### TECHNICAL FIELD

This document relates to materials and methods for producing brandy-like alcoholic beverages that contain individually added volatile components.

### BACKGROUND

The term “brandy” generally refers to a distilled spirit made from fermented fruit juice. Brandy can be made using grapes or any other suitable fruit (e.g., apples, apricots, cherries, or pears). Brandy typically is 40 to 50 percent alcohol by volume (ABV), although the alcohol content can vary depending on the type of brandy. Traditional methods for producing brandy can be lengthy and costly, involving the harvesting of particular crops, followed by processing, fermenting, distilling, and aging (usually in oak barrels). Each component of the traditional process for making brandy can have an inherent variability and risk, including climate, crop disease, and contamination, which can render such methods and their resulting products inconsistent from batch to batch and year to year.

Going forward in this document, the term “brandy” refers to both “brandy” and “brandy” spirits.

### SUMMARY

This document is based, at least in part, on the identification of compounds that contribute to the flavor and aroma of various types of brandy, and on the development of methods for combining those compounds to yield brandy replicas that have the taste, aroma, and other characteristics of traditionally generated brandies. Because each ingredient is added individually, the methods disclosed herein reduce many of the risks and variability associated with traditional brandy production. The methods also can provide nearly infinite reproducibility of a recipe, which is not possible with traditional production methods. Further, the methods described herein allow for unique flexibility in optimization of the flavors, aromas, and textures of brandies of various types (e.g., more traditional grape brandies, or brandies made from other types of fruit), and greatly reduce or even eliminate the possibility that the resulting beverage will contain detrimental or undesired components. Moreover, the methods disclosed herein differ from currently existing methods in that they are rapid, reproducible, and cost-effective.

In a first aspect, this document features an alcoholic beverage. The alcoholic beverage can be a brandy replica. In some aspects, the brandy replica can include (or consist essentially of or consist of) water, a grain neutral spirit, an oak extract, one or more tannins, or an oak extract and one or more tannins, fruit juice, and at least six added volatile compounds (VOCs), where the added VOCs include at least one ester, at least one additional alcohol, at least one aldehyde or ketone, and at least one terpene or isoprenoid, and where the added VOCs include about 0.001 wt % to about 0.1 wt % of the brandy replica. The brandy replica can further include a traditional brandy, where the brandy replica includes no more than about 10 wt % of the traditional brandy. The at least one ester can include one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate. The at least one ester can include one or more of ethyl acetate, ethyl laurate, phenethyl acetate, and tetrahydrofurfuryl acetate. The at least one ester can include one or more of butyl isobutyrate, ethyl butyrate, hexyl 2-methylbutanoate, isobutyl isobutyrate, isobutyl propionate, and propyl acetate. The at least one aldehyde or ketone can include one or more of phenylacetaldehyde, 2,3-pentanedione, 2-heptanone, and methylcyclopentenolone. The at least one aldehyde or ketone can include 2,3-pentanedione. The at least one aldehyde or ketone can include 2-heptanone. The at least one additional alcohol can include one or both of isoamyl alcohol and phenethyl alcohol. The at least one additional alcohol can include phenethyl alcohol. The at least one additional alcohol can include isoamyl alcohol. The at least one terpene or isoprenoid can include linalool. The added VOCs further can include at least one furan, at least one acid, at least one phenol, or a combination thereof. The at least one furan can include 2-pentylfuran. The at least one acid can include butyric acid. The at least one phenol can include eugenol. The added VOCs can include at least one ester, at least one additional alcohol, at least one aldehyde or ketone, at least one terpene or isoprenoid, at least one phenol, and at least one furan. The added VOCs can include ethyl laurate, phenethyl alcohol, 2-pentylfuran, linalool, 2,3-pentanedione, eugenol, and ethyl acetate. The added VOCs can include at least one ester, at least one acid, at least one additional alcohol, at least one aldehyde or ketone, and at least one terpene or isoprenoid. The added VOCs can include propyl acetate, ethyl butyrate, isobutyl isobutyrate, hexyl 2-methylbutanoate, butyl isobutyrate, 2-heptanone, linalool, butyric acid, and isoamyl alcohol.

In some cases, the brandy replica can include at least one added non-volatile compound. The at least one added non-volatile compound can include a color compound. The at least one added non-volatile compound is selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole. The at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin. The at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin. The at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

In some cases, the brandy replica can include from about 5 wt % to about 70 wt % water, from about 30 wt % to about 95 wt % grain neutral spirits, from about 0.5 wt % to about 10 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs.

In another aspect, this document features a brandy replica that includes (or consists essentially of or consists of) water, a grain neutral spirit, an oak extract, one or more tannins, or an oak extract and one or more tannins, fruit juice, and at least six added VOCs, where the added VOCs include about 0.001 wt % to about 0.1 wt % of the brandy replica. In some cases, the brandy replica can further include a traditional brandy, where the brandy replica includes no more than about 10 wt % of the traditional brandy. The added VOCs can include at least one VOC selected from the group consisting of tetrahydrofurfuryl acetate, isobutyl propionate, isobutyl isobutyrate, hexyl 2-methylbutanoate, butyl isobutyrate, and 2-pentylfuran. The added VOCs can include phenethyl alcohol, where the phenethyl alcohol is present in the brandy replica at a concentration less than about 1.28 mg/L. The added VOCs can include 2,3-pentanedione, where the 2,3-pentanedione is present in the brandy replica at a concentration less than about 0.17 mg/L. The added VOCs can include butyric acid, where the butyric acid is present in the brandy replica at a concentration less than about 0.16 mg/L. The added VOCs can include propyl acetate, where the propyl acetate is present in the brandy replica at a concentration of at least about 0.75 mg/L. The added VOCs can include ethyl butyrate, where the ethyl butyrate is present in the brandy replica at a concentration of at least about 5 mg/L. The added VOCs can include 2-heptanone, where the 2-heptanone is present in the brandy replica at a concentration of at least about 0.03 mg/L. The added VOCs can include propyl acetate, where the brandy replica includes at least about 0.018% by mass of the propyl acetate. The added VOCs can include ethyl butyrate, where the brandy replica includes at least about 0.11% by mass of the ethyl butyrate. The added VOCs can include 2-heptanone, where the brandy replica includes at least about 0.00068% by mass of the 2-heptanone. The added VOCs can include eugenol, where the brandy replica includes at least about 0.007% by mass of the eugenol.

In some cases, the brandy replica can include an added non-volatile compound. The added non-volatile compound can include trehalose, where the trehalose is present in the brandy replica at a concentration less than about 6.67 mg/L. The added non-volatile compound can include 3-hydroxy-2-methylpyridine, where the 3-hydroxy-2-methylpyridine is present in the brandy replica at a concentration of at least about 0.18 mg/L. The added non-volatile compound can include 3-hydroxy-2-methylpyridine, where the brandy replica includes at least about 0.01% by mass of the 3-hydroxy-2-methylpyridine. The added non-volatile compound can include 4-methyl-2,3-dihydro-1H-pyrrolo[3,4-c]-quinoline, where the brandy replica includes at least about 0.00145% by mass of the 4-methyl-2,3-dihydro-1H-pyrrolo[3,4-c]-quinoline. The added non-volatile compound can include azobenzene, where the brandy replica includes at least about 0.04% by mass of the azobenzene. The added non-volatile compound can include furaneol, where the brandy replica includes at least about 0.07% by mass of the furaneol. The added non-volatile compound can include 2,3-isopropylidene-D-ribonolactone, where the brandy replica includes at least about 0.02% by mass of the 2,3-isopropylidene-D-ribonolactone. The added non-volatile compound can include homovanillic acid, where the brandy replica includes at least about 0.05% by mass of the homovanillic acid.

In another aspect, this document features a method for making a brandy replica. In some cases, the method for making a brandy replica can include (or consist essentially of or consist of) combining water, a grain neutral spirit, an oak extract, a tannin, or an oak extract and a tannin, a fruit juice, at least six VOCs, where the VOCs are provided as separate ingredients and include at least one ester, at least one additional alcohol, at least one aldehyde or ketone, at least one terpene or isoprenoid, and where the added VOCs include about 0.001 wt % to about 0.1 wt % of the brandy replica, and optionally, a traditional brandy, such that the brandy replica includes no more than about 10 wt % of the traditional brandy. The at least one ester can include one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate. The at least one ester can include one or more of ethyl acetate, ethyl laurate, phenethyl acetate, and tetrahydrofurfuryl acetate. The at least one ester can include one or more of butyl isobutyrate, ethyl butyrate, hexyl 2-methylbutanoate, isobutyl isobutyrate, isobutyl propionate, and propyl acetate. The at least one aldehyde or ketone can include one or more of phenylacetaldehyde, 2,3-pentanedione, 2-heptanone, and methylcyclopentenolone. The at least one aldehyde or ketone can include 2,3-pentanedione. The at least one aldehyde or ketone can include 2-heptanone. The at least one additional alcohol can include one or both of isoamyl alcohol and phenethyl alcohol. The at least one additional alcohol can include phenethyl alcohol. The at least one additional alcohol can include isoamyl alcohol. The at least one terpene or isoprenoid can include linalool.

In some cases, the added VOCs can further include at least one furan, at least one acid, at least one phenol, or a combination thereof. The at least one furan can include 2-pentylfuran. The at least one acid can include butyric acid. The at least one phenol can include eugenol. The added VOCs can include at least one ester, at least one additional alcohol, at least one aldehyde or ketone, at least one terpene or isoprenoid, at least one phenol, and at least one furan. The added VOCs can include ethyl laurate, phenethyl alcohol, 2-pentylfuran, linalool, 2,3-pentanedione, eugenol, and ethyl acetate. The added VOCs can include at least one ester, at least one acid, at least one additional alcohol, at least one aldehyde or ketone, and at least one terpene or isoprenoid. The added VOCs can include propyl acetate, ethyl butyrate, isobutyl isobutyrate, hexyl 2-methylbutanoate, butyl isobutyrate, 2-heptanone, linalool, butyric acid, and isoamyl alcohol.

In some cases, the method can further include combining at least one added non-volatile compound with the water, grain neutral spirit, oak extract and/or tannin, fruit juice, at least six VOCs, and optional traditional brandy. The at least one added non-volatile compound can include a color compound. The at least one added non-volatile compound can be selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole. The at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin. The at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin. The at least one added non-volatile compound can be selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

In some cases, the brandy replica can further include from about 5 wt % to about 70 wt % water, from about 30 wt % to about 95 wt % grain neutral spirits, from about 0.5 wt % to about 10 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs.

In another aspect, this document features a method of making a brandy replica. In some cases, the method for making a brandy replica can include (or consist essentially of or consist of) combining water, a grain neutral spirit, an oak extract, a tannin, or an oak extract and a tannin, a fruit juice, at least six VOCs, where the VOCs are provided as separate ingredients and make up about 0.001 wt % to about 0.1 wt % of the brandy replica, and optionally, a traditional brandy, where the brandy replica includes no more than about 10 wt % of the traditional brandy. The added VOCs can include at least one VOC selected from the group consisting of tetrahydrofurfuryl acetate, isobutyl propionate, isobutyl isobutyrate, hexyl 2-methylbutanoate, butyl isobutyrate, and 2-pentylfuran. The added VOCs can include phenethyl alcohol, where the phenethyl alcohol is present in the brandy replica at a concentration less than about 1.28 mg/L. The added VOCs can include 2,3-pentanedione, where the 2,3-pentanedione is present in the brandy replica at a concentration less than about 0.17 mg/L. The added VOCs can include butyric acid, where the butyric acid is present in the brandy replica at a concentration less than about 0.16 mg/L. The added VOCs can include propyl acetate, where the propyl acetate is present in the brandy replica at a concentration of at least about 0.75 mg/L. The added VOCs can include ethyl butyrate, where the ethyl butyrate is present in the brandy replica at a concentration of at least about 5 mg/L. The added VOCs can include 2-heptanone, where the 2-heptanone is present in the brandy replica at a concentration of at least about 0.03 mg/L. The added VOCs can include propyl acetate, where the brandy replica includes at least about 0.018% by mass of the propyl acetate. The added VOCs can include ethyl butyrate, where the brandy replica includes at least about 0.11% by mass of the ethyl butyrate. The added VOCs can include 2-heptanone, where the brandy replica includes at least about 0.00068% by mass of the 2-heptanone. The added VOCs can include eugenol, where the brandy replica includes at least about 0.007% by mass of the eugenol.

In some cases, method can include combining an added non-volatile compound with the water, grain neutral spirit, oak extract and/or tannin, fruit juice, at least six VOCs, and optional traditional brandy. The added non-volatile compound can include trehalose, where the trehalose is present in the brandy replica at a concentration less than about 6.67 mg/L. The added non-volatile compound can include 3-hydroxy-2-methylpyridine, where the 3-hydroxy-2-methylpyridine is present in the brandy replica at a concentration of at least about 0.18 mg/L. The added non-volatile compound can include 3-hydroxy-2-methylpyridine, where the brandy replica includes at least about 0.01% by mass of the 3-hydroxy-2-methylpyridine. The added non-volatile compound can include 4-methyl-2,3-dihydro-1H-pyrrolo[3,4-c]-quinoline, where the brandy replica includes at least about 0.00145% by mass of the 4-methyl-2,3-dihydro-1H-pyrrolo[3,4-c]-quinoline. The added non-volatile compound can include azobenzene, wherein the brandy replica includes at least about 0.04% by mass of the azobenzene. The added non-volatile compound can include furaneol, where the brandy replica includes at least about 0.07% by mass of the furaneol. The added non-volatile compound can include 2,3-isopropylidene-D-ribonolactone, where the brandy replica includes at least about 0.02% by mass of the 2,3-isopropylidene-D-ribonolactone. The added non-volatile compound can include homovanillic acid, wherein the brandy replica includes at least about 0.05% by mass of the homovanillic acid.

In another aspect, this document features a brandy replica produced by any of the methods described herein.

In another aspect, this document features a brandy-like alcoholic beverage concentrate that includes (or consists essentially of or consists of) an oak extract, fruit juice, a tannin, at least six added VOCs that include at least one ester, at least one additional alcohol, at least one aldehyde or ketone, and at least one terpene or isoprenoid, where at least one of the added VOCs is present in a concentration of at least about 2-fold the concentration of the same VOC in a corresponding traditional brandy, and optionally, a traditional brandy, where the alcoholic beverage, after dilution to produce a final product, includes no more than about 10 wt % of the traditional brandy. At least one of the added VOCs can be present in the concentrate in a concentration of at least about 5-fold the concentration of the same VOCs in a corresponding traditional brandy. At least one of the added VOCs can be present in the concentrate in a concentration of at least about 10-fold the concentration of the same VOCs in a corresponding traditional brandy. At least one of the added VOCs can be present in the concentrate in a concentration of at least about 15-fold the concentration of the same VOCs in a corresponding traditional brandy. In some cases, upon dilution of the brandy-like beverage concentrate to a brandy-like alcoholic beverage, the brandy-like alcoholic beverage can be any of the brandy replicas described herein.

In another aspect, this document features a method of making a brandy-like alcoholic beverage concentrate, where the method includes (or consists essentially of or consists of) combining an oak extract, fruit juice, a tannin, at least six added VOCs that include at least one ester, at least one additional alcohol, at least one aldehyde or ketone, and at least one terpene or isoprenoid, where at least one of the added VOCs is present in a concentration of at least about 2-fold the concentration of the same VOC in a corresponding traditional brandy, and optionally, a traditional brandy, where the alcoholic beverage, after dilution to produce a final product, includes no more than about 10 wt % of the traditional brandy. At least one of the added VOCs can be present in the concentrate in a concentration of at least about 5-fold the concentration of the same VOCs in a corresponding traditional brandy. At least one of the added VOCs can be present in the concentrate in a concentration of at least about 10-fold the concentration of the same VOCs in a corresponding traditional brandy. At least one of the added VOCs can be present in the concentrate in a concentration of at least about 15-fold the concentration of the same VOCs in a corresponding traditional brandy. In some cases, upon dilution of the brandy-like beverage concentrate to a brandy-like alcoholic beverage, the brandy-like alcoholic beverage can be any of the brandy replicas described herein.

In another aspect, this document features an alcoholic beverage. The alcoholic beverage can comprise (or consist essentially of or consist of) water, a grain neutral spirit, a traditional brandy (where the alcoholic beverage contains no more than about 10 wt % of the traditional brandy), an oak extract, fruit juice, tannins, and at least six added volatile compounds (VOCs), wherein the added VOCs include at least one ester, at least one aldehyde, at least one furan, at least one additional alcohol, at least one terpene, and at least one ketone, and where the added VOCs make up about 0.001 wt % to about 0.1 wt % of the alcoholic beverage. The at least one ester can include one or more of phenethyl acetate, ethyl laurate, ethyl acetate, and tetrahydrofurfuryl acetate. The at least one aldehyde can include phenylacetaldehyde. The at least one furan can include 2-pentylfuran. The at least one additional alcohol can include one or both of phenethyl alcohol and eugenol. The at least one terpene can include linalool. The at least one ketone can include one or both of 2,3-pentanedione and methylcyclopentenolone. The added VOCs can include vanillin erythro and threo-butan-2,3-diol acetal. The alcoholic beverage can further include a color compound. In some cases, the added VOCs can include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In some cases, the alcoholic beverage can contain from about 5 wt % to about 70 wt % water, from about 30 wt % to about 95 wt % grain neutral spirits, not more than about 1 wt % brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs, where the added VOCs include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal. In some cases, the added VOCs can consist of phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In another aspect, this document features a method for making an alcoholic beverage. The method can comprise (or consist essentially of or consist of) combining water, a grain neutral spirit, a traditional brandy (where the alcoholic beverage contains no more than about 10 wt % of the traditional brandy), an oak extract, fruit juice, tannins, and at least six VOCs, where the VOCs are provided as separate ingredients and include at least one ester, at least one aldehyde, at least one furan, at least one additional alcohol, at least one terpene, and at least one ketone, and where the added VOCs make up about 0.001 wt % to about 0.1 wt % of the alcoholic beverage. The at least one ester can include one or more of phenethyl acetate, ethyl laurate, ethyl acetate, and tetrahydrofurfuryl acetate. The at least one aldehyde can include phenylacetaldehyde. The at least one furan can include 2-pentylfuran. The at least one additional alcohol can include one or both of phenethyl alcohol and eugenol. The at least one terpene can include linalool. The at least one ketone can include one or both of 2,3-pentanedione and methylcyclopentenolone. The added VOCs can include vanillin erythro and threo-butan-2,3-diol acetal. The method can further include adding a color compound. The added VOCs can include (or consist essentially of or consist of) phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In some cases, the alcoholic beverage produced by the method can contain from about 5 wt % to about 70 wt % water, from about 30 wt % to about 95 wt % grain neutral spirits, not more than about 1 wt % brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs, where the added VOCs include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal. In some cases, the added VOCs can consist of phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In another aspect, this document features an alcoholic beverage produced by a method that includes combining water, a grain neutral spirit, a traditional brandy (where the alcoholic beverage contains no more than about 10 wt % of the traditional brandy), an oak extract, fruit juice, tannins, and at least six VOCs, where the VOCs are provided as separate ingredients and include at least one ester, at least one aldehyde, at least one furan, at least one additional alcohol, at least one terpene, and at least one ketone, and where the added VOCs make up about 0.001 wt % to about 0.1 wt % of the alcoholic beverage. The at least one ester can include one or more of phenethyl acetate, ethyl laurate, ethyl acetate, and tetrahydrofurfuryl acetate. The at least one aldehyde can include phenylacetaldehyde. The at least one furan can include 2-pentylfuran. The at least one additional alcohol can include one or both of phenethyl alcohol and eugenol. The at least one terpene can include linalool. The at least one ketone can include one or both of 2,3-pentanedione and methylcyclopentenolone. The added VOCs can include vanillin erythro and threo-butan-2,3-diol acetal. The method can further include adding a color compound. The added VOCs can include (or consist essentially of or consist of) phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In some cases, the alcoholic beverage produced by the method can contain from about 5 wt % to about 70 wt % water, from about 30 wt % to about 95 wt % grain neutral spirits, not more than about 1 wt % brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs, where the added VOCs include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal. In some cases, the added VOCs can consist of phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In another aspect, this document features a brandy-like alcoholic beverage concentrate. The brandy-like alcoholic beverage concentrate can comprise (or consist essentially of or consist of) a traditional brandy (where the alcoholic beverage, after dilution to produce a final product, contains no more than about 10 wt % of the traditional brandy), an oak extract, fruit juice, tannins, and at least six added VOCs, where the added VOCs include at least one ester, at least one aldehyde, at least one furan, at least one additional alcohol, at least one terpene, and at least one ketone, and where at least one of the added VOCs is present in a concentration of at least about 2-fold the concentration of the same VOC in a corresponding traditional brandy. At least one of the added VOCs can be present in the concentrate in a concentration of at least about 5-fold the concentration of the same VOCs in a corresponding traditional brandy. At least one of the added VOCs can be present in the concentrate in a concentration of at least about 10-fold the concentration of the same VOCs in a corresponding traditional brandy. At least one of the added VOCs can be present in the concentrate in a concentration of at least about 15-fold the concentration of the same VOCs in a corresponding traditional brandy. Upon dilution of the brandy-like beverage concentrate to a brandy-like alcoholic beverage, the brandy-like alcoholic beverage can be an alcoholic beverage comprising (or consisting essentially of or consisting of) water, a grain neutral spirit, a traditional brandy (where the alcoholic beverage contains no more than about 10 wt % of the traditional brandy), an oak extract, fruit juice, tannins, and at least six added VOCs, where the added VOCs include at least one ester, at least one aldehyde, at least one furan, at least one additional alcohol, at least one terpene, and at least one ketone, and where the added VOCs make up about 0.001 wt % to about 0.1 wt % of the alcoholic beverage. The at least one ester can include one or more of phenethyl acetate, ethyl laurate, ethyl acetate, and tetrahydrofurfuryl acetate. The at least one aldehyde can include phenylacetaldehyde. The at least one furan can include 2-pentylfuran. The at least one additional alcohol can include one or both of phenethyl alcohol and eugenol. The at least one terpene can include linalool. The at least one ketone can include one or both of 2,3-pentanedione and methylcyclopentenolone. The added VOCs can include vanillin erythro and threo-butan-2,3-diol acetal. The alcoholic beverage can further include a color compound. In some cases, the added VOCs can include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

In still another aspect, this document features a method of making a brandy-like alcoholic beverage concentrate. The method can include (or consist essentially of or consist of) combining a traditional brandy (where the alcoholic beverage, after dilution to produce a final product, contains no more than about 10 wt % of the traditional brandy), an oak extract, fruit juice, tannins, and at least six added VOCs, where the added VOCs include at least one ester, at least one aldehyde, at least one furan, at least one additional alcohol, at least one terpene, and at least one ketone, and where at least one of the added VOCs is present in a concentration of at least about 2-fold the concentration of the same VOC in a corresponding traditional brandy. At least one of the added VOCs can be present in the concentrate in a concentration of at least about 5-fold the concentration of the same VOCs in a corresponding traditional brandy. At least one of the added VOCs can be present in the concentrate in a concentration of at least about 10-fold the concentration of the same VOCs in a corresponding traditional brandy. At least one of the added VOCs can be present in the concentrate in a concentration of at least about 15-fold the concentration of the same VOCs in a corresponding traditional brandy. Upon dilution of the brandy-like beverage concentrate to a brandy-like alcoholic beverage, the brandy-like alcoholic beverage can be an alcoholic beverage comprising (or consisting essentially of or consisting of) water, a grain neutral spirit, a traditional brandy (where the alcoholic beverage contains no more than about 10 wt % of the traditional brandy), an oak extract, fruit juice, tannins, and at least six added VOCs, where the added VOCs include at least one ester, at least one aldehyde, at least one furan, at least one additional alcohol, at least one terpene, and at least one ketone, and where the added VOCs make up about 0.001 wt % to about 0.1 wt % of the alcoholic beverage. The at least one ester can include one or more of phenethyl acetate, ethyl laurate, ethyl acetate, and tetrahydrofurfuryl acetate. The at least one aldehyde can include phenylacetaldehyde. The at least one furan can include 2-pentylfuran. The at least one additional alcohol can include one or both of phenethyl alcohol and eugenol. The at least one terpene can include linalool. The at least one ketone can include one or both of 2,3-pentanedione and methylcyclopentenolone. The added VOCs can include vanillin erythro and threo-butan-2,3-diol acetal. The alcoholic beverage can further include a color compound. In some cases, the added VOCs can include phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and from the claims.

### DETAILED DESCRIPTION

This document provides brandy-like alcoholic beverages (also referred to as “brandy replicas,” “brandy products,” and “flavored brandies”), as well as methods for making brandy-like alcoholic beverages by combining water and ethanol with individual VOCs. The brandy-like alcoholic beverages described herein have characteristics—including taste, aroma, mouthfeel, and appearance—of traditionally produced brandies, and are meant to be consumed and enjoyed in the same manner as traditional brandies.

As used herein, the terms “traditional” and “reference” brandy refer to brandy produced through standard fermenting and distilling processes.

The following standards of identity for traditionally produced distilled neutral spirits are set forth in 27 C.F.R. § 5.22(a):
Class 1; neutral spirits or alcohol. “Neutral spirits” or “alcohol” are distilled spirits produced from any material at or above 190° proof, and, if bottled, bottled at not less than 80° proof.

The following standards of identity for traditionally produced brandies are further set forth in 27 C.F.R. § 5.22(d):
Class 4. “Brandy” is an alcoholic distillate from the fermented juice, mash, or wine of fruit, or from the residue thereof, produced at less than 190° proof in such manner that the distillate possesses the taste, aroma, and characteristics generally attributed to the product, and bottled at not less than 800 proof. Brandy, or mixtures thereof, not conforming to any of the standards in paragraphs (d)(1) through (9) of this section shall be designated as “brandy,” and such designation shall be immediately followed by a truthful and adequate statement of composition.
(1) “Fruit brandy” is brandy distilled solely from the fermented juice or mash of whole, sound, ripe fruit, or from standard grape, citrus, or other fruit wine, with or without the addition of not more than 20 percent by weight of the pomace of such juice or wine, or 30 percent by volume of the lees of such wine, or both (calculated prior to the addition of water to facilitate fermentation or distillation). Fruit brandy shall include mixtures of such brandy with not more than 30 percent (calculated on a proof gallon basis) of lees brandy. Fruit brandy, derived from grapes, shall be designated as “grape brandy” or “brandy”, except that in the case of brandy (other than neutral brandy, pomace brandy, marc brandy, grappa brandy, Pisco, Pisco Peru, or Pisco Chileno) distilled from the fermented juice, mash, or wine of grapes, or the residue thereof, which has been stored in oak containers for less than 2 years, the statement of class and type shall be immediately preceded, in the same size and kind of type, by the word “immature.” Fruit brandy, other than grape brandy, derived from one variety of fruit, shall be designated by the word “brandy” qualified by the name of such fruit (for example, “peach brandy”), except that “apple brandy” may be designated “applejack.” Fruit brandy derived from more than one variety of fruit shall be designated as “fruit brandy” qualified by a truthful and adequate statement of composition.
(2) “Cognac” or “Cognac (grape) brandy” is grape brandy distilled in the Cognac region of France, which is entitled to be so designated by the laws and regulations of the French Government.
(3) “Dried fruit brandy” is brandy that conforms to the standard for fruit brandy except that it has been derived from sound, dried fruit, or from the standard wine of such fruit. Brandy derived from raisins, or from raisin wine, shall be designated as “raisin brandy.” Other brandies shall be designated in the same manner as fruit brandy from the corresponding variety or varieties of fruit except that the name of the fruit shall be qualified by the word “dried.”
(4) “Lees brandy” is brandy distilled from the lees of standard grape, citrus, or other fruit wine, and shall be designated as “lees brandy,” qualified by the name of the fruit from which such lees are derived.
(5) “Pomace brandy” or “marc brandy” is brandy distilled from the skin and pulp of sound, ripe grapes, citrus or other fruit, after the withdrawal of the juice or wine therefrom, and shall be designated as “pomace brandy” or “marc brandy,” qualified by the name of the fruit from which derived. Grape pomace brandy may be designated as “grappa” or “grappa brandy.”
(6) “Residue brandy” is brandy distilled wholly or in part from the fermented residue of fruit or wine, and shall be designated as “residue brandy” qualified by the name of the fruit from which derived. Brandy distilled wholly or in part from residue materials which conforms to any of the standards set forth in paragraphs (d) (1), (3), (4), and (5) of this section may, regardless of such fact, be designated “residue brandy,” but the use of such designation shall be conclusive, precluding any later change of designation.
(7) “Neutral brandy” is brandy produced at more than 170° proof and shall be designated in accordance with the standards in this paragraph, except that the designation shall be qualified by the word “neutral;” for example, “neutral citrus residue brandy.”
(8) “Substandard brandy” shall bear as a part of its designation the word “substandard,” and shall include:
(i) Any brandy distilled from fermented juice, mash, or wine having a volatile acidity, calculated as acetic acid and exclusive of sulfur dioxide, in excess of 0.20 gram per 100 cubic centimeters (20° C.); measurements of volatile acidity shall be calculated exclusive of water added to facilitate distillation.
(ii) Any brandy which has been distilled from unsound, moldy, diseased, or decomposed juice, mash, wine, lees, pomace, or residue, or which shows in the finished product any taste, aroma, or characteristic associated with products distilled from such material.
(9) “Pisco” is grape brandy manufactured in Peru or Chile in accordance with the laws and regulations of the country of manufacture governing the manufacture of Pisco for consumption in the country of manufacture.
(i) “Pisco Perú” (or “Pisco Peru”) is Pisco manufactured in Peru in accordance with the laws and regulations of Peru governing the manufacture of Pisco for consumption in that country.
(ii) “Pisco Chileno” (or “Chilean Pisco”) is Pisco manufactured in Chile in accordance with the laws and regulations of Chile governing the manufacture of Pisco for consumption in that country.

The alcoholic beverages provided herein can include a traditional brandy, such that the beverages can be considered “spirits” as defined above. In some cases, one or more traditional brandies can be included in a brandy replica in a total amount of no more than about 10 wt % of the brandy replica. For example, one or more traditional brandies can make up no more than about 10 wt %, no more than about 5 wt %, no more than about 1 wt %, no more than about 0.5 wt %, no more than about 0.1 wt %, about 0.1 wt % to about 10 wt %, about 0.5 wt % to about 10 wt %, about 1 wt % to about 10 wt %, about 5 wt % to about 10 wt %, about 0.1 wt % to about 5 wt %, about 0.5 wt % to about 5 wt %, about 1 wt % to about 5 wt %, about 0.1 Wt/o to about 1 wt %, about 0.5 wt % to about 1 wt %, or about 0.1 wt % to about 0.5 wt % of a brandy replica provided herein. In some cases, about 1 percent to about 5 percent of the ethanol in a brandy replica, on a proof gallon basis, can be from a traditional brandy. For example, 1% to 5% (e.g., 1% to 2%, 2% to 3%, 3% to 4%, or 4% to 5%) of the ethanol in a brandy replica, on a proof gallon basis, can be from a traditional brandy.

A “proof gallon” is one liquid gallon of spirits that is 50% alcohol at 60° F. Thus, for example, a distilled spirit bottled at 80 proof (40% alcohol) would be 0.8 proof gallons per gallon of liquid. An 80 proof spirit brandy replica containing 1% ethanol from a traditional brandy on a proof gallon basis therefore would contain 0.8×0.01=0.008 proof gallon from the traditional brandy.

The brandy replicas described herein can contain particular volatile and, optionally, non-volatile organic compounds. The terms “contain,” “include,” “comprise” are used herein to indicate that a compound is present in a brandy replica in an amount that is detectable (e.g., using a mass spectrometry method, such as gas chromatography mass spectrometry). The terms “lacks,” “does not contain,” “does not include,” and “does not comprise” are used herein to indicate that a compound is not detectable in a brandy replica (e.g., using a mass spectrometry method, such as liquid chromatography mass spectrometry). The brandy replicas provided herein can be distinguished from traditional brandies based at least in part on the combination of VOCs and, in some cases, non-volatile organic compounds contained or not contained therein, and/or based on the amounts of particular VOCs or, in some cases, non-volatile organic compounds contained therein.

In some embodiments, a brandy replica can consist of the ingredients included in a particular list, or can have a VOC content (or non-volatile compound content) that consists of the VOCs (or non-volatile compounds) included in a particular list. Further, a brandy replica can consist essentially of the ingredients included in a particular list, or can have a VOC content (or non-volatile compound content) that consists essentially of the VOCs (or non-volatile compounds) that are included in a particular list. By “consisting essentially of” is meant that a brandy replica contains specified ingredients/VOCs/non-volatile compounds, and can contain additional ingredients/VOCs/non-volatile compounds that do not materially affect the basic and novel characteristics of the brandy.

Various formulations for brandy replicas are described herein. In general, the brandy replicas include the following components, or classes of components:
(a) a source of water, either pure or with mineral content present to improve flavor;
(b) a source of ethanol (e.g., a distilled or fermented ethanol, such as grain neutral spirits);
(c) optionally, a traditional brandy, where the traditional brandy makes up no more than about 10 wt % of the brandy replica;
(d) one or more fruit juices;
(e) one or more tannins and/or an oak extract;
(f) one or more additional VOCs (that is, one or more VOCs in addition to the ethanol and any volatile compounds that may be present in the traditional brandy, the fruit juice, and the tannins and/or oak extract); and optionally
(g) one or more additional non-volatile compounds (that is, one or more non-volatile compounds in addition to any non-volatile compounds that may be present in the traditional brandy, the fruit juice, and the tannins and/or oak extract).

Water is the main component of the brandy replicas, acting as a solvent for the other ingredients. The ethanol component and the brandy component (if any) provide the alcoholic content. The one or more fruit juices, one or more tannins, and one or more added VOCs can provide both aroma and flavor, including fruity, floral, earthy, herbaceous, oak, yeast, spice, and/or mineral aromas and flavors. In some cases, one or more non-volatile components can provide acidity, flavor, aftertaste, and mouthfeel perception of the brandy replicas.

In general, the brandy replicas provided herein can have a water content of about 5 to about 70 wt %. For example, a brandy replica can have a water content of about 5 to 10 wt %, about 10 to 20 wt %, about 20 to 30 wt %, about 30 to 40 wt %, about 40 to 45 wt %, about 45 to 50 wt %, about 50 to 55 wt %, about 55 to 60 wt %, about 60 to 65 wt %, or about 65 to 70 wt %.

In some embodiments, a brandy replica can include water, ethanol, a traditional brandy, one or more fruit juices, and (a) one or more additional VOCs (i.e., VOCs in addition to ethanol), where the one or more additional VOCs are not present in a corresponding reference brandy (also sometimes herein called a corresponding traditional brandy); (b) one or more additional VOCs, where the one or more additional VOCs do not include one or more VOCs that are present in a corresponding reference brandy; (c) one or more additional non-volatile compounds, where the one or more additional non-volatile compounds are not present in a corresponding reference brandy; (d) one or more additional non-volatile compounds, where the one or more additional non-volatile compounds do not include one or more non-volatile compounds that are present in a corresponding reference brandy; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

As used herein, a “corresponding reference brandy” can be a single type, a single brand, or a single bottle of traditionally-produced brandy that a brandy replica as described herein is intended to replicate. In some cases, a single type, single brand, or single bottle of traditionally-produced brandy can be a blend of two or more (e.g., two, three, four, or more than four) brandies. For example, if a brandy replica is meant to be the same as a Cognac, then a Cognac would be a corresponding reference brandy.

In general, the brandy replicas provided herein can have a total alcohol content (e.g., an ethanol content from grain neutral spirits and traditional brandy) content that ranges from about 30 wt % to about 95 wt %. For example, a brandy replica can have an alcohol content of about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt %.

In some cases, the brandy replicas provided herein can contain about 30 wt % to about 95 wt % grain neutral spirits (e.g., about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt % grain neutral spirits) and about 0.1 wt % to about 10 wt % traditional brandy (e.g., about 0.1 wt %, about 0.25 wt %, about 0.5 wt %, about 0.75 wt %, about 1 wt %, about 1.25 wt %, about 1.5 wt %, about 2 wt %, about 3 wt %, about 5 wt %, about 10 wt %, about 0.1 to 0.25 wt %, about 0.25 to 0.5 wt %, about 0.5 to 0.75 wt %, about 0.75 to 1 wt %, about 1 to 1.25 wt %, about 1.25 to 1.5 wt %, about 1.5 to 2 wt %, about 2 to 3 wt %, about 3 to 5 wt %, about 5 to 10 wt %, no more than about 1 wt %, no more than about 2 wt %, no more than about 3 wt %, no more than about 5 wt %, or no more than about 10 wt % traditional brandy).

The brandy replicas provided herein can contain one or more (e.g., one, two, three, four, five, or more than five) types of fruit juices. For example, a brandy replica can contain grape juice, apple juice, pear juice, apricot juice, peach juice, cherry juice, or any combination thereof (e.g., combinations that include grape and apple juice, grape and pear juice, grape and apricot juice, grape and peach juice, grape and cherry juice, apple and pear juice, apple and apricot juice, apple and peach juice, apple and cherry juice, pear and apricot juice, pear and peach juice, pear and cherry juice, apricot and peach juice, apricot and cherry juice, peach and cherry juice, or combinations that include three or more such juices). During preparation, a juice can be added to a brandy replica as a concentrate or in non-concentrated form. The brandy replicas provided herein can contain about 0.1 wt % to about 10 wt % fruit juice. For example, a brandy replica can contain fruit juice in an amount of about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 0.1 to 0.5 wt %, about 0.5 to 1 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, or about 9 to 10 wt %. When two or more fruit juices are included, they may be included in equal amounts or in any appropriate ratio.

In some cases, the brandy replicas provided herein can contain an oak extract. The oak extract can be included in an amount from about 0.1 wt % to about 10 wt %. For example, a brandy replica can contain about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 0.1 to 0.5 wt %, about 0.5 to 1 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, or about 9 to 10 wt % oak extract.

In some cases, the brandy replicas provided herein can contain one or more tannins (e.g., one or more oak tannins or powdered oak tannins). The one or more tannins can be included in an amount of about 0.001 wt % to about 1 wt % (e.g., about 0.001 to 0.005 wt %, about 0.005 to 0.01 wt %, about 0.01 to 0.05 wt %, about 0.05 to about 0.1 wt %, about 0.1 to about 0.25 wt %, about 0.25 to 0.5 wt %, or about 0.5 to 1 wt %).

In addition, the brandy replicas provided herein can contain one or more additional VOCs, where the additional VOCs were added to the replica on an individual basis (e.g., in pure or substantially pure form). The one or more added VOCs that are present in a brandy replica can include compounds that fall into any of several categories, including esters, acids, alcohols, aldehydes/ketones, terpenes/isoprenoids, phenols, and/or furans. In some cases, for example, a brandy replica can contain VOCs that include an ester, an alcohol in addition to the ethanol, an aldehyde and/or a ketone, a terpene, and a furan.

Esters, including ethyl, methyl, and acetate esters, can contribute fruity and floral characteristics to an alcoholic beverage. In some cases, esters that can be used in a brandy replica include, without limitation, phenethyl acetate, ethyl laurate, ethyl acetate, tetrahydrofurfuryl acetate, isobutyl propionate, propyl acetate, ethyl butyrate, isobutyl isobutyrate, hexyl 2-methylbutanoate, butyl isobutyrate, and any combination thereof. Any appropriate number of esters can be used (for example, 1 to 25, 1 to 10, 1 to 5, 5 to 25, 5 to 10, or 10 to 25 esters). In some cases, the one or more esters can be present in a total amount of about 1.8 mg/L to about 400 mg/L (e.g., about 1.8 to about 3 mg/L, about 3 to about 10 mg/L, about 10 to about 20 mg/L, about 20 to about 50 mg/L, about 50 to about 100 mg/L, about 100 to about 200 mg/L, about 200 to about 300 mg/L, or about 300 to about 400 mg/L). The ester(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90%/6 to about 95%) by mass of the additional VOCs can comprise one or more esters. The one or more esters can be present at any suitable amount within a brandy replica. In some cases, for example, added ester(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no esters.

Acids may contribute to “sour” or “fermented” aromas or flavors, which can be important to the general character of a brandy. An example of an acid that may be included in a brandy replica is butyric acid. Any appropriate number of acids can be used (for example, 1 to 25, 1 to 10, 1 to 5, 5 to 25, 5 to 10, or 10 to 25 acids). Acids can make up any suitable portion of the additional VOCs. In some embodiments, the one or more acids can be present in a total amount of about 0.06 mg/L to about 11 mg/L (e.g., about 0.06 to about 0.1 mg/L, about 0.1 to about 0.5 mg/L, about 0.5 to about 1 mg/L, about 1 to about 3 mg/L, about 3 to about 5 mg/L, about 5 to about 7 mg/L, about 7 to about 9 mg/L, or about 9 to about 11 mg/L). In some cases, the one or more acids can be present in a total amount of less than about 0.16 mg/L (e.g., less than about 0.15 mg/L, less than about 0.13 mg/L, less than about 0.1 mg/L, or less than about 0.05 mg/L). The acid(s) can make up any suitable proportion of the additional VOC content. For example, about 0.1% to about 99%, a (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more acids. The one or more acids can be present at any suitable amount within a brandy replica. In some cases, for example, added acid(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some embodiments, the one or more additional VOCs can include no acids.

Alcohols in addition to the ethanol provided by the grain neutral spirit and the traditional brandy can provide various flavor components to alcoholic beverages, including banana, spice, grassiness, and oxidized characteristics. In some cases, higher alcohols also can add roundness to the general aroma of an alcoholic beverage, as well as some weight on the palate. Non-limiting examples of alcohols that can be present in the brandy replicas provided herein are phenethyl alcohol, isoamyl alcohol, and a combination thereof. Any appropriate number of alcohols in addition to the ethanol can be used (for example, 1 to 25, 1 to 10, 1 to 5, 5 to 25, 5 to 10, or 10 to 25 alcohols). In some cases, the one or more added alcohols can be present in a total amount of about 0.5 mg/L to about 500 mg/L (e.g., about 0.5 to about 5 mg/L, about 5 to about 10 mg/L, about 10 to about 50 mg/L, about 50 to about 100 mg/L, about 100 to about 250 mg/L, or about 250 to about 500 mg/L). In some cases, the one or more added alcohols can be present in a total amount of less than about 22 mg/L (e.g., less than about 20 mg/L, less than about 17 mg/L, less than about 15 mg/L, or less than about 10 mg/L.). The alcohol(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more alcohols. The one or more added alcohols can be present at any suitable amount within a brandy replica. In some cases, for example, added alcohol(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no additional alcohols.

Aldehydes and ketones also can provide flavors that add to the general character of an alcoholic beverage. In some cases, aldehydes/ketones that can be used in the brandy replicas provided herein can include, without limitation, phenylacetaldehyde, 2,3-pentanedione, methylcyclopentenolone, 2-heptanone, and any combination thereof. Any appropriate number of aldehydes/ketones can be used (for example, 1 to 25, 1 to 10, 1 to 5, 5 to 25, 5 to 10, or 10 to 25 aldehydes/ketones). In some cases, the one or more added aldehydes/ketones can be present in a total amount of about 0.006 mg/L to about 1.2 mg/L (e.g., about 0.006 to about 0.06 mg/L, about 0.06 to about 0.12 mg/L, about 0.12 to about 0.6 mg/L, or about 0.6 to about 1.2 mg/L). The aldehyde(s)/ketone(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30/o, about 30/o to about 40%, about 40/o to about 50%, about 50% to about 60%, about 60% to about 70%, about 70% to about 80%, about 80% to about 90%, or about 90% to about 95%) by mass of the additional VOCs can comprise one or more aldehydes and/or ketones. The one or more aldehyde(s) and/or ketone(s) can be present at any suitable amount within a brandy replica. In some cases, for example, added aldehyde(s) and/or ketone(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no aldehydes or ketones.

Terpenes and isoprenoids can contribute various floral and green characteristics to an alcoholic beverage. A non-limiting example of a terpene that can be included in the brandy replicas provided herein is linalool. Any appropriate number of terpenes/isoprenoids can be used (for example, 1 to 25, 1 to 10, 1 to 5, 5 to 25, 5 to 10, or 10 to 25 terpenes). In some cases, the one or more added terpenes/isoprenoids can be present in a total amount of about 0.03 mg/L to about 1.3 mg/L (e.g., about 0.03 to about 0.3 mg/L, about 0.3 to about 0.6 mg/L, about 0.6 to about 0.9 mg/L, or about 0.9 to about 1.3 mg/L). The terpene(s)/isoprenoid(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more terpenes. The one or more terpenes/isoprenoids can be present at any suitable amount within a brandy replica. In some cases, for example, added terpene(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no terpenes or isoprenoids.

Furans can also contribute to the signature flavors of alcoholic beverages. A non-limiting example of a furan that can be included in the brandy replicas provided herein is 2-pentylfuran. Any appropriate number of furans can be used (for example, 1 to 25, 1 to 10, 1 to 5, 5 to 25, 5 to 10, or 10 to 25 furans). In some cases, the one or more added furans can be present in a total amount of about 0.07 mg/L to about 0.14 mg/L (e.g., about 0.07 to about 0.08 mg/L, about 0.08 to about 0.1 mg/L, about 0.1 to about 0.12 mg/L, or about 0.12 to about 0.14 mg/L). The furan(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more furans. The one or more furans can be present at any suitable amount within a brandy replica. In some cases, for example, added furan(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no furans.

Acetals can also contribute to the signature flavors of alcoholic beverages. A non-limiting example of an acetal that can be included in the brandy replicas provided herein is vanillin erythro and threo-butan-2,3-diol acetal. Any appropriate number of acetals can be used (for example, 1 to 25, 1 to 10, 1 to 5, 5 to 25, 5 to 10, or 10 to 25 acetals). The acetal(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more acetals. The one or more acetals can be present at any suitable amount within a brandy replica. In some cases, for example, added acetal(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the additional VOCs can include no acetals.

Phenols can contribute smoky or earthy characteristics to a sake. A non-limiting example of a phenol that can be used in the brandy replicas described herein is eugenol. Any appropriate number of phenols can be used (for example, 1 to 10, 1 to 8, 1 to 5, 2 to 10, 2 to 8, 2 to 5, 3 to 5, 3 to 8, or 3 to 10 phenols). Phenols can make up any suitable portion of the additional VOCs. In some embodiments, the one or more phenols can be present in a total amount of about 0.015 mg/L to about 0.37 mg/L (e.g., about 0.015 to about 0.05 mg/L, about 0.05 to about 0.1 mg/L, about 0.1 to about 0.2 mg/L, or about 0.2 to about 0.37 mg/L). In some embodiments, about 0.00009% to about 0.006% by mass (e.g., about 0.00009% to about 0.0001%, about 0.00009% to about 0.0005%, about 0.0001% to about 0.0005%, about 0.0005% to about 0.001%, about 0.001% to about 0.005%, or about 0.001% to about 0.006% by mass) of the one or more additional VOCs can be the one or more phenols. In some embodiments, the one or more additional VOCs can include no phenols.

In some cases, a brandy replica can include one or more (e.g., one or more, two or more, three or more, four or more, five or more, six or more, seven or more, eight or more, nine or more, ten or more, eleven, or all twelve) additional VOCs selected from the group consisting of phenethyl acetate, phenylacetaldehyde, 2-pentylfuran, phenethyl alcohol, ethyl laurate, eugenol, ethyl acetate, linalool, 2,3-pentanedione, tetrahydrofurfuryl acetate, methylcyclopentenolone, and vanillin erythro and threo-butan-2,3-diol acetal.

The presence, absence, and/or amount of VOCs and non-volatile compounds in traditional brandies and in brandy replicas is assessed using gas chromatography/mass spectrometry (GC-MS) and liquid chromatography/mass spectrometry (LC-MS) methods as described herein. A volatile or non-volatile compound that is “not present” in a reference brandy is one that is not detected in the reference brandy using the methods set forth in Example 3. Limits of detection for various VOCs are disclosed in TABLES 2A and 2B herein, and limits of detection for various non-volatile compounds are disclosed in TABLE 6 herein.

In some embodiments, the brandy replicas provided herein can include one or more (e.g., one, two, three, four, five, six, seven eight, nine, ten, or more than ten) VOCs that are not present in a corresponding traditional brandy. Non-limiting examples of such compounds include tetrahydrofurfuryl acetate, isobutyl propionate, isobutyl isobutyrate, hexyl 2-methylbutanoate, butyl isobutyrate, and 2-pentylfuran. In some embodiments, a brandy replica can include at least one (e.g., at least 1, at least 2, at least 3, at least 4, at least 5, or all 6) compounds selected from the group consisting of tetrahydrofurfuryl acetate, isobutyl propionate, isobutyl isobutyrate, hexyl 2-methylbutanoate, butyl isobutyrate, and 2-pentylfuran. It is surprising that the brandy replicas described herein include one or more VOCs not found in any tested traditional brandy, as it would be expected that to create a brandy replica, one would only think to use compounds found in one or more traditional brandies. By way of example only, 2-pentylfuran, on its own, gives off an earthy, musty character. However, in low concentrations in a brandy replica (e.g., any of the brandy replicas provided herein), it can provide an attractive caramellic, rum-like character.

In some embodiments, the additional VOCs can exclude one or more VOCs that are present in a corresponding traditional brandy. Examples of VOCs that can be excluded from the brandy replicas provided herein include, without limitation, (E)-β-famesene, terpinene, 2-methyl-1-butanol, 2-methyl butyl acetate, isoamyl acetate, 1-decanol, 1-hexanol, 1-octanol, 1-tetradecanol, 2-carene, 5-methyl-furfural, 2-methylbutyl octanoate, 2-nonanol, butyl ethanoate, hexyl acetate, n-octyl acetate, α-ionene, benzaldehyde, 1,2,3,5-tetramethyl-benzene, ethyl benzoate, diethyl succinate, cadalene, calamenene, ethyl decanoate, propyl decanoate, diethyl carbonate, D-limonene, dodecanoic acid, 2-furyl methyl ketone, ethyl 2-furoate, ethyl 2-methylbutyrate, ethyl 9-decenoate, ethyl isobutyrate, ethyl isovalerate, ethyl lactate, furfural, ethyl heptanoate, ethyl palmitate, ethyl hexanoate, isoamyl laurate, isobutyl acetate, isobutyl laurate, isopentyl hexanoate, n-capric acid isobutyl ester, n-caprylic acid isobutyl ester, n-decanoic acid, nerolidol, nonanal, ethyl nonanoate, octanoic acid, 3-methylbutyl octanoate, ethyl octanoate, hexyl octanoate, methyl octanoate, p-cymene, 3-methylbutyl decanoate, ethyl valerate, ethyl propionate, β-bisabolene, β-myrcene, tetradecanoic acid, ethyl tetradecanoate, and whiskey lactone. In some cases, for example, a brandy replica can exclude one or more (e.g., at least five, at least 10, at least 20, or at least 30) compounds selected from the group consisting of (E)-β-famesene, terpinene, 2-methyl-1-butanol, 2-methyl butyl acetate, isoamyl acetate, 1-decanol, 1-hexanol, 1-octanol, 1-tetradecanol, 2-carene, 5-methyl-furfural, 2-methylbutyl octanoate, 2-nonanol, butyl ethanoate, hexyl acetate, n-octyl acetate, α-ionene, benzaldehyde, 1,2,3,5-tetramethyl-benzene, ethyl benzoate, diethyl succinate, cadalene, calamenene, ethyl decanoate, propyl decanoate, diethyl carbonate, D-limonene, dodecanoic acid, 2-furyl methyl ketone, ethyl 2-furoate, ethyl 2-methylbutyrate, ethyl 9-decenoate, ethyl isobutyrate, ethyl isovalerate, ethyl lactate, furfural, ethyl heptanoate, ethyl palmitate, ethyl hexanoate, isoamyl laurate, isobutyl acetate, isobutyl laurate, isopentyl hexanoate, n-capric acid isobutyl ester, n-caprylic acid isobutyl ester, n-decanoic acid, nerolidol, nonanal, ethyl nonanoate, octanoic acid, 3-methylbutyl octanoate, ethyl octanoate, hexyl octanoate, methyl octanoate, p-cymene, 3-methylbutyl decanoate, ethyl valerate, ethyl propionate, β-bisabolene, β-myrcene, tetradecanoic acid, ethyl tetradecanoate, and whiskey lactone. It is surprising that the brandy replicas described herein lack one or more compounds found in every tested traditional brandy, as it would be expected that to create a brandy replica, one would believe that compounds present in every tested traditional brandy to be important to brandy flavor.

A brandy replica can include any appropriate number of additional VOCs. For example, a brandy replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs. For example, in some embodiments, a brandy replica can include 1 to 21 (e.g., one or more, two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21, 1 to 5, 1 to 10, 1 to 15, 5 to 10, 5 to 15, 5 to 20, 10 to 15, 10 to 20, 15 to 20, or 18 to 21) compounds selected from the group consisting of phenethyl acetate, ethyl laurate, ethyl acetate, tetrahydrofurfuryl acetate, isobutyl propionate, propyl acetate, ethyl butyrate, isobutyl isobutyrate, hexyl 2-methylbutanoate, butyl isobutyrate, butyric acid, phenethyl alcohol, isoamyl alcohol, phenylacetaldehyde, 2,3-pentanedione, methylcyclopentenolone, 2-heptanone, linalool, 2-pentylfuran, eugenol, and vanillin erythro and threo-butan-2,3-diol acetal. In some cases, a brandy replica can include 1 to 9 (e.g., one or more, two or more, three or more, four or more, five or more, six or more, seven or more, eight or more, nine, 1 to 3, 2 to 4, 3 to 5, 4 to 6, 5 to 7, 6 to 8, or 7 to 9) compounds selected from the group consisting of phenethyl acetate, tetrahydrofurfuryl acetate, ethyl laurate, phenethyl alcohol, 2-pentylfuran, linalool, 2,3-pentanedione, eugenol, and ethyl acetate. In some cases, a brandy replica can include 1 to 10 (e.g., one or more, two or more, three or more, four or more, five or more, six or more, seven or more, eight or more, nine or more, ten, 1 to 3, 2 to 4, 3 to 5, 4 to 6, 5 to 7, 6 to 8, 7 to 9, or 8 to 10) compounds selected from the group consisting of isobutyl propionate, propyl acetate, ethyl butyrate, isobutyl isobutyrate, hexyl 2-methylbutanoate, butyl isobutyrate, 2-heptanone, linalool, butyric acid, and isoamyl alcohol. In some cases, the number of VOCs in a brandy-like alcoholic beverage can be less than the number of VOCs in a single corresponding reference brandy.

In some cases, the number of additional VOCs in a brandy replica can be fewer than the number of additional VOCs in a single corresponding reference brandy. Further, in some embodiments, the brandy replicas provided herein can lack one or more (e.g., one, two, three, four, five, ten, 15, 20, or more than 20) VOCs that are present in a corresponding traditional brandy. In some cases, the overall population of additional (non-ethanol) VOCs in a brandy replica can have less than 95% identity to the VOCs in a corresponding reference brandy (e.g., in a single type of traditionally made brandy corresponding to the replica). For example, the additional VOCs in a brandy replica can have less than 90%, less than 80%, less than 70%, less than 60%, less than 50%, less than 40%, less than 30%, less than 25%, less than 20%, or less than 15% identity to the population of VOCs in a corresponding reference brandy made by traditional methods. In some cases, a percent identity can be calculated by dividing the number of shared additional VOCs by the number of additional VOCs in the corresponding reference brandy. Some brandy replicas may contain at least 3 (e.g., at least 5, at least 10 at least 15, at least 20, at least 25, at least 30, at least 35, at least 40, at least 45, or at least 50) VOCs that are not found in a single reference brandy. Moreover, some brandy replicas may contain no more than 50 (e.g., no more than 45, 40, 35, 30, 25, 20, 15, or 10) VOCs that are present in a single reference brandy. For example, in some embodiments, a brandy replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference brandy; in some embodiments, in can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

As noted above, the amounts of VOCs in reference brandies are measured using the GC-MS methods described herein. In some embodiments, the amount of a particular VOC in a brandy replica can be an amount, based on concentration or percent composition, that is within a range 30% higher and lower than a measured amount for that VOC in a corresponding reference brandy. For example, a VOC can be present in a brandy replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference brandy.

In some embodiments, a percent composition of VOCs can be calculated by dividing the measured amount of a VOC of interest (e.g., in mg/L) by the total measured amount of VOCs (e.g., in mg/L). In some embodiments, the total measured amount of VOCs is based on the VOCs in TABLES 2A and 2B. In some embodiments, the total measured amount of VOCs is based on the total measured amount of phenethyl acetate, ethyl laurate, ethyl acetate, tetrahydrofurfuryl acetate, isobutyl propionate, propyl acetate, ethyl butyrate, isobutyl isobutyrate, hexyl 2-methylbutanoate, butyl isobutyrate, butyric acid, phenethyl alcohol, isoamyl alcohol, phenylacetaldehyde, 2,3-pentanedione, methylcyclopentenolone, 2-heptanone, linalool, 2-pentylfuran, eugenol, and vanillin erythro and threo-butan-2,3-diol acetal. In some embodiments, the total measured amount of VOCs is based on the total measured amount of phenethyl acetate, tetrahydrofurfuryl acetate, ethyl laurate, phenethyl alcohol, 2-pentylfuran, linalool, 2,3-pentanedione, eugenol, and ethyl acetate. In some embodiments, the total measured amount of VOCs is based on the total measured amount of isobutyl propionate, propyl acetate, ethyl butyrate, isobutyl isobutyrate, hexyl 2-methylbutanoate, butyl isobutyrate, 2-heptanone, linalool, butyric acid, and isoamyl alcohol.

In some cases, the total amount of VOCs in a brandy replica can be less than the total amount of VOCs in a reference brandy. For example, a brandy replica can have a total VOC content (in mg/L) that is less than 95% (e.g., less than 90%, 85%, 80%, 70%, 60%, 50% or 40%) of the total VOC content (in mg/L) of a corresponding reference brandy.

In some cases, the total amount of VOCs in a brandy replica can be less than the total amount of VOCs in a corresponding reference brandy. Further, the amount of any particular VOC in a brandy replica may be different than the amount of that VOC in a corresponding reference brandy. In some cases, the amount of a VOC in a brandy replica can be 75% or less (e.g., 70% or less, 60% or less, 50% or less, 40% or less, 30% or less, 20% or less, or 100% or less), by concentration or percent mass, than the amount of the same VOC in a corresponding reference brandy. In some cases, the amount of a VOC in a brandy replica can be 125% or more (e.g., 150% or more, 20% or more, or 300% or more), by concentration or percent mass, than the amount of the same VOC in a corresponding reference brandy.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, phenethyl acetate can be present in an amount of about 0.03 mg/L to about 2 mg/L and the one or more additional VOCs can include phenethyl acetate in an amount of at least about 0.17 mg/L. Therefore, phenethyl acetate can be present in an amount of about 0.17 mg/L to about 2 mg/L (e.g., about 0.17 to about to about 0.5 mg/L, about 0.17 to about 1 mg/L, about 0.17 to about 1.5 mg/L, or about 0.17 to about 2 mg/L); phenethyl acetate can be present in an amount of about 0.2 mg/L to about 2 mg/L (e.g., about 0.2 to about 0.5 mg/L, about 0.2 to about 1 mg/L, or about 0.2 to about 2 mg/L); phenethyl acetate can be present in an amount of about 0.4 mg/L to about 2 mg/L (e.g., about 0.4 to about 1 mg/L, or about 0.4 to about 2 mg/L); or ethyl butanoate can be present in an amount of about 1 mg/L to about 2 mg/L.

Further, it will be understood that if both a range and an “at least” or “less than” value are described for a brandy replica, the interpretation will be the largest overlap of those descriptions. For example, if a brandy replica is described with both “phenethyl acetate can be present in an amount of about 0.03 mg/L to about 2 mg/L” and “the one or more additional VOCs include phenethyl acetate in an amount of at least about 0.17 mg/L,” the interpretation shall be that phenethyl acetate is present in an amount of about 0.17 mg/L to about 2 mg/L.

In some cases, a brandy-like alcoholic beverage can include two added VOCs, where the two added VOCs are selected from the group consisting of phenethyl acetate, ethyl laurate, ethyl acetate, tetrahydrofurfuryl acetate, isobutyl propionate, propyl acetate, ethyl butyrate, isobutyl isobutyrate, hexyl 2-methylbutanoate, butyl isobutyrate, butyric acid, phenethyl alcohol, isoamyl alcohol, phenylacetaldehyde, 2,3-pentanedione, methylcyclopentenolone, 2-heptanone, linalool, 2-pentylfuran, and vanillin erythro and threo-butan-2,3-diol acetal. For example, the two added VOCs can be phenethyl acetate and phenylacetaldehyde, phenethyl acetate and 2-pentylfuran, phenethyl acetate and phenethyl alcohol, phenethyl acetate and ethyl laurate, phenethyl acetate and eugenol, phenethyl acetate and ethyl acetate, phenethyl acetate and linalool, phenethyl acetate and 2,3-pentanedione, phenethyl acetate and tetrahydrofurfuryl acetate, phenethyl acetate and methylcyclopentenolone, phenethyl acetate and vanillin erythro and threo-butan-2,3-diol acetal, phenylacetaldehyde and 2-pentylfuran, phenylacetaldehyde and phenethyl alcohol, phenylacetaldehyde and ethyl laurate, phenylacetaldehyde and eugenol, phenylacetaldehyde and ethyl acetate, phenylacetaldehyde and linalool, phenylacetaldehyde and 2,3-pentanedione, phenylacetaldehyde and tetrahydrofurfuryl acetate, phenylacetaldehyde and methylcyclopentenolone, phenylacetaldehyde and vanillin erythro and threo-butan-2,3-diol acetal, 2-pentylfuran and phenethyl alcohol, 2-pentylfuran and ethyl laurate, 2-pentylfuran and eugenol, 2-pentylfuran and ethyl acetate, 2-pentylfuran and linalool, 2-pentylfuran and 2,3-pentanedione, 2-pentylfuran and tetrahydrofurfuryl acetate, 2-pentylfuran and methylcyclopentenolone, 2-pentylfuran and vanillin erythro and threo-butan-2,3-diol acetal, phenethyl alcohol and ethyl laurate, phenethyl alcohol and eugenol, phenethyl alcohol and ethyl acetate, phenethyl alcohol and linalool, phenethyl alcohol and 2,3-pentanedione, phenethyl alcohol and tetrahydrofurfuryl acetate, phenethyl alcohol and methylcyclopentenolone, phenethyl alcohol and vanillin erythro and threo-butan-2,3-diol acetal, ethyl laurate and eugenol, ethyl laurate and ethyl acetate, ethyl laurate and linalool, ethyl laurate and 2,3-pentanedione, ethyl laurate and tetrahydrofurfuryl acetate, ethyl laurate and methylcyclopentenolone, ethyl laurate and vanillin erythro and threo-butan-2,3-diol acetal, eugenol and ethyl acetate, eugenol and linalool, eugenol and 2,3-pentanedione, eugenol and tetrahydrofurfuryl acetate, eugenol and methylcyclopentenolone, eugenol and vanillin erythro and threo-butan-2,3-diol acetal, ethyl acetate and linalool, ethyl acetate and 2,3-pentanedione, ethyl acetate and tetrahydrofurfuryl acetate, ethyl acetate and methylcyclopentenolone, ethyl acetate and vanillin erythro and threo-butan-2,3-diol acetal, linalool and 2,3-pentanedione, linalool and tetrahydrofurfuryl acetate, linalool and methylcyclopentenolone, linalool and vanillin erythro and threo-butan-2,3-diol acetal, 2,3-pentanedione and tetrahydrofurfuryl acetate, 2,3-pentanedione and methylcyclopentenolone, 2,3-pentanedione and vanillin erythro and threo-butan-2,3-diol acetal, tetrahydrofurfuryl acetate and methylcyclopentenolone, tetrahydrofurfuryl acetate and vanillin erythro and threo-butan-2,3-diol acetal, and methylcyclopentenolone and vanillin erythro and threo-butan-2,3-diol acetal.

As noted above, VOCs and non-volatile compounds can be detected in reference brandies and brandy replicas (and other alcoholic beverages) using any suitable methods, including gas chromatography/mass spectrometry (GC-MS) and liquid chromatography/mass spectrometry (LC-MS) methods. A VOC that is “not present” or “not detected” in a reference brandy, for example, is one that is not detected in the reference brandy using a GC-MS method as described herein.

In some cases, the one or more additional VOCs in a brandy-like alcoholic beverage can include phenethyl acetate. The phenethyl acetate can be present in an amount of, for example, about 0.03 to about 2 mg/L (e.g., about 0.03 to about 0.3 mg/L, about 0.3 to about 0.46 mg/L, about 0.46 to about 0.85 mg/L, about 0.46 to about 0.5 mg/L, about 0.5 to about 0.54 mg/L, about 0.54 to about 0.58 mg/L, about 0.58 to about 0.62 mg/L, about 0.62 to about 0.66 mg/L, about 0.64 to about 0.68 mg/L, about 0.68 to about 0.72 mg/L, about 0.72 to about 0.76 mg/L, about 0.76 to about 0.8 mg/L, about 0.8 to about 0.85 mg/L, about 0.85 to about 1.0 mg/L, about 1.0 to about 1.5 mg/L, or about 1.5 to about 2 mg/L). In some cases, about 0.005% to about 5% by mass (e.g., about 0.005% to about 0.05%, about 0.05% to about 0.5%, about 0.5% to about 1.0%, about 1.0% to about 1.3%, about 1.3% to about 2.5%, about 1.3% to about 1.5%, about 1.5% to about 1.7%, about 1.7% to about 1.9%, about 1.9% to about 2.1%, about 2.1% to about 2.3%, or about 2.3% to about 2.5%, about 2.5% to about 3%, about 3% to about 3.5%, about 3.5% to about 4%, about 4% to about 4.5%, or about 4.5% to about 5.0%, by mass) of the one or more additional VOCs can be phenethyl acetate. In some cases, the one or more additional VOCs can include no phenethyl acetate.

In some cases, the one or more additional VOCs in a brandy-like alcoholic beverage can include phenylacetaldehyde. The phenylacetaldehyde can be present in an amount of, for example, about 0.2 to about 0.8 mg/L (e.g., about 0.2 to about 0.36 mg/L, about 0.2 to about 0.22 mg/L, about 0.22 to about 0.24 mg/L, about 0.24 to about 0.26 mg/L, about 0.26 to about 0.28 mg/L, about 0.28 to about 0.3 mg/L, about 0.3 to about 0.32 mg/L, about 0.32 to about 0.34 mg/L, about 0.34 to about 0.36 mg/L, about 0.36 to about 0.4 mg/L, about 0.4 to about 0.6 mg/L, or about 0.6 to about 0.8 mg/L). In some cases, about 0.53% to about 1.8% by mass (e.g., about 0.53% to about 0.57%, about 0.57% to about 1.06%, about 0.57% to about 0.65%, about 0.65% to about 0.75%, about 0.75% to about 0.85%, about 0.85% to about 0.95%, about 0.95% to about 1.06%, about 1% to about 1.2%, about 1.2% to about 1.4%, about 1.4% to about 1.6%, or about 1.6% to about 1.8%, by mass) of the one or more additional VOCs can be phenylacetaldehyde. In some cases, the one or more additional VOCs can include no phenylacetaldehyde.

In some cases, the one or more additional VOCs in a brandy-like alcoholic beverage can include 2-pentylfuran. The 2-pentylfuran can be present in an amount of, for example, about 0.05 to about 0.85 mg/L (e.g., about 0.05 to about 0.1 mg/L, about 0.1 to about 0.25 mg/L, about 0.25 to about 0.46 mg/L, about 0.46 to about 0.85 mg/L, about 0.46 to about 0.5 mg/L, about 0.5 to about 0.54 mg/L, about 0.54 to about 0.58 mg/L, about 0.58 to about 0.62 mg/L, about 0.62 to about 0.66 mg/L, about 0.64 to about 0.68 mg/L, about 0.68 to about 0.72 mg/L, about 0.72 to about 0.76 mg/L, about 0.76 to about 0.8 mg/L, or about 0.8 to about 0.85 mg/L). In some cases, about 0.25% to about 2.5% by mass (e.g., about 0.25% to about 0.5%, about 0.5% to about 1.0%, about 1.0% to about 1.3%, about 1.3% to about 2.5%, about 1.3% to about 1.7%, about 1.7% to about 1.9/6, about 1.9% to about 2.1%, about 2.1% to about 2.3%, or about 2.3% to about 2.5%, by mass) of the one or more additional VOCs can be 2-pentylfuran. In some cases, the one or more additional VOCs can include no 2-pentylfuran.

In some cases, the one or more additional VOCs in a brandy-like alcoholic beverage can include phenethyl alcohol. The phenethyl alcohol can be present in an amount of, for example, about 0.46 to about 50 mg/L (e.g., about 0.46 to about 0.85 mg/L, about 0.46 to about 0.5 mg/L, about 0.5 to about 0.54 mg/L, about 0.54 to about 0.58 mg/L, about 0.58 to about 0.62 mg/L, about 0.62 to about 0.66 mg/L, about 0.64 to about 0.68 mg/L, about 0.68 to about 0.72 mg/L, about 0.72 to about 0.76 mg/L, about 0.76 to about 0.8 mg/L, or about 0.8 to about 0.85 mg/L, about 0.85 to about 1 mg/L, about 1 to about 5 mg/L, about 5 to about 10 mg/L, about 10 to about 15 mg/L, about 15 to about 20 mg/L, about 20 mg/L to about 25 mg/L, about 25 to about 30 mg/L, about 30 to about 35 mg/L, about 35 to about 40 mg/L, about 40 to about 45 mg/L, or about 45 to about 50 mg/L). In some cases, the phenethyl alcohol can be present in an amount of less than about 1.28 mg/L (e.g., less than about 1.25 mg/L, less than about 1.2 mg/L, less than about 1.1 mg/L, less than about 1 mg/L, less than about 0.9 mg/L, less than about 0.8 mg/L, less than about 0.7 mg/L, less than about 0.6 mg/L, less than about 0.5 mg/L, less than about 0.4 mg/L, less than about 0.3 mg/L, less than about 0.2 mg/L, or less than about 0.1 mg/L). In some cases, about 0.26% to about 65% by mass (e.g., about 0.26% to about 0.5%, about 0.5% to about 1.0%, about 1.0% to about 1.3%, about 1.3% to about 2.5%, about 1.3% to about 1.5%, about 1.5% to about 1.7%, about 1.7% to about 1.9/6, about 1.9% to about 2.1%, about 2.1% to about 2.3%, about 2.3% to about 2.5%, about 2.5% to about 10.0%, about 10% to about 20% about 20% to about 30%, to about 40%, about 40% to about 50%, about 50% to about 60%, or about 60% to about 65%) of the one or more additional VOCs can be phenethyl alcohol. In some cases, the one or more additional VOCs can include no phenethyl alcohol.

In some cases, the one or more additional VOCs in a brandy-like alcoholic beverage can include ethyl laurate. The ethyl laurate can be present in an amount of, for example, about 0.05 to about 14 mg/L (e.g., about 0.05 to about 0.5 mg/L, about 0.5 to about 1.0 mg/L, about 1.0 to about 1.3 mg/L, about 1.3 to about 2.42 mg/L, about 1.3 to about 1.4 mg/L, about 1.4 to about 1.5 mg/L, about 1.5 to about 1.6 mg/L, about 1.6 to about 1.7 mg/L, about 1.7 to about 1.8 mg/L, about 1.8 to about 1.9 mg/L, about 1.9 to about 2 mg/L, about 2 to about 2.1 mg/L, about 2.1 to about 2.2 mg/L, about 2.2 to about 2.3 mg/L, about 2.3 to about 2.42 mg/L, about 2.42 to about 14.0 mg/L (e.g., about 2.42 to about 5 mg/L, about 5 to about 10.0 mg/L, about 10.0 to about 14.0 mg/L). In some cases, about 0.005% to about 27% by mass (e.g., about 0.005% to about 0.05%, about 0.05% to about 0.5%, about 0.5% to about 1%, about 1% to about 2%, about 2% to about 3%, about 3% to about 3.8, about 3.8% to about 7.1%, about 3.8% to about 4.1%, about 4.1% to about 4.4%, about 4.4% to about 4.7%, about 4.7% to about 5%, about 5% to about 5.3%, about 5.3% to about 5.6%, about 5.6% to about 5.9%, about 5.9/a to about 6.2%, about 6.2% to about 6.5%, about 6.5% to about 6.8%, about 6.8% to about 7.1%, about 7.1% to about 10%, about 10% to about 15%, about 15% to about 20%, about 20% to about 25%, or about 25% to about 27%, by mass) of the one or more additional VOCs can be ethyl laurate. In some cases, the one or more additional VOCs can include no ethyl laurate.

In some cases, the one or more additional VOCs in a brandy-like alcoholic beverage can include eugenol. The eugenol can be present in an amount of, for example, about 0.02 to about 0.97 mg/L (e.g., about 0.02 to about 0.2 mg/L, about 0.2 to about 0.3 mg/L, about 0.3 to about 0.4 mg/L, about 0.4 to about 0.5 mg/L, about 0.52 to about 0.97 mg/L, about 0.52 to about 0.57 mg/L, about 0.57 to about 0.61 mg/L, about 0.61 to about 0.65 mg/L, about 0.65 to about 0.69 mg/L, about 0.69 to about 0.73 mg/L, about 0.73 to about 0.77 mg/L, about 0.77 to about 0.81 mg/L, about 0.81 to about 0.85 mg/L, about 0.85 to about 0.89 mg/L, about 0.89 to about 0.93 mg/L, or about 0.93 to about 0.97 mg/L). In some cases, about 0.002% to about 2.8% by mass (e.g., about 0.002% to about to about 0.02%, about 0.02% to about 0.2%, about 0.2% to about 0.5%, about 0.5% to about 1.0%, about 1.0% to about 1.5%, about 1.5% to about 2.8%, about 1.5% to about 1.7%, about 1.7% to about 1.9%, about 1.9% to about 2.1%, about 2.1% to about 2.3%, about 2.3% to about 2.5%, about 2.5% to about 2.7%, or about 2.7% to about 2.8%, by mass) of the one or more additional VOCs can be eugenol. In some cases, greater than about 0.007% by mass (e.g., greater than about 0.008%, greater than about 0.01%, or greater than about 0.05%, by mass) of the one or more additional VOCs can be eugenol. In some cases, the one or more additional VOCs can include no eugenol.

In some cases, the one or more additional VOCs in a brandy-like alcoholic beverage can include ethyl acetate. The ethyl acetate can be present in an amount of, for example, about 0.2 to about 377 mg/L (e.g., about 0.2 to about 2 mg/L, about 2 to about 5 mg/L, about 5 to about 8 mg/L, about 8 to about 11 mg/L, about 11 to about 13 mg/L, about 13 to about 24.2 mg/L, about 13 to about 14 mg/L, about 14 to about 15 mg/L, about 15 to about 16 mg/L, about 16 to about 17 mg/L, about 17 to about 18 mg/L, about 18 to about 19 mg/L, about 19 to about 20 mg/L, about 20 to about 21 mg/L, about 21 to about 22 mg/L, about 22 to about 23 mg/L, about 23 to about 24.2 mg/L, about 24.2 to about 377 mg/L (e.g., about 24.2 to about 50 mg/L, about 50 to about 75 mg/L, about 75 to about 100 mg/L, about 100 to about 150 mg/L, about 150 to about 200 mg/L, about 200 to about 250 mg/L, about 250 to about 300 mg/L, about 300 to about 350 mg/L, or about 350 to about 377 mg/L). In some cases, about 10% to about 100% by mass (e.g., about 10% to about 20%, about 20% to about 30%, about 30% to about 38%, about 38% to about 70%, about 38% to about 42%, about 42% to about 46%, about 46% to about 50%, about 50% to about 54%, about 54% to about 58%, about 58% to about 62%, about 62% to about 66%, or about 66% to about 70%, about 70% to about 75%, about 75% to about 80%, about 85% to about 90%, or about 95% to about 100%, by mass) of the one or more additional VOCs can be ethyl acetate. In some cases, the one or more additional VOCs can include no ethyl acetate.

In some cases, the one or more additional VOCs in a brandy-like alcoholic beverage can include linalool. The linalool can be present in an amount of, for example, about 0.03 to about 1.3 mg/L (e.g., about 0.03 to about 0.035 mg/L, about 0.035 to about 0.07 mg/L, about 0.07 to about 0.12 mg/L, about 0.07 to about 0.075 mg/L, about 0.075 to about 0.08 mg/L, about 0.08 to about 0.085 mg/L, about 0.085 to about 0.09 mg/L, about 0.09 to about 0.095 mg/L, about 0.095 to about 0.1 mg/L, about 0.1 to about 0.105 mg/L, about 0.105 to about 0.11 mg/L, about 0.11 to about 0.115 mg/L, about 0.115 to about 0.12 mg/L, about 0.12 to about 0.5 mg/L, about 0.5 to about 1.0 mg/L, or about 1.0 to about 1.3 mg/L). In some cases, about 0.005% to about 3% by mass (e.g., about 0.005 to about 0.05%, about 0.05% to about 0.1%, about 0.1% to about 0.19%, about 0.19% to about 0.35%, about 0.19% to about 0.21%, about 0.21% to about 0.23%, about 0.23% to about 0.25%, about 0.25% to about 0.27%, about 0.27% to about 0.29%, about 0.29% to about 0.31%, about 0.31% to about 0.33%, or about 0.33% to about 0.35%, about 0.35% to about 0.5%, about 0.5% to about 0.75%, about 0.75% to about 1.00%, about 1.0% to about 1.05%, about 1.05% to about 1.15%, about 1.15% to about 1.2%, about 1.2% to about 1.25%, about 1.25% to about 1.75%, about 1.75% to about 2.0%, about 2.0% to about 2.25%, about 2.25% to about 2.5%, about 2.5% to about 2.75%, or about 2.75% to about 3.0%, by mass) of the one or more additional VOCs can be linalool. In some cases, the one or more additional VOCs can include no linalool.

In some cases, the one or more additional VOCs in a brandy-like alcoholic beverage can include 2,3-pentanedione. The 2,3-pentanedione can be present in an amount of, for example, about 0.1 to about 1.21 mg/L (e.g., about 0.1 to about 0.3 mg/L, about 0.3 to about 0.6 mg/L, about 0.65 to about 1.21 mg/L, about 0.65 to about 0.75 mg/L, about 0.75 to about 0.85 mg/L, about 0.85 to about 0.9 mg/L, about 0.9 to about 0.95 mg/L, about 0.95 to about 1 mg/L, about 1 to about 1.1 mg/L, or about 1.1 to about 1.21 mg/L). In some cases, the 2,3-pentanedione can be present in an amount of less than about 0.17 mg/L (e.g., less than about 0.16 mg/L, less than about 0.15 mg/L, less than about 0.14 mg/L, less than about 0.12 mg/L, less than about 0.1 mg/L, less than about 0.05 mg/L, or less than about 0.01 mg/L). In some cases, about 0.03% to about 3.53% (e.g., about 0.03% to about 0.3%, about 0.3% to about 0.6%, about 0.6% to about 0.9%, about 0.9% to about 1.3%, about 1.3% to about 1.6%, about 1.6% to about 1.9%, about 1.9% to about 3.53%, about 1.9% to about 2.1%, about 2.1% to about 2.3%, about 2.3% to about 2.5%, about 2.5% to about 2.7%, about 2.7% to about 2.9%, about 2.9% to about 3.1%, about 3.1% to about 3.3%, or about 3.3% to about 3.53%, by mass) of the one or more additional VOCs can be 2,3-pentanedione. In some cases, the one or more additional VOCs can include no 2,3-pentanedione.

In some cases, the one or more additional VOCs in a brandy-like alcoholic beverage can include tetrahydrofurfuryl acetate. The tetrahydrofurfuryl acetate can be present in an amount of, for example, about 0.33 to about 0.68 mg/L (e.g., about 0.33 to about 0.61 mg/L, about 0.33 to about 0.36 mg/L, about 0.36 to about 0.39 mg/L, about 0.39 to about 0.42 mg/L, about 0.42 to about 0.45 mg/L, about 0.45 to about 0.48 mg/L, about 0.48 to about 0.51 mg/L, about 0.51 to about 0.54 mg/L, about 0.54 to about 0.57 mg/L, about 0.57 to about 0.61 mg/L, about 0.61 to about 0.64 mg/L, or about 0.64 to about 0.68 mg/L). In some cases, about 0.95% to about 2.8% by mass (e.g., about 0.95% to about 1.77%, about 0.95% to about 1%, about 1% to about 1.1%, about 1.1% to about 1.2%, about 1.2% to about 1.3%, about 1.3% to about 1.4%, about 1.4% to about 1.5%, about 1.5% to about 1.6%, about 1.6% to about 1.7%, about 1.7% to about 1.77%, about 1.77% to about 2.0%, about 2.0% to about 2.3%, about 2.3% to about 2.6%, or about 2.6% to about 2.8%, by mass) of the one or more additional VOCs can be tetrahydrofurfuryl acetate. In some cases, the one or more additional VOCs can include no tetrahydrofurfuryl acetate.

In some cases, the one or more additional VOCs in a brandy-like alcoholic beverage can include methylcyclopentenolone. The methylcyclopentenolone can be present in an amount of, for example, about 3.9 to about 7.3 mg/L (e.g., about 3.9 to about 4.2 mg/L, about 4.2 to about 4.5 mg/L, about 4.5 to about 4.8 mg/L, about 4.8 to about 5.1 mg/L, about 5.1 to about 5.4 mg/L, about 5.4 to about 5.7 mg/L, about 5.7 to about 6 mg/L, about 6 to about 6.3 mg/L, about 6.3 to about 6.6 mg/L, about 6.6 to about 6.9 mg/L, or about 6.9 to about 7.3 mg/L). In some cases, about 11.4% to about 21.2% by mass (e.g., about 11.4% to about 13%, about 13% to about 15%, about 15% to about 17%, about 17% to about 19%, or about 19% to about 21.2%, by mass) of the one or more additional VOCs can be methylcyclopentenolone. In some cases, the one or more additional VOCs can include no methylcyclopentenolone.

In some cases, the one or more additional VOCs in a brandy-like alcoholic beverage can include vanillin erythro and threo-butan-2,3-diol acetal. The vanillin erythro and threo-butan-2,3-diol acetal can be present in an amount of, for example, about 2.6 to about 4.85 mg/L (e.g., about 2.6 to about 2.8 mg/L, about 2.8 to about 3 mg/L, about 3 to about 3.2 mg/L, about 3.2 to about 3.4 mg/L, about 3.4 to about 3.6 mg/L, about 3.6 to about 3.8 mg/L, about 3.8 to about 4 mg/L, about 4 to about 4.2 mg/L, about 4.2 to about 4.4 mg/L, about 4.4 to about 4.6 mg/L, or about 4.6 to about 4.85 mg/L). In some cases, about 7.6% to about 14.1% by mass (e.g., about 7.6% to about 8%, about 8% to about 9%, about 9% to about 10%, about 10% to about 11%, about 11% to about 12%, about 12% to about 13%, or about 13% to about 14.1%, by mass) of the one or more additional VOCs can be vanillin erythro and threo-butan-2,3-diol acetal. In some cases, the one or more additional VOCs can include no vanillin erythro and threo-butan-2,3-diol acetal.

In some cases, the one or more additional VOCs in a brandy-like alcoholic beverage can include isobutyl propionate. The isobutyl propionate can be present in an amount of, for example, about 2.5 to about 5.0 mg/L (e.g. about 2.5 to about 2.75 mg/L, about 2.75 to about 3.0 mg/L, about 3.0 to about 3.25 mg/L, about 3.25 to about 3.50 mg/L, about 3.50 to about 3.75 mg/L, about 3.75 to about 4.0 mg/L, about 4.0 to about 4.25 mg/L, about 4.25 to about 4.50 mg/L, about 4.50 to about 4.75 mg/L, about or about 4.75 to about 5.0 mg/L). In some cases, about 2.0% to about 4.5% by mass (e.g. about 2.0% to about 2.3%, about 2.3% to about 2.6%, about 2.6% to about 2.9%, about 3.2% to about 3.5%, about 3.5% to about 3.8%, about or about 4.1% to about 4.5%, by mass) of the one or more additional VOCs can be isobutyl propionate. In some cases, the one or more additional VOCs can include no isobutyl propionate.

In some cases, the one or more additional VOCs in a brandy-like alcoholic beverage can include propyl acetate. The propyl acetate can be present in an amount of, for example, about 0.03 to about 18 mg/L (e.g. about 0.03 to about 1 mg/L, about 1 to about 5 mg/L, about 5 to about 10 mg/L, about 10 to about 15 mg/L, about 15 to about 18 mg/L). In some cases, the propyl acetate can be present in an amount greater than about 0.75 mg/L (e.g., greater than about 0.8 mg/L, greater than about 0.9 mg/L, greater than about 1 mg/L, or greater than about 1.5 mg/L). In some cases, about 0.005% to about 2% by mass (e.g. about 0.005% to about 0.05%, about 0.05% to about 0.5%, about 0.5% to about 1.0%, about 1.0% to about 1.5%, or about 1.5% to about 2.0%, by mass) of the one or more additional VOCs can be propyl acetate. In some cases, about 2% to about 7% by mass (e.g. about 2% to about 3%, about 3% to about 6%, about 6% to about 9%, about 9% to about 12%, or about 12% to about 15%, by mass) of the one or more additional VOCs can be propyl acetate. In some cases, greater than about 0.018% by mass (e.g., greater than about 0.02%, greater than about 0.3%, greater than about 0.4%, or greater than about 0.5%, by mass) of the one or more additional VOCs can be propyl acetate. In some cases, the one or more additional VOCs can include no propyl acetate.

In some cases, the one or more additional VOCs in a brandy-like alcoholic beverage can include ethyl butyrate. The ethyl butyrate can be present in an amount of, for example, about 0.2 to about 1 mg/L (e.g. about 0.2 to about 0.4 mg/L, about 0.4 to about 0.6 mg/L, about 0.6 to about 0.8 mg/L, or about 0.8 to about 1.0 mg/L). The ethyl butyrate can be present in an amount of, for example, about 1.0 to about 15 mg/L (e.g. about 1.0 to about 5.0 mg/L, about 5.0 to about 10.0 mg/L, or about 10.0 to about 15.0 mg/L). The ethyl butyrate can be present in an amount of, for example, about 15.0 to about 26.5 mg/L (e.g. about 15.0 to about 20.0 mg/L, or about 20.0 to about 26.5 mg/L). In some cases, the ethyl butyrate can be present in an amount greater than about 5 mg/L (e.g., greater than about 5.5 mg/L, greater than about 6 mg/L, greater than about 8 mg/L, or greater than about 10 mg/L). In some cases, about 0.03% to about 1% by mass (e.g. about 0.03% to about 0.33%, 0.33% to about 0.63%, 0.63% to about 0.93%, or 0.93% to about 1%, by mass) of the one or more additional VOCs can be ethyl butyrate. In some cases, about 1% to about 24% by mass (e.g. about 1% to about 5%, about 5% to about 10%, about 10% to about 15%, about 15% to about 20%, or about 20% to about 24%, by mass) of the one or more additional VOCs can be ethyl butyrate. In some cases, greater than about 0.11% by mass (e.g., greater than about 0.12%, greater than about 0.15%, greater than about 0.2%, or greater than about 0.25%, by mass) of the one or more additional VOCs can be ethyl butyrate. In some cases, the one or more additional VOCs can include no ethyl butyrate.

In some cases, the one or more additional VOCs in a brandy-like alcoholic beverage can include isobutyl isobutyrate. The isobutyl isobutyrate can be present in an amount of, for example, about 3 to about 7 mg/L (e.g. about 3 to about 3.5 mg/L, about 3.5 to about 4 mg/L, about 4 to about 4.5 mg/L, about 4.5 to about 5 mg/L, about 5 to about 5.5 mg/L, about 5.5 to about 6 mg/L, about 6 to about 6.5 mg/L, or about 6.5 to about 7 mg/L). In some cases, about 3% to about 7% by mass (e.g. about 3% to about 3.5%, about 3.5% to about 4%, about 4% to about 4.5%, about 4.5% to about 5%, about 5% to about 5.5%, about 5.5% to about 6%, about 6% to about 6.5%, or about 6.5% to about 7%, by mass) of the one or more additional VOCs can be isobutyl isobutyrate. In some cases, the one or more additional VOCs can include no isobutyl isobutyrate.

In some cases, the one or more additional VOCs in a brandy-like alcoholic beverage can include hexyl 2-methylbutanoate. The hexyl 2-methylbutanoate can be present in an amount of, for example, about 2 to about 5 mg/L (e.g. about 2 to about 2.3 mg/L, about 2.3 to about 2.6 mg/L, about 2.6 to about 2.9 mg/L, about 2.9 to about 3.2 mg/L, about 3.2 to about 3.5 mg/L, about 3.5 to about 3.8 mg/L, about 3.8 to about 4.1 mg/L, about 4.1 to about 4.4 mg/L, or about 4.7 to about 5 mg/L). In some cases, about 2% to about 4% by mass (e.g. about 2% to about 2.3%, about 2.3% to about 2.6%, about 2.6% to about 2.9%, about 2.9/o to about 3.2%, about 3.2% to about 3.5%, about 3.5% to about 3.8%, or about 3.8% to about 4.1%, by mass) of the one or more additional VOCs can be hexyl 2-methylbutanoate. In some cases, the one or more additional VOCs can include no hexyl 2-methylbutanoate.

In some cases, the one or more additional VOCs in a brandy-like alcoholic beverage can include butyl isobutyrate. The butyl isobutyrate can be present in an amount of, for example, about 10 to about 19 mg/L (e.g. about 10 to about 11 mg/L, about 11 to about 12 mg/L, about 12 to about 13 mg/L, about 13 to about 14 mg/L, about 14 to about 15 mg/L, about 15 to about 16, about 16 to about 17 mg/L, about 17 to about 18 mg/L, or about 18 to about 19 mg/L). In some cases, about 9% to about 16% by mass (e.g. about 9% to about 10%, about 10% to about 11%, about 11% to about 12%, about 12% to about 13%, about 13% to about 14%, about 14% to about 15%, or about 15% to about 16%, by mass) of the one or more additional VOCs can be butyl isobutyrate. In some cases, the one or more additional VOCs can include no butyl isobutyrate.

In some cases, the one or more additional VOCs in a brandy-like alcoholic beverage can include 2-heptanone. The 2-heptanone can be present in an amount of, for example, about 0.0006 to about 1 mg/L (e.g. about 0.0006 to about 0.006 mg/L, about 0.006 to about 0.06 mg/L, about 0.06 to about 0.6 mg/L, or about 0.6 to about 1.000 mg/L). In some cases, the 2-heptanone can be present in an amount greater than about 0.03 mg/L (e.g., greater than about 0.05 mg/L, greater than about 0.07 mg/L, greater than about 0.1 mg/L, or greater than about 0.3 mg/L). In some cases, about 0.0009% to about 1% by mass (e.g. about 0.0009% to about 0.009%, about 0.009% to about 0.09%, about 0.09% to about 0.9%, about 0.9% to about 1%, by mass) of the one or more additional VOCs can be 2-heptanone. In some cases, greater than about 0.00068% by mass (e.g., greater than about 0.0008%, greater than about 0.001%, greater than about 0.005%, by mass) of the one or more additional VOCs can be 2-heptanone. In some cases, the one or more additional VOCs can include no 2-heptanone.

In some cases, the one or more additional VOCs in a brandy-like alcoholic beverage can include butyric acid. The butyric acid can be present in an amount of, for example, about 0.06 to about 11 mg/L (e.g. about 0.06 to about 0.66 mg/L, about 0.66 to about 1.26 mg/L, about 1.26 to about 1.86 mg/L, about 1.86 to about 2.46 mg/L, about 2.46 to about 3.06 mg/L, about 3.06 to about 3.66 mg/L, about 3.66 to about 4.26 mg/L, about 4.26 to about 4.86 mg/L, about 4.86 to about 5.46 mg/L, about 5.46 to about 6.06 mg/L, about 6.06 to about 6.66 mg/L, about 6.66 to about 7.26 mg/L, about 7.26 to about 7.86 mg/L, about 7.86 to about 8.46 mg/L, about 8.46 to about 9.06 mg/L, about 9.06 to about 9.66 mg/L, about 9.66 to about 10.26 mg/L, about 10.26 to about 10.86 mg/L, or about 10.86 to about 11 mg/L). In some cases, the butyric acid can be present in an amount of less than about 0.16 mg/L (e.g., less than about 0.15 mg/L, less than about 0.14 mg/L, less than about 0.12 mg/L, less than about 0.1 mg/L, less than about 0.05 mg/L, or less than about 0.01 mg/L). In some cases, about 0.03% to about 22% by mass (e.g. about 0.03% to about 0.06%, about 0.06% to about 0.09%, about 0.09% to about 0.9%, about 0.9% to about 1.0%, about 1.0% to about 2%, about 2% to about 3%, about 3% to about 4%, about 4% to about 5%, about 5% to about 6%, about 6% to about 7%, about 7% to about 8%, about 8% to about 9%, about 9% to about 10%, about 10% to about 11%, about 11% to about 12%, about 12% to about 13%, about 13% to about 14%, about 14% to about 15%, about 15% to about 16%, about 16% to about 17%, about 17% to about 18%, about 18% to about 19%, about 19% to about 20%, about 20% to about 21%, or about 21% to about 22%, by mass) of the one or more additional VOCs can be butyric acid. In some cases, the one or more additional VOCs can include no butyric acid.

In some cases, the one or more additional VOCs in a brandy-like alcoholic beverage can include isoamyl alcohol. The isoamyl alcohol can be present in an amount of, for example, about 25 to about 75 mg/L (e.g. about 25 to about 35 mg/L, about 35 to about 45 mg/L, about 45 to about 55 mg/L, about 55 to about 65 mg/L, or about 65 to about 75 mg/L). The isoamyl alcohol can be present in an amount of, for example, about 75 to about 155 mg/L (e.g. about 75 to about 85 mg/L, about 85 to about 95 mg/L, about 95 to about 105 mg/L, about 105 to about 115 mg/L, about 115 to about 125 mg/L, about 125 to about 135 mg/L, about 135 to about 145 mg/L, or about 145 to about 155 mg/L). The isoamyl alcohol can be present in an amount of, for example, about 150 to about 305 mg/L (e.g. about 155 to about 165 mg/L, about 165 to about 175 mg/L, about 175 to about 185 mg/L, about 185 to about 195 mg/L, about 195 to about 205 mg/L, about 205 to about 215 mg/L, about 215 to about 225 mg/L, about 225 to about 235 mg/L, about 235 to about 245 mg/L, about 245 to about 255 mg/L, about 255 to about 265 mg/L, about 265 to about 275 mg/L, about 275 to about 285 mg/L, about 285 to about 295 mg/L, or about 295 to about 305 mg/L). The isoamyl alcohol can be present in an amount of, for example, about 305 to about 405 mg/L (e.g. about 305 to about 315 mg/L, about 315 to about 325 mg/L, about 325 to about 335 mg/L, about 335 to about 345 mg/L, about 345 to about 355 mg/L, about 355 to about 365 mg/L, about 365 to about 375 mg/L, about 375 to about 385 mg/L, about 385 to about 395 mg/L, about 395 to about 405 mg/L). The isoamyl alcohol can be present in an amount of, for example, about 405 to about 505 mg/L (e.g., about 405 to about 415 mg/L, about 415 to about 425 mg/L, about 425 to about 435 mg/L, about 435 to about 445 mg/L, about 445 to about 455 mg/L, about 455 to about 465 mg/L, about 465 to about 475 mg/L, about 475 to about 485 mg/L, about 485 to about 495 mg/L, or about 495 to about 505 mg/L). In some cases, about 5% to about 50% by mass (e.g. about 5% to about 10%, about 10% to about 15%, about 15% to about 20%, about 20% to about 25%, about 25% to about 30%, about 30% to about 35%, about 35% to about 40%, about 40% to about 45%, or about 45% to about 50%, by mass) of the one or more additional VOCs can be isoamyl alcohol. In some cases, about 50% to about 100% by mass (e.g., about 50% to about 55%, about 55% to about 60%, about 60% to about 65%, about 65% to about 70%, about 70% to about 75%, about 75% to about 80%, about 80% to about 85%, about 85% to about 90%, about 90% to about 95%, or about 95% to about 100%, by mass) of the one or more additional VOCs can be isoamyl alcohol. In some cases, the one or more additional VOCs can include no isoamyl alcohol.

A brandy replica can include additional VOCs in any appropriate amount. For example, in some embodiments, the additional VOCs in a brandy-like alcoholic beverage can be present in a total amount of about 15 to about 150 mg/L (e.g., about 15 to about 25 mg/L, about 24 to about 44 mg/L, about 24 to about 26 mg/L, about 25 to about 40 mg/L, about 26 to about 28 mg/L, about 28 to about 30 mg/L, about 30 to about 32 mg/L, about 34 to about 36 mg/L, about 36 to about 38 mg/L, about 38 to about 40 mg/L, about 40 to about 42 mg/L, about 40 to about 55 mg/L, about 42 to about 44 mg/L, about 55 to about 70 mg/L, about 70 to about 85 mg/L, about 85 to about 100 mg/L, about 100 to about 125 mg/L, or about 125 to about 150 mg/L). In some cases, the total amount of additional (non-ethanol) VOCs in a brandy replica can be 50 mg/L or less (e.g., 50, 45, 40, 35, 30, 25, or 20 mg/L or less).

In some cases, the brandy replicas provided herein can include one or more additional non-volatile compounds. A non-limiting example of an additional non-volatile compound that can be included in a brandy replica is a coloring agent (e.g., a caramel coloring agent, a Food, Drugs and Cosmetics (FD&C) color, or a naturally-sourced color from a fruit or a vegetable). The additional non-volatile compound(s) can be present at any suitable amount within a brandy replica. In some cases, for example, added non-volatile compound(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a brandy replica. In some cases, the a brandy replica can include no added non-volatile compounds.

Examples of additional non-volatile compounds that can be included in a brandy-like alcoholic beverage include, without limitation, 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole.

In some embodiments, the additional non-volatile compounds in a brandy replica provided herein can include one or more non-volatile compounds that are not present in a corresponding traditional brandy. It is surprising that the brandy-like alcoholic beverage replicas described herein include one or more compounds not found in any tested traditional brandy, as it would be expected that to create a brandy-like alcoholic beverage, one would only think to use compounds found in one or more traditional brandies.

In some embodiments, the additional non-volatile compounds in a brandy replica provided herein can exclude one or more non-volatile compounds that are present in a corresponding traditional brandy. Examples of non-volatile compounds that can be excluded from the brandy replicas provided herein include, without limitation; (−)-corey lactone; ({[(3S,4S,5R)-2,3,4-trihydroxy-5-(hydroxymethyl)tetrahydro-2-furanyl]methyl}amino)acetic acid; ({6-[(hydroxymethyl)amino]-1,3,5-triazine-2,4-diyl}dinitrilo)tetramethanol; (+)-8-hydroxy-5,5-dimethylpeltogynan; (1,3-phenylenedioxy)diacetic acid; (1R,3S,4S,5R,7R)-4-(3-hydroxybutyl)-5-methyl-10-methylidene-8-oxatricyclo[5.3.0.03,5]decan-9-one; (1R,9R)-11-(propylsulfonyl)-5-[4-(trifluoromethoxy)phenyl]-7,11-diazatricyclo[7.3.1.02,7]trideca-2,4-dien-6-one; (1R,9R)-3-(2-fluorophenyl)-11-(phenylsulfonyl)-7,11-diazatricyclo[7.3.1.02,7]trideca-2,4-dien-6-one; (1R,9S)-11-(2-pyrazinylcarbonyl)-3-[4-(trifluoromethoxy)phenyl]-7,11-diazatricyclo[7.3.1.02,7]trideca-2,4-dien-6-one; (1R,9S)-11-[(methylsulfanyl)acetyl]-3-(2-thienyl)-7,11-diazatricyclo[7.3.1.02,7]trideca-2,4-dien-6-one; (1R,9S)-5-(4-chlorophenyl)-11-[(methylsulfanyl)acetyl]-7,11-diazatricyclo[7.3.1.02,7]trideca-2,4-dien-6-one; (1′S,2′S)-3′,11′-dihydroxy-1′,2′,5′-trimethyl-8′-oxaspiro[oxirane-2,12′-tricyclo[7.2.1.02,7]dodecan]-5′-en-4′-one; (2E)-3-(3,4-dimethoxyphenyl)acrylic acid; (2E)-decenoic acid; (2R)-2-[(2R,5S)-5-[(2S)-2-hydroxybutyl]oxolan-2-yl]propanoic acid; (2S)-2-(2-hydroxypropan-2-yl)-2H,3H,7H-furo[3,2-g]chromen-7-one; (2S)-2-hydroxy-2-(2-oxiranyl)ethyl methanesulfonate; (2S)-4-methyl-2-({[(3S,4S,5R)-2,3,4-trihydroxy-5-(hydroxymethyl)tetrahydro-2-furanyl]methyl}amino)pentanoic acid; (3,3,3-trifluoropropyl)benzene; (3R,4S)-4,6,8-trihydroxy-7-methoxy-3-methyl-3,4-dihydro-1H-isochromen-1-one; (4,6-diamino-1,3,5-triazin-2-yl)acetic acid; (4aS,9aR)-7-[2-(2,3-dimethoxyphenyl)ethyl]-2-[(4-methoxyphenyl)acetyl]decahydro-6H-pyrido[3,4-d]azepin-6-one; (4S,4aR,5S,5aR,12aS)-9-amino-4,7-bis(dimethylamino)-3,5,10,12,12a-pentahydroxy-1,11-dioxo-1,4,4a,5,5a,6,11,12a-octahydro-2-tetracenecarboxamide; (5Z)-2-amino-4,5-dihydroxy-5-{[(1E)-2-(hydroxymethyl)-1,3-butadien-1-yl]imino}pentanoic acid; (6S)-6-[(1 S,2R)-1,2-dihydroxypentyl]-4-methoxy-5,6-dihydro-2H-pyran-2-one; (E)-4-methoxycinnamic acid; (E)-ectylurea; (E)-p-coumaric acid; (hydroxyethyl)methacrylate; (p-hydroxyphenyl)glyoxal; (r)-2,5-dihydro-3,6-diethoxy-2-isopropylpyrazine; (S)-(+)-N-boc-3-pyrrolidinol; (trifluoroacetyl)isobutyrylmethane; (Z)-triethyl aconitate; L-2-aminoadipic acid; [7-hydroxy-1-(4-hydroxy-3,5-dimethoxyphenyl)-3-(hydroxymethyl)-6,8-dimethoxy-1,2,3,4-tetrahydro-2-naphthalenyl]methyl pentopyranoside; 1-(1H-imidazol-5-yl)-3-(phosphonooxy)-2-propanone; 1-(2,2-diethoxyethyl)-1H-imidazole; 1-(2′-fluoro[1,1′-biphenyl]-4-yl)propan-1-one; 1-(2-hydroxyethyl)-1-methylguanidine; 1-(2-propen-1-yl) (2E)-2-butenedioate; 1-(3,4-dimethoxyphenyl)-1,2-propanediol; 1-(3,4-dimethoxyphenyl)ethan-1-one oxime; 1-(3-trifluoromethylphenyl)-1,2-propanediol; 1-(3-trifluoromethylphenyl)piperazine; 1-(4,6-dimethoxy-1,3,5-triazin-2-yl)-8-methyl-1,2,3,4-tetrahydroquinoline; 1-(4-methyl-2-morpholino-1,3-thiazol-5-yl)ethan-1-one; 1-(5-amino-5-carboxypentyl)-5-oxoproline; 1,1,1-trifluoro-2-octanol; 1,1′-methylenebis[3-(2-hydroxyethyl)-2-pyrrolidinone]; 1,2-diethyl citrate; 1,2-difluorobenzene; 1,2-phenylenebis(1H-imidazol-1-ylmethanone); 1,3,5-trinitroso-1,3,5-triazinane; 4,4,4-trifluoro-1-(p-tolyl)-1,3-butanedione; 1,3-dimethyl-4,5,7,8-tetrahydro-1H-pyrazolo[3,4-b]thieno[3,4-e]pyridin-4-one; 1,3-divinyl-2-imidazolidinone; 1,4:3,6-dianhydro-2-[(4-carboxybutanoyl)amino]-2,5-dideoxy-5-{[4-(3-fluorophenyl)-2-pyrimidinyl]amino}-L-iditol; 1,4:3,6-dianhydro-2-deoxy-5-O-(2-methoxy-2-oxoethyl)-2-{([3-(trifluoromethyl)phenyl]carbamoyl}amino)-D-glucitol; 1,4-benzodioxan-5-carboxylic acid; 1-[2,4-dihydroxy-3-(2-hydroxyethyl)-6-methoxyphenyl]-1-butanone; 1-[2-hydroxy-3-(phenylthio)propyl]piperidine-4-carboxamide; 1-[3-(allyloxy)-2-hydroxypropyl]-2-imidazolidinone; 1-[4-(2,3-dihydroxypropoxy)-3-methoxyphenyl]-1-propanone; 1-{[4-hydroxy-6-(methoxymethyl)pyrimidin-2-yl]thio}-3,3-dimethylbutan-2-one; 1-{4-[(3S)-3-(5-phenyl-1,3,4-oxadiazol-2-yl)-1-pyrrolidinyl]-1-piperidinyl}ethanone; 10-hydroxydecanoic acid; 1-aminocyclohexanecarboxylic acid; 1-carbethoxy-4-aminopiperidine; 1-deoxy-1-L-proline-D-fructose; 1-ethyl citrate; 1-ethyl-6,8-difluoro-1,2-dihydro-3-quinolinecarboxylic acid; 1H-benzotriazole-5-carboxylic acid; 1-hydrazino-3-(4-morpholinyl)-2-propanol; 1-methylxanthine; 1-nitrosopiperazine; 1-O-acetyl-D-glucitol; 1-phenyl-1H-pyrazolo[3,4-d]pyrimidin-4-amine; 1-propylguanidine; 1-propylimidazole; 1-vinyl-2-pyrrolidone; 2-({2-oxo-2-[(2-oxo-3-azepanyl)amino]ethyl}sulfanyl)acetic acid; 2-({6-[4-(tert-butyl)phenyl]-1,4-dihydro-1,2,4,5-tetraazin-3-yl}sulfanyl)-1-(4-chlorophenyl)-1-ethanone; 2-(1-ethyl-3-methyl-1H-pyrazol-5-yl)-5-(4-methylphenyl)-1,3,4-oxadiazole; 2-(1H-imidazol-1-ylmethyl)cyclohexanone oxime; 2-(2-thienyl)-1,4-dihydroquinazolin-4-one; 2-(2-thienyl)-4H-chromen-4-one; 2-(3,5-dimethyl-1-phenyl-1H-pyrazol-4-yl)-5-methoxybenzoic acid; 2-(4-fluorophenyl)quinoline; 2-(6-hydroxyhexyl)-3-methylenesuccinic acid; 2-(acetoxymethoxy)-1,3-propanediyl diacetate; 2-(carboxymethylthio)succinic acid; 2-(dimethylamino)ethyl 5-oxo-L-prolinate; 2,1,3-benzoxadiazol-5-yl(4-phenylpiperazino)methanone; 2′,2′-difluorodeoxyuridine; 2,3,12-trihydroxy-4,6a,6b,11,12,14b-hexamethyl-8a-({[3,4,5-trihydroxy-6-(hydroxymethyl)oxan-2-yl]oxy}carbonyl)-1,2,3,4,4a,5,6,6a,6b,7,8,8a,9,10,11,12,12a, 14,14a,14b-icosahydropicene-4-carboxylic acid; 2,3-dihydroxypropyl 3-oxohexanoate; 2,4,6,8-tetranitro-2,4,6,8-tetraazanonane-1,9-diyl diacetate; 2,4,6-octatriynoic acid; 2′,4′,6′-trihydroxy-3′-prenyldihydrochalcone; 2,4-diamino-6-(4-pyridyl)-1,3,5-triazine; 2,4-difluorobenzoic acid; 2′,5′-dihydroxy-4,3′,4′,6′-tetramethoxychalcone; 2,6,3′-trihydroxy-4′-methoxy-2-benzylcoumaranone; 2,6-di[2-chloro-4-(dimethylamino)benzylidene]cyclohexan-1-one; 2,6-diaminotoluene; 2,6-dibutoxy-N,N′-dimethylisonicotinohydrazide; 2,6-di-tert-butyl-1,4-benzoquinone; 2,6-lutidine-alpha2,3-diol; 2,7,9-trimethyl-4H-pyrido[3′,2′:4,5]thieno[3,2-d][1,3]oxazin-4-one; 2-[(3,3-dimethyl-2-oxobutyl)thio]-6-oxo-4-pyridin-3-yl-1,6-dihydropyrimidine-5-carbonitrile; 2-[(3S)-1-(3-chlorobenzyl)-3-pyrrolidinyl]-1,3-benzothiazole; 2-[(3S)-1-methyl-3-pyrrolidinyl]-1H-benzimidazole-5-carbonitrile; 2-[(4,5-dimethyl-2-furyl)methylidene]-5,5-dimethylcyclohexane-1,3-dione; 2-[4-(3-hydroxypropyl)-2-methoxyphenoxy]-1,3-propanediol; 2-{(3S)-1-[4-(trifluoromethyl)benzyl]-3-pyrrolidinyl}-1,3-benzoxazole; 2-([(2E)-3-(4-hydroxyphenyl)-2-propenoyl]oxy)succinic acid; 2-{[4-methyl-5-(2-naphthyl)-4H-1,2,4-triazol-3-yl]sulfanyl}-N-phenylacetamide; 2-acetylpyridine; 2-amino-1,3,4-octadecanetriol; 2-anisidine; 2-cyano-1-(diaminomethylene)guanidine; 2′-deoxyadenosine; 2′-deoxyinosine; 2-ethylhexanoic acid; 2-furoic acid; 2H-pyran-2,4,6(3H,5H)-trione; 2-hydroxy-2-(trifluoromethyl)propionic acid; 2-imino-3a-methylperhydro-5lambda˜6˜-thieno[3,4-d][1,3]thiazole-5,5-dione; 2-isopropylmalic acid; 2-methoxyresorcinol; 2-methyl-3-hydroxybutyric acid; 2-methylglutaric acid; 2-morpholinophenyl 3,5-dimethyl-4-isoxazolesulfonate; 2-oxo-2H-chromene-3-carboxylic acid; 2-phenyl-2,4,6,7-tetrahydrothiino[4,3-c]pyrazol-3-ol; 2-vinyl-4-picoline; 3-(1H-benzo[d]imidazol-2-yl)-6-ethyl-7-hydroxy-4H-chromen-4-one; 3-(1-hydroxyethyl)-2,3,6,7,8,8a-hexahydropyrrolo[1,2-a]pyrazine-1,4-dione; 3-(2H-tetrazol-5-yl)-4(3H)-quinazolinone; 3-(2-methylpropyl)-octahydropyrrolo[1,2-a]pyrazine-1,4-dione; 3-(3,4,5-trimethoxyphenyl)propanoic acid; 3-(4-hydroxy-5-oxo-3-phenyl-2,5-dihydro-2-furanyl)propanoic acid; 3-(5,7-dimethoxy-4-oxo-4H-chromen-2-yl)propanoic acid; 3-(5-{(3S)-1-[4-(methylsulfonyl)benzyl]-3-pyrrolidinyl}-1,3,4-oxadiazol-2-yl)pyridine; 3-(5-phenyl-1,3-oxazol-2-yl)-4-(trifluoromethyl)pyridine; 3-(7-methoxy-1,3-benzodioxol-5-yl)-2-propenal; 3-(propan-2-yl)-octahydropyrrolo[1,2-a]pyrazine-1,4-dione; 3,4,5-trihydroxyphthalaldehyde; 3,4,5-trimethoxybenzoylformic acid; 3,4,5-trimethoxyphenyl acetate; 3,4-dihydroxybenzaldehyde; 3,4-dihydroxyphenylacetic acid; 3′,4′-dimethoxyacetophenone; 3,4-dimethoxyhydrocinnamic acid; 3,4-diphenyl-1H-pyrazol-5-amine; 3,4-methylenedioxy-2′,4′-dimethoxychalcone; 3,5-dimethyl-4-isoxazolecarboxylic acid; 3,5-dioxocyclohexanecarboxylic acid; 3-[(2-thienylthio)methyl]benzoic acid; 3-[(5-nitropyridin-2-yl)oxy]-1H-indazole; 3-[2-(1,3-benzodioxol-5-yl)-7-methoxy-1-benzofuran-5-yl]-3-hydroxypropyl hexopyranoside; 3-[3-(trifluoromethyl)phenyl]propan-1-ol; 3-{[(methylsulfanyl)carbonothioyl]amino}phenyl methylcarbamate; 3-acetyl-4-(4-hydroxy-3-methoxyphenyl)-2(5H)-furanone; 3-allyl-2-hydroxybenzoic acid; 3-amino-1H-pyrazolo[4,3-c]pyridine-4,6-diol; 3-amino-2-phenyl-2H-pyrazolo[4,3-c]pyridine-4,6-diol; 3-amino-4-(propylamino)cyclobut-3-ene-1,2-dione; 3-butene-1,2,3-tricarboxylic acid; 3-deoxy-D-arabino-heptulosonic acid 7-phosphate; 3-hydroxy-3-methylbutanoic acid; 3-hydroxyquinuclidine-3-carbonitrile hydrochloride; 3-methylcrotonylglycine; 3-morpholinopropylamine; 3-nitrobenzimidamide; 3-phenylpropanoic acid; 3-phenylpropylguanidine; 4-(2,3-dihydro-1H-indol-1-yl)-6-phenylthieno[2,3-d]pyrimidine; 4-(4-hydroxy-4-methylpentyl)cyclohex-3-ene-1-carbaldehyde; 4-(4-methoxyphenyl)-6-pyridin-4-yl-1,3,5-triazin-2(3H)-one; 4′-(difluoromethoxy)acetophenone; 4-(ethoxymethylidene)-7-methoxy-2-phenyl-1,2,3,4-tetrahydroisoquinoline-1,3-dione; 4-(trifluoromethoxy)anisole; 4′-(trifluoromethyl)acetophenone; 4-(trifluoromethyl)benzoic acid; 4,11-diamino-2,3-dihydro-3-imino-2-(3-methoxypropyl)-1H-naphth(2,3-f)isoindole-1,5,10-trione; 4,2′,3′,4′-tetrahydroxychalcone 4′-O-(2″-O-acetyl-6″-O-cinnamoyl) glucoside; 4,4,4-trifluoro-3-oxobutyric acid; 4,4′-difluorobenzophenone; 4,4′-methylenebis(2-nitroaniline); 4-acetyl-3-hydroxy-2-propylphenyl (dimethylamino)methanethioate; 4-benzoylbiphenyl; 4-coumaric acid; 4-ethoxycarbonyloxy-3,5-dimethoxybenzoic acid; 4-fluorobenzhydrazide; 4-hydroxy-3-methoxyphenylglycol sulfate; 4-hydroxybenzaldehyde; 4′-hydroxychalcone 4′-glucoside; 4-hydroxyphenylglycine; 4-methoxy-9-(2-methylbut-3-en-2-yl)-7H-furo[3,2-g]chromen-7-one; 4-methoxybenzaldehyde; 4-methoxycinnamic acid; 4-methoxyphthalic acid; 4-methylumbelliferyl glucuronide; 4-nitrocatechol; 4-oxo-4,5,6,7-tetrahydrobenzo[b]furan-3-carboxylic acid; 4-phenanthro[9,10-e][1,2,4]triazin-3-ylmorpholine; 4-propoxybenzoic acid; 5-(1-hydroxyethyl)-3-(2-hydroxypropyl)-2(5H)-furanone; 5,6,7,2′,3′,4′,5′-heptamethoxyflavanone; 5,6,7,8-tetramethoxy-3′,4′-methylenedioxyisoflavone; 5,6,7-trimethoxy-2-(2,3,4-trimethoxybenzylidene)indan-1-one; 5,6-dihydro-1H-pyrrolo(3,4-D)pyrimidine-2,4,7(3H)-trione; 5,6-dimethyl-3-[5-(trifluoromethyl)pyridin-2-yl]-1,2,4-triazine; 5,6-dimethyl-4-oxo-4H-pyran-2-carboxylic acid; 5,7-dihydroxy-3′,4′-dimethoxyflavone; 5-[5-hydroxy-3-(hydroxymethyl)pentyl]-8a-(hydroxymethyl)-5,6-dimethyl-3,4,4a,5,6,7,8,8a-octahydronaphthalene-1-carboxylic acid; 5-amino-1-phenyl-1H-pyrazole-4-carbonitrile; 5-amino-2-(dimethylamino)benzoic acid; 5-amino-6-(D-ribitylamino)uracil; 5-aminovaleric acid; 5-butyl-2-(4-chlorophenyl)-6-(methoxymethyl)pyrimidin-4-ol; 5-carboxyvanillic acid; 5-hydroxy-4-[3-(2-hydroxypropan-2-yl)oxiran-2-yl]-1-methyl-7-oxabicyclo[4.1.0]hept-3-en-2-one; 5-hydroxy-4-methoxy-5,6-dihydro-2H-pyran-2-one; 5-hydroxymethyl-2-furaldehyde; 5-methoxy-2(5H)-furanone; 5-methyl-1-phenyl-4-[1-(thien-2-oyl)pyrazol-5-yl]pyrazole; 5-methyl-2-nitro-N′-(pyridin-3-ylmethylene)benzohydrazide; 5-pentylresorcinol; 6-[(2-ethyl-5-oxohexyl)oxy]-6-oxohexanoic acid; 6-benzyl-2-(tert-butyl)-6,7-dihydro-4H-pyrazolo[1,5-a]pyrrolo[3,4-d]pyrimidine-5,8-dione; 6-ethylguanine; 6-hydroxycaproic acid; 6-methoxy-7,8-methylenedioxycoumarin; 6-methyl kojic acid; 6-pentyl-2H-pyran-2-one; 6-phenyl-2-thiouracil; 7-amino-2-phenylpyrazolo[1,5-a]pyrimidine-6-carbonitrile; 7-chloro-4-[(5-propyl-2-pyrimidinyl)oxy]quinazoline; 7-methoxy-6-(1,2,3-trihydroxy-3-methylbutyl)-2H-chromen-2-one; 7-oxobenz[de]anthracene; 8-[3,4-(methylenedioxy)styryl]theophylline; 8-hydroxy-3,4,9,10-tetramethoxypterocarpan; 8-methyl-1,3-diphenyl-5-piperidino-1,2,3,4,7,8-hexahydropyrido[2,3-d]pyrimidine-2,4,7-trione; 9-carboxymethoxymethylguanine; 9-methyl-2-[4-(trifluoromethyl)benzylidene]-2,3-dihydro-1H-pyrrolo[1,2-a]indol-1-one; 9-oxo-4,5,6,7,8,9-hexahvdropyrazolo[5,1-b]quinazoline-3-carbonitrile; aceanthrenequinone; acetanilide; acetoacetic acid; acetopyruvic acid; acetyl proline; acetylcholine; acrylic acid; adenine; adipic acid; agamanone; alizarin; allyl 2-(1H-benzimidazol-2-yl)-2-cyano-N-phenylethanimidothioate; allyl 2,2,2-trifluoroethyl ether; alpha-muramic acid; amidinoproline; amorphigenin O-glucoside; apocynin; argininosuccinic acid; asparagine; asperulosidic acid; azobenzene; benzoic acid; benzophenone; benzoyl glucuronide; bis-glyceryl ascorbate; caffeic acid; catechin-7-methyl ether; catechol; choline alfoscerate; chrysin 5-xyloside; cinnamyl acetoacetate; cis,cis-muconic acid; citraconic acid; citral; coniferyl aldehyde; crotonic acid; cyclo(phenylalanyl-prolyl); D-(−)-ribose; D-(+)-glucose; D-(+)-phenyllactic acid; D-(+)-proline; D-3-deoxyglucosone; demeton-S-methyl sulfone; D-glucose 6-phosphate; dibutyl succinate; diethyl {2,5-bis[(2-hydroxyethyl)amino]-3,6-dioxo-1,4-cyclohexadiene-1,4-diyl}biscarbamate; diethyl 4-[(5-phenyl-4H-1,2,4-triazol-3-yl)thio]pyridine-2,6-dicarboxylate; bis(hydroxymethyl)malonate; diethyl malonate; diethyl mesoxalate; diethyl succinate; diethyl tartrate; diethyl tetrahydrofufurylmalonate; diflubenzuron; diglycidyl ether; dihydrokavain; dihydromyricetin; dihydrothymine; dimethyl (R,R)-phloionate; dimethyl 4-hydroxyisophthalate; dimethyl 5-oxotetrahydro-2,3-furandicarboxylate; dimethyl cyclohexane-1,4-dicarboxylate; dimethyl itaconate; dimethyl phthalate; dimethyl succinate; dipropylene glycol dimethyl ether; DL-arginine; DL-lactic acid; DL-serine; dodecanediperoxoic acid; elenolic acid; epicatechin 3′,4′-dimethyl ether; epigallocatechin 3-O-caffeate; esculetin; esculin; ethyl 2-[5-(4-chlorophenyl)-1,3,4-oxadiazol-2-yl]acetate; ethyl 3,4,5-trimethoxybenzoate; ethyl 3-hydroxy-4,4,4-trifluorobutyrate; ethyl 3-methyl-5,6-dihydroimidazo[2,1-b][1,3]thiazole-2-carboxylate; ethyl 4,4,4-trifluorocrotonate; ethyl 4,5-dimethyl-2-[(quinolin-6-ylcarbonyl)amino]thiophene-3-carboxylate; ethyl 4-amino-2-(methylsulfanyl)-1,3-thiazole-5-carboxylate; ethyl 7-hydroxy-4-oxo-4H-chromene-2-carboxylate; ethyl caprate; ethyl glucoside; ethyl nicotinate; ethyl protocatechuate; ethylmalonic acid; ethyl-β-D-glucuronide; fraxetin; furaltadone; g-butyrobetaine; gentisic acid; glutamic acid; glycerin; glycidyl methacrylate; guanine; guvacine; guvacoline; hexafluoroacetylacetone; hydroxyethyl imidazolidinone; hydroxypropionylcamitine; Î±-isopropylmalate; imidazolelactic acid; imidocarb; isofraxidin; isohomovanillic acid; isoleucine; isopropyl trifluoroacetate; isovanillic acid; itaconic acid; juniperic acid; L-(−)-norephedrine; L-(+)-valine; lactamide; L-cystine; levulinic acid; L-glutamic acid 5-tert-butyl ester; L-lysine; L-proline; L-pyroglutamic acid; L-threonine; L-tyrosine; luteolin; madecassic acid; malealdehydic acid; malondialdehyde; mebutamate; melamine; melatonin; mesquitol-4beta-ol 3,8-dimethyl ether; metanephrine; methyl 3,4,5-trimethoxybenzoate; methyl 4-hydroxyphenylacetate; methyl 4-methyl-2-[({5-[4-methyl-5-(methylthio)-4H-1,2,4-triazol-3-yl]-2-thienyl}sulfonyl)amino]pentanoate; methyl alpha-D-glucoside; methyl phthalyl ethyl glycolate; methyl salicylate; monomethyl succinate; mosher's acid; N-({(2R,4S,5R)-5-[3-(2-methoxyphenyl)-1-methyl-1H-pyrazol-5-yl]-1-azabicyclo[2.2.2]oct-2-yl}methyl)acetamide; N-(4,4-difluorocyclohexyl)-2-(3-methyl-1H-pyrazol-1-yl)-6-(4-morpholinyl)-4-pyrimidinamine; N-(4-{[(2,4-diamino-6-quinazolinyl)methyl]amino}benzoyl)-L-aspartic acid; N′-(4-chlorophenyl)-4-ethylbenzohydrazide; N-(4-pyridinylmethyl)-1,2-ethanediamine; N-(tetrahydrofuran-2-ylmethyl)quinoline-8-sulfonamide; N,N-dimethyl-N′-[2-(methylthio)-7-phenylpyrazolo[1,5-a][1,3,5]triazin-4-yl]iminoformamide; N-[1-carboxy-3-(1,3-dioxo-1,3-dihydro-2H-benzo[f]isoindol-2-yl)propyl]leucyl-N-methylphenylalaninamide; N-[4-(difluoromethoxy)phenyl]-5-isoxazol-5-ylthiophene-2-sulfonamide; N-{[(2R,4S,5R)-5-ethyl-1-azabicyclo[2.2.2]oct-2-yl]methyl}-2-thiophenesulfonamide; N1-[4-(aminosulfonyl)phenyl]-2,2-dimethylpropanamide; N1-{4-[2-(1,3-benzodioxol-5-yl)-1-cyanovinyl]phenyl}-3,4,5-trimethoxybenzamide; N4-(3-chloro-4-fluorophenyl)-6-methylpyrimidine-2,4-diamine hydrochloride; N-acetyl-1-aspartylglutamic acid; N-acetylvaline; N-boc-L-proline; N-butyl-1-hydroxyimino-N-nitroso-2-oxoethylamine; N-hexahydro[1,3]thiazolo[3,4-a]pyridin-3-ylidene-1,3-benzodioxol-5-amine; nicotinamide; N-methyl-1-naphthylamine; o-succinylbenzoate; penicillic acid; phenacetin; phenylacetaldehyde; phenylglyoxylic acid; phenylmethylsulfonyl fluoride; phloionolic acid; phloroglucide; phloroglucinol; phorate oxon; pinostrobin 5-O-glucoside; piperonylidene acetone; prolylleucine; propionylcarnitine; propylparaben; pyran-4-one; pyridoxine; pyrogallol; quercetin-3β-D-glucoside; resorcinol-o,o′-diacetic acid; salicylic acid; sinapinic acid; solerone; sotolon; succinylacetone; sulfaphenazole; sulfosalicylic acid; syringaldehyde; syringic acid; syringol; terebic acid; tetramethylpyrazine; theophylline; thiodiglycol; D-threose triacetate; tiaprofenic acid; trans-2-aminomethyl-1-cyclohexanol; trans-3,4-difluorocinnamic acid; trans-4-hydroxy-L-proline; trigonelline; trimethyl trimesate; tryptamine; uvarinol; valpromide; vanillyl alcohol; and α-lactose. It is surprising that the brandy-like alcoholic beverages described herein lack one or more compounds found in every tested traditional brandies, as one would believe that compounds present in every tested traditional brandy to be important to brandy flavor.

The additional non-volatile compounds present in a brandy-like alcoholic beverage can include compounds that fall into any of several categories, including sugars, sugar alcohols, or a combination thereof; amino acids, amino acid derivatives, or a combination thereof; pH-modifying salts; organic acids; nucleobases, nucleotides, or a combination thereof; nitrogen-containing heterocycles; phenolic compounds. Additional categories can include lipids, vitamins, other flavorants, colors, tannin components, salt (e.g., NaCl). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Non-volatile compounds can be detected in traditional brandies using any suitable method, including the LC-MS method described herein. A non-volatile compound that is “not present” in a reference brandy is one that is not detected in the reference brandy using the methods set forth in Example 3. Limits of detection for various non-volatile compounds are disclosed in TABLE 6 herein.

A brandy-like alcoholic beverage can include any appropriate number of added non-volatile compounds. For example, a brandy-like alcoholic beverage can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, a brandy-like alcoholic beverage can include 1 to 35 (e.g., at least 5, at least 10, at least 20, at least 30, 1 to 5, 1 to 10, 1 to 20, 1 to 30, 5 to 10, 5 to 15, 5 to 20, 5 to 25, 5 to 30, 5 to 35, 10 to 15, 10 to 20, 10 to 25, 10 to 30, 10 to 35, 15 to 20, 15 to 25, 15 to 30, 15 to 35, 20 to 25, 20 to 30, 20 to 35, 25 to 30, 25 to 35, or 30 to 35) compounds selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole. In some embodiments, a brandy-like alcoholic beverage can include 1 to 22 (e.g., at least 3, at least 5, at least 10, at least 15, at least 20, 1 to 5, 1 to 10, 1 to 15, 1 to 20, 1 to 22, 5 to 10, 5 to 15, 5 to 20, 5 to 22, 10 to 15, 10 to 20, 10 to 22, 15 to 20, 15 to 22, or 20 to 22) compounds selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin. In some embodiments, a brandy-like alcoholic beverage can include 1 to 18 (e.g., at least 5, at least 10, at least 15, 1 to 5, 1 to 10, 1 to 15, 1 to 18, 5 to 10, 5 to 15, 5 to 18, 10 to 15, 10 to 18, or 15 to 18) compounds selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin. In some embodiments, a brandy-like alcoholic beverage can include 1 to 15 (e.g., at least 3, at least 5, at least 10, at least 12, 1 to 5, 1 to 10, 1 to 15, 5 to 10, 5 to 15, or 10 to 15) compounds selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin. In some cases, the number of non-volatile compounds in a brandy-like alcoholic beverage can be less than the number of non-volatile compounds in a single corresponding reference brandy.

Further, in some cases, the brandy-like alcoholic beverages provided herein can lack one or more (e.g., one, two, three, four, five, six, seven, eight, nine, ten, or more than ten) non-volatile compounds that are present in corresponding traditional brandies. In some cases, the overall population of non-volatile compounds in a brandy-like alcoholic beverage can have less than 95% identity to the non-volatile compounds in a corresponding reference brandy (e.g., in a single type of traditionally made brandy corresponding to the replica). For example, the non-volatile compounds in a brandy-like alcoholic beverage can have less than 90%, less than 80%, less than 70%, less than 60%, less than 50%, less than 40%, less than 30%, or less than 25% identity to the population of non-volatile compounds in a corresponding reference brandy. Some brandy-like alcoholic beverages may contain at least 1 (e.g., at least 2, at least 5, at least 10, at least 15, at least 20, at least 25, or at least 30) non-volatile compounds that are not found in a single reference brandy. Moreover, some brandy-like alcoholic beverages may contain no more than 50 (e.g., no more than 45, 40, 35, 30, 25, 20, 15, or 10) non-volatile compounds that are present in a single reference brandy. For example, in some embodiments, a brandy-like alcoholic beverage can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference brandy; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference brandies are measured using the LC-MS methods described herein. In some cases, the amount of a particular non-volatile compound in a brandy-like alcoholic beverage can be an amount, based on concentration or percent composition, that is within a range 30% higher and lower than a measured amount for that non-volatile compound in a corresponding reference brandy. For example, a non-volatile compound can be present in a brandy-like alcoholic beverage in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference brandy.

In some cases, the amount of any particular non-volatile compound in a brandy-like alcoholic beverage may be different than the amount of that non-volatile compound in a corresponding reference brandy. In some cases, the amount of a non-volatile compound in a brandy-like alcoholic beverage can be 75% or less (e.g., 70% or less, 60% or less, 50% or less, 40% or less, 30% or less, 20% or less, or 10% or less), by concentration or percent mass, than the amount of the same non-volatile compound in a corresponding reference brandy. In some cases, the amount of a non-volatile compound in a brandy-like alcoholic beverage can be 125% or more (e.g., 150% or more, 200% or more, or 300% or more), by concentration or percent mass, than the amount of the same non-volatile compound in a corresponding reference brandy.

In some cases, the one or more additional non-volatile compounds in a brandy-like alcoholic beverage can include 2-mercapto-4,6-dimethylnicotinonitrile. The 2-mercapto-4,6-dimethylnicotinonitrile can be present in an amount of, for example, about 0.04 to about 0.1 mg/L (e.g. about 0.04 to about 0.06, about 0.06 to about 0.08 mg/L, or about 0.08 to about 0.1 mg/L). In some cases, about 0.004% to about 0.6% by mass (e.g., about 0.004% to about 0.04%, about 0.04% to about 0.4%, or about 0.4% to about 0.5%, by mass) of the one or more additional non-volatile compounds can be 2-mercapto-4,6-dimethylnicotinonitrile. In some cases, the one or more additional non-volatile compounds can include no 2-mercapto-4,6-dimethylnicotinonitrile.

In some cases, the one or more additional non-volatile compounds in a brandy-like alcoholic beverage can include 4,4-dihydroxybenzophenone. The 4,4-dihydroxybenzophenone can be present in an amount of, for example, about 0.03 to about 0.1 mg/L (e.g. about 0.03 to about 0.05 mg/L, about 0.05 to about 0.07 mg/L, or about 0.09 to about 0.1 mg/L). In some cases, about 0.003% to about 0.6% by mass (e.g. about 0.003% to about 0.03%, about 0.03% to about 0.3%, or about 0.3% to about 0.6%, by mass) of the one or more additional non-volatile compounds can be 4,4-dihydroxybenzophenone. In some cases, the one or more additional non-volatile compounds can include no 4,4-dihydroxybenzophenone.

In some cases, the one or more additional non-volatile compounds in a brandy-like alcoholic beverage can include 4-methyl-2,3-dihydro-1h-pyrrolo[3,4-c]-quinoline. The 4-methyl-2,3-dihydro-1h-pyrrolo[3,4-c]-quinoline can be present in an amount of, for example, about 0.008 to about 0.017 mg/L (e.g. about 0.008 to about 0.010 mg/L, about 0.008 to about 0.012 mg/L, about 0.012 to about 0.014 mg/L, or about 0.014 to about 0.017 mg/L). In some cases, about 0.0006% to about 0.24% by mass (e.g. about 0.0006% to about 0.006%, about 0.006% to about 0.06%, or about 0.06% to about 0.24%, by mass) of the one or more additional non-volatile compounds can be 4-methyl-2,3-dihydro-1h-pyrrolo[3,4-c]-quinoline. In some cases, greater than about 0.00145% by mass (e.g., greater than about 0.002%, greater than about 0.005%, greater than about 0.01%, or greater than about 0.05%, by mass) of the one or more additional non-volatile compounds can be 4-methyl-2,3-dihydro-1h-pyrrolo[3,4-c]-quinoline. In some cases, the one or more additional non-volatile compounds can include no 4-methyl-2,3-dihydro-1h-pyrrolo[3,4-c]-quinoline.

In some cases, the one or more additional non-volatile compounds in a brandy-like alcoholic beverage can include azobenzene. The azobenzene can be present in an amount of, for example, about 0.2 to about 0.4 mg/L (e.g. about 0.2 to about 0.3 mg/L, or about 0.3 to about 0.4 mg/L). In some cases, about 0.02% to about 7.0% by mass (e.g. about 0.02% to about 0.2%, about 0.2% to about 1.0%, about 1.0% to about 1.5%, about 1.5% to about 2.0%, about 2.0% to about 2.5%, about 2.5% to about 3.0%, about 3.0% to about 3.5%, about 3.5% to about 4.0%, about 4.0% to about 4.5%, about 4.5% to about 5.0%, about 5.0% to about 5.5%, about 5.5% to about 6.0%, about 6.0% to about 6.5%, or about 6.5% to about 7.0%, by mass) of the one or more additional non-volatile compounds can be azobenzene. In some cases, greater than about 0.04% by mass (e.g., greater than about 0.05%, greater than about 0.075%, greater than about 0.1%, or greater than about 0.3%, by mass) of the one or more additional non-volatile compounds can be azobenzene. In some cases, the one or more additional non-volatile compounds can include no azobenzene.

In some cases, the one or more additional non-volatile compounds in a brandy-like alcoholic beverage can include carnosine. The carnosine can be present in an amount of, for example, about 0.4 to about 5.5 mg/L (e.g. about 0.4 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 4.5 to about 5.0 mg/L, or about 5.0 to about 5.5 mg/L). In some cases, about 0.04% to about 24.66% by mass (e.g. about 0.04% to about 0.4%, about 0.4% to about 4.0%, about 4.0% to about 6.0%, about 6.0% to about 8.0%, about 8.0% to about 10.0%, about 10.0% to about 12.0%, about 12.0% to about 14.0%, about 14.0% to about 16.0%, about 16.0% to about 18.0%, about 18.0% to about 20.0%, about 20.0% to about 22.0%, about 22.0% to about 24.0%, or about 24.0% to about 24.66%, by mass) of the one or more additional non-volatile compounds can be carnosine. In some cases, the one or more additional non-volatile compounds can include no carnosine.

In some cases, the one or more additional non-volatile compounds in a brandy-like alcoholic beverage can include choline. The choline can be present in an amount of, for example, about 0.6 to about 5.0 mg/L (e.g. about 0.6 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, or about 4.5 to about 5.0 mg/L). In some cases, about 0.005% to about 23.0% by mass (e.g. about 0.005% to about 0.05%, about 0.05% to about 0.5%, about 0.5% to about 1.0%, about 1.0% to about 2%, about 2.0% to about 4.0%, about 4.0% to about 6.0%, about 6.0% to about 8.0%, about 8.0% to about 10.0%, about 10.0% to about 12.0%, about 12.0% to about 14.0%, about 14.0% to about 16.0%, about 16.0% to about 18.0%, about 18.0% to about 20.0%, about 20.0% to about 22.0%, about or 22.0% to about 23.0%, by mass) of the one or more additional non-volatile compounds can be choline. In some cases, the one or more additional non-volatile compounds can include no choline.

In some cases, the one or more additional non-volatile compounds in a brandy-like alcoholic beverage can include betaine. The betaine can be present in an amount of, for example, about 0.001 to about 0.6 mg/L (e.g. about 0.001 to about 0.01 mg/L, about 0.01 to about 0.1 mg/L, about 0.1 to about 0.2 mg/L, about 0.2 to about 0.3 mg/L, about 0.3 to about 0.4 mg/L, about 0.4 to about 0.5 mg/L, or about 0.6 to about 0.2 mg/L). In some cases, about 0.0002% to about 3.5% by mass (e.g. about 0.0002% to about 0.002%, about 0.002% to about 0.02%, about 0.02% to about 0.2%, about 0.2% to about 1.0%, about 1.0% to about 1.5%, about 1.5% to about 2.0%, about 2.0% to about 2.5%, about 2.5% to about 3.0%, or about 3.0% to about 3.5%, by mass) of the one or more additional non-volatile compounds can be betaine. In some cases, the one or more additional non-volatile compounds can include no betaine.

In some cases, the one or more additional non-volatile compounds in a brandy-like alcoholic beverage can include trigonelline. The trigonelline can be present in an amount of, for example, about 0.003 to about 2.5 mg/L (e.g. about 0.003 to about 0.03 mg/L, about 0.003 to about 0.03 mg/L, about 0.03 to about 0.3 mg/L, about 0.3 to about 1.0 mg/L, about 1.0 to about 1.5 mg/L, about 1.5 to about 2.0 mg/L, or about 2.0 to about 2.5 mg/L). In some cases, about 0.0002% to about 11.5% by mass (e.g. about 0.0002% to about 0.002%, about 0.002% to about 0.02%, about 0.02% to about 0.2%, about 0.2% to about 1.0%, about 1.0% to about 1.5%, about 1.5% to about 2.0%, about 2.0% to about 2.5%, about 2.5% to about 3.0%, about 3.0% to about 3.5% about 4.0% to about 4.5%, about 4.5% to about 5.0%, about 5.0% to about 5.5%, about 5.5% to about 6.0%, about 6.0% to about 6.5%, about 6.5% to about 7.0%, about 7.0% to about 7.5%, about 7.5% to about 8.0%, about 8.0% to about 8.5%, about 8.5% to about 9.0%, about 9.0% to about 9.5%, about 9.5% to about 10.0%, about 10.0% to about 10.5%, about 10.5% to about 11.0%, or about 11.0% to about 11.5%, by mass) of the one or more additional non-volatile compounds can be trigonelline. In some cases, the one or more additional non-volatile compounds can include no trigonelline.

In some cases, the one or more additional non-volatile compounds in a brandy-like alcoholic beverage can include pyridoxal. The pyridoxal can be present in an amount of, for example, about 0.01 to about 0.07 mg/L (e.g. about 0.01 to about 0.02 mg/L, about 0.02 to about 0.03 mg/L, about 0.03 to about 0.04 mg/L, about 0.04 to about 0.05 mg/L, about 0.05 to about 0.06 mg/L, or about 0.06 to about 0.07 mg/L). In some cases, about 0.001% to about 0.4% by mass (e.g. about 0.001% to about 0.01%, about 0.01% to about 0.10%, about 0.1% to about 0.2%, about 0.2% to about 0.3%, or about 0.3% to about 0.4%, by mass) of the one or more additional non-volatile compounds can be pyridoxal. In some cases, the one or more additional non-volatile compounds can include no pyridoxal.

In some cases, the one or more additional non-volatile compounds in a brandy-like alcoholic beverage can include nicotinic acid. The nicotinic acid can be present in an amount of, for example, about 0.01 to about 0.5 mg/L (e.g. about 0.01 to about 0.1 mg/L, about 0.1 to about 0.2 mg/L, about 0.2 to about 0.3 mg/L, about 0.3 to about 0.4 mg/L, about 0.4 to about 0.5 mg/L). In some cases, about 0.001% to about 2.8% by mass (e.g. about 0.001% to about 0.01%, about 0.01% to about 0.1%, about 0.10% to about 1.0%, about 1.00% to about 1.5%, about 1.5% to about 2.0%, about 2.0% to about 2.5%, or about 2.5% to about 2.8%, by mass) of the one or more additional non-volatile compounds can be nicotinic acid. In some cases, the one or more additional non-volatile compounds can include no nicotinic acid.

In some cases, the one or more additional non-volatile compounds in a brandy-like alcoholic beverage can include furaneol. The furaneol can be present in an amount of, for example, about 0.2 to about 1.0 mg/L (e.g. about 0.2 to about 0.4 mg/L, about 0.4 to about 0.6 mg/L, about 0.6 to about 0.8 mg/L, or about 0.8 to about 1.0 mg/L, about 0.2 to about 0.4 mg/L). In some cases, about 0.02% to about 10.5% by mass (e.g. about 0.02% to about 0.2%, about 0.2% to about 1.0%, about 1.0% to about 1.5%, about 1.5% to about 2.0%, about 2.0% to about 2.5%, about 2.5% to about 3.0%, about 3.0% to about 3.5% about 4.0% to about 4.5%, about 4.5% to about 5.0%, about 5.0% to about 5.5%, about 5.5% to about 6.0%, about 6.0% to about 6.5%, about 6.5% to about 7.0%, about 7.0% to about 7.5%, about 7.5% to about 8.0%, about 8.0% to about 8.5%, about 8.5% to about 9.0%, about 9.0% to about 9.5%, about 9.5% to about 10.0%, or about 10.0% to about 10.5%, by mass) of the one or more additional non-volatile compounds can be furaneol. In some cases, greater than about 0.07% by mass (e.g., greater than about 0.08%, greater than about 0.1%, greater than about 0.3%, or greater than about 0.5%, by mass) of the one or more additional non-volatile compounds can be furaneol. In some cases, the one or more additional non-volatile compounds can include no furaneol.

In some cases, the one or more additional non-volatile compounds in a brandy-like alcoholic beverage can include 2,3-isopropylidene-d-ribonolactone. The 2,3-isopropylidene-d-ribonolactone can be present in an amount of, for example, about 0.09 to about 0.2 mg/L (e.g. about 0.09 to about 0.1 mg/L or about 0.1 to about 0.2 mg/L). In some cases, about 0.008% to about 3.0% by mass (e.g. about 0.008% to about 0.08% about 0.08% to about 0.8%, about 0.8% to about 1.00%, about 1.00% to about 1.5%, about 1.5% to about 2.00%, about 2.0% to about 2.5%, or about 2.5% to about 3.00%, by mass) of the one or more additional non-volatile compounds can be 2,3-isopropylidene-d-ribonolactone. In some cases, greater than about 0.02% by mass (e.g., greater than about 0.03%, greater than about 0.05%, greater than about 0.1%, or greater than about 0.3%, by mass) of the one or more additional non-volatile compounds can be 2,3-isopropylidene-d-ribonolactone. In some cases, the one or more additional non-volatile compounds can include no 2,3-isopropylidene-d-ribonolactone.

In some cases, the one or more additional non-volatile compounds in a brandy-like alcoholic beverage can include 3-methylglutaric acid. The 3-methylglutaric acid can be present in an amount of, for example, about 0.3 to about 0.8 mg/L (e.g. about 0.3 to about 0.4 mg/L, about 0.4 to about 0.5 mg/L, about 0.5 to about 0.6 mg/L, about 0.6 to about 0.7 mg/L, or about 0.7 to about 0.8 mg/L). In some cases, about 0.03% to about 4.3% by mass (e.g. about 0.03% to about 0.3%, about 0.3% to about 1.0%, about 1.0% to about 1.5%, about 1.5% to about 2.0%, about 2.0% to about 2.5%, or about 2.5% to about 3.0%, about 3.0% to about 3.5%, about 3.5% to about 4.0%, or about 4.0% to about 4.3%, by mass) of the one or more additional non-volatile compounds can be 3-methylglutaric acid. In some cases, the one or more additional non-volatile compounds can include no 3-methylglutaric acid.

In some cases, the one or more additional non-volatile compounds in a brandy-like alcoholic beverage can include homovanillic acid. The homovanillic acid can be present in an amount of, for example, about 0.2 to about 0.6 mg/L (e.g. about 0.2 to about 0.3 mg/L, about 0.3 to about 0.4 mg/L, about 0.4 to about 0.5 mg/L, or about 0.5 to about 0.6 mg/L). In some cases, about 0.02% to about 7% by mass (e.g. about 0.02% to about 0.2%, about 0.2% to about 1.0%, about 1.0% to about 1.5%, about 1.5% to about 2.0%, about 2.0% to about 2.5%, about 2.5% to about 3.0%, about 3.0% to about 3.5% about 4.0% to about 4.5%, about 4.5% to about 5.0%, about 5.0% to about 5.5%, about 5.5% to about 6.0%, about 6.0% to about 6.5%, or about 6.5% to about 7.0%, by mass) of the one or more additional non-volatile compounds can be homovanillic acid. In some cases, greater than about 0.05% by mass (e.g., greater than about 0.07%, greater than about 0.1%, greater than about 0.12%, or greater than about 0.15%, by mass) of the one or more additional non-volatile compounds can be homovanillic acid. In some cases, the one or more additional non-volatile compounds can include no homovanillic acid.

In some cases, the one or more additional non-volatile compounds in a brandy-like alcoholic beverage can include fraxetin. The fraxetin can be present in an amount of, for example, about 0.06 to about 11 mg/L (e.g. about 0.6 to about 1.0 mg/L, about 1.0 to about 2.0 mg/L, about 2.0 to about 3.0 mg/L, about 3.0 to about 4.0 mg/L, about 4.0 to about 5.0 mg/L, about 5.0 to about 6.0 mg/L, about 6.0 to about 7.0 mg/L, about 7.0 to about 8.0 mg/L, about 8.0 to about 9.0 mg/L, about 9.0 to about 10.0 mg/L, or about 10.0 to about 11.0 mg/L). In some cases, about 0.006% to about 40% by mass (e.g. about 0.006% to about 0.06%, about 0.06% to about 0.6%, about 0.6% to about 1%, about 1% to about 5%, about 5% to about 10%, about 10% to about 15%, about 15% to about 20%, about 20% to about 25%, about 25% to about 30%, about 30% to about 35%, or about 35% to about 40%, by mass) of the one or more additional non-volatile compounds can be fraxetin. In some cases, the one or more additional non-volatile compounds can include no fraxetin.

In some cases, the one or more additional non-volatile compounds in a brandy-like alcoholic beverage can include coniferyl aldehyde. The coniferyl aldehyde can be present in an amount of, for example, about 0.02 to about 0.4 mg/L (e.g. about 0.02 to about 0.2 mg/L or about 0.2 to about 0.4 mg/L). In some cases, about 0.0007% to about 18.2% by mass (e.g. about 0.0007% to about 0.007%, about 0.007% to about 0.07%, about 0.07% to about 0.7%, about 0.7% to about 1.0%, about 1.0% to about 3.0%, about 3.0% to about 4.0%, about 4.0% to about 5.0%, about 5.0% to about 6.0%, about 6.0% to about 7.0%, about 7.0% to about 8.0%, about 8.0% to about 9.0%, about 9.0% to about 10.0%, about 11.0% to about 12.0%, about 12.0% to about 13.0%, about 13.0% to about 14.0%, about 14.0% to about 15.0%, about 15.0% to about 16.0%, about 16.0% to about 17.0%, or about 17.0% to about 18.3%, by mass) of the one or more additional non-volatile compounds can be coniferyl aldehyde. In some cases, the one or more additional non-volatile compounds can include no coniferyl aldehyde.

In some cases, the one or more additional non-volatile compounds in a brandy-like alcoholic beverage can include cyclohexyl thiourea. The cyclohexyl thiourea can be present in an amount of, for example, about 0.02 to about 0.4 mg/L (e.g. about 0.02 to about 0.2 mg/L or about 0.2 to about 0.4 mg/L). In some cases, about 0.002% to about 2.0% by mass (e.g. about 0.002% to about 0.02%, about 0.02% to about 0.2%, about 0.2% to about 1.05, about 1.0% to about 1.5%, or about 1.5% to about 2.0%, by mass) of the one or more additional non-volatile compounds can be cyclohexyl thiourea. In some cases, the one or more additional non-volatile compounds can include no cyclohexyl thiourea.

In some cases, the one or more additional non-volatile compounds in a brandy-like alcoholic beverage can include cyanazine. The cyanazine can be present in an amount of, for example, about 0.009 to about 0.16 mg/L (e.g. about 0.009 to about 0.09 mg/L, about 0.09 to about 0.9 mg/L, or about 0.9 to about 0.16 mg/L). In some cases, about 0.0008% to about 0.9% by mass (e.g. about 0.0008% to about 0.008%, about 0.008% to about 0.08%, about 0.08% to about 0.8%, or about 0.8% to about 0.9%, by mass) of the one or more additional non-volatile compounds can be cyanazine. In some cases, the one or more additional non-volatile compounds can include no cyanazine.

In some cases, the one or more additional non-volatile compounds in a brandy-like alcoholic beverage can include dimethyl phthalate. The dimethyl phthalate can be present in an amount of, for example, about 0.04 to about 0.09 mg/L (e.g. about 0.04 to about 0.06 mg/L or about 0.06 to about 0.09 mg/L). In some cases, about 0.004% to about 0.5% by mass (e.g. about 0.004% to about 0.04%, about 0.04% to about 0.4%, or about 0.4% to about 0.5%, by mass) of the one or more additional non-volatile compounds can be dimethyl phthalate. In some cases, the one or more additional non-volatile compounds can include no dimethyl phthalate.

In some cases, the one or more additional non-volatile compounds in a brandy-like alcoholic beverage can include isophorone. The isophorone can be present in an amount of, for example, about 0.04 to about 0.9 mg/L (e.g. about 0.04 to about 0.06 mg/L or about 0.06 to about 0.09 mg/L). In some cases, about 0.003% to about 2% by mass (e.g. about 0.003% to about 0.03%, about 0.03% to about 0.3%, about 0.3% to about 0.5%, about 0.5% to about 0.7%, or about 0.7% to about 0.9%, by mass) of the one or more additional non-volatile compounds can be isophorone. In some cases, the one or more additional non-volatile compounds can include no isophorone.

In some cases, the one or more additional non-volatile compounds in a brandy-like alcoholic beverage can include 2,6-dimethyl-gamma-pyrone. The 2,6-dimethyl-gamma-pyrone can be present in any appropriate amount. In some cases, the one or more additional non-volatile compounds can include no 2,6-dimethyl-gamma-pyrone.

In some cases, the one or more additional non-volatile compounds in a brandy-like alcoholic beverage can include vanillin. The vanillin can be present in an amount of, for example, about 1 to about 77 mg/L (e.g. about 1 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, about 50 to about 55 mg/L, about 55 to about 60 mg/L, about 60 to about 65 mg/L, about 65 to about 70 mg/L, about 70 to about 75 mg/L, or about 75 to about 77 mg/L). In some cases, about 0.1% to about 100% by mass (e.g. about 0.1% to about 5%, about 5% to about 10%, about 10/o to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90%, about 90% to about 95%, or about 95% to about 100%, by mass) of the one or more additional non-volatile compounds can be vanillin. In some cases, the one or more additional non-volatile compounds can include no vanillin.

In some cases, the one or more additional non-volatile compounds in a brandy-like alcoholic beverage can include quinic acid. The quinic acid can be present in an amount of, for example, about 0.16 to about 8 mg/L (e.g. about 0.16 to about 1 mg/L, about 1 to about 3 mg/L, about 3 to about 5 mg/L, about 5 to about 7 mg/L, about 7 to about 8 mg/L). In some cases, about 0.01% to about 33% by mass (e.g. about 0.01% to about 0.1%, about 0.1% to about 1%, about 1% to about 5%, about 5% to about 10%, about 10% to about 15%, about 15.0% to about 20%, about 20.0% to about 25%, about 25% to about 30%, about 30% to about 33%, by mass) of the one or more additional non-volatile compounds can be quinic acid. In some cases, the one or more additional non-volatile compounds can include no quinic acid.

In some cases, the one or more additional non-volatile compounds in a brandy-like alcoholic beverage can include gallic acid. The gallic acid can be present in an amount of, for example, about 0.2 to about 16 mg/L (e.g. about 0.2 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, or about 14 to about 16 mg/L). In some cases, about 0.02% to about 53% by mass (e.g. about 0.02% to about 0.2%, about 0.2% to about 2.0%, about 2.0% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 53%, by mass) of the one or more additional non-volatile compounds can be gallic acid. In some cases, the one or more additional non-volatile compounds can include no gallic acid.

In some cases, the one or more additional non-volatile compounds in a brandy-like alcoholic beverage can include isoferulic acid. The isoferulic acid can be present in any appropriate amount. In some cases, the one or more additional non-volatile compounds can include no isoferulic acid.

In some cases, the one or more additional non-volatile compounds in a brandy-like alcoholic beverage can include scopoletin. The scopoletin can be present in an amount of, for example, about 0.003 to about 0.1 mg/L (e.g. about 0.003 to about 0.03 mg/L or about 0.03 to about 0.1 mg/L). In some cases, about 0.0003% to about 0.6% by mass (e.g. about 0.0003% to about 0.003%, about 0.003% to about 0.03%, about 0.03% to about 0.3%, about 0.3% to about 0.4%, about 0.4% to about 0.5%, or about 0.5% to about 0.6%, by mass) of the one or more additional non-volatile compounds can be scopoletin. In some cases, the one or more additional non-volatile compounds can include no scopoletin.

In some cases, the one or more additional non-volatile compounds in a brandy-like alcoholic beverage can include ethyl paraben. The ethyl paraben can be present in an amount of, for example, about 0.008 to about 0.1 mg/L (e.g. about 0.008 to about 0.08 mg/L, about 0.08 to about 0.8 mg/L, or about 0.8 to about 0.1 mg/L). In some cases, about 0.0007% to about 0.8% by mass (e.g. about 0.0007% to about 0.007%, about 0.007% to about 0.07%, or about 0.07% to about 0.8%, by mass) of the one or more additional non-volatile compounds can be ethyl paraben. In some cases, the one or more additional non-volatile compounds can include no ethyl paraben.

In some cases, the one or more additional non-volatile compounds in a brandy-like alcoholic beverage can include 3-hydroxypyridine. The 3-hydroxypyridine can be present in an amount of, for example, about 0.0005 to about 0.4 mg/L (e.g. about 0.0005 to about 0.005 mg/L, about 0.005 to about 0.05 mg/L, or about 0.05 to about 0.4 mg/L). In some cases, about 0.00004% to about 2.0% by mass (e.g. about 0.00004% to about 0.0004%, about 0.0004% to about 0.004%, about 0.004% to about 0.04%, about 0.04% to about 0.4%, about 0.4% to about 1.0%, or about 1.0% to about 2.0%, by mass) of the one or more additional non-volatile compounds can be 3-hydroxypyridine. In some cases, the one or more additional non-volatile compounds can include no 3-hydroxypyridine.

In some cases, the one or more additional non-volatile compounds in a brandy-like alcoholic beverage can include mannitol. The mannitol can be present in an amount of, for example, about 0.3 to about 31 mg/L (e.g. about 0.3 to about 3 mg/L, about 3 to about 6.0 mg/L, about 6.0 to about 9.0 mg/L, about 9.0 to about 12.0 mg/L, about 12.0 to about 15.0 mg/L, about 15.0 to about 18.0 mg/L, about 18.0 to about 21.0 mg/L, about 21.0 to about 23.0 mg/L, about 23.0 to about 25.0 mg/L, or about 28.0 to about 31.0 mg/L). In some cases, about 0.03% to about 75% by mass (e.g. about 0.03% to about 0.3%, about 0.3% to about 3%, about 0.3% to about 3%, about 3% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, or about 70% to about 75%, by mass) of the one or more additional non-volatile compounds can be mannitol. In some cases, the one or more additional non-volatile compounds can include no mannitol.

In some cases, the one or more additional non-volatile compounds in a brandy-like alcoholic beverage can include mannoheptulose. The mannoheptulose can be present in an amount of, for example, about 0.06 to about 1 mg/L (e.g. about 0.06 to about 0.6 mg/L or about 0.6 to about 1 mg/L). In some cases, about 0.008% to about 5% by mass (e.g. about 0.008% to about 0.08%, about 0.08% to about 0.8%, about 0.8% to about 1%, about 1% to about 3%, about 3% to about 5%, about 5% to about 7%, or about 7% to about 8%, by mass) of the one or more additional non-volatile compounds can be mannoheptulose. In some cases, the one or more additional non-volatile compounds can include no mannoheptulose.

In some cases, the one or more additional non-volatile compounds in a brandy-like alcoholic beverage can include trehalose. The trehalose can be present in an amount of, for example, about 1 to about 1295 mg/L (e.g. about 1 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 400 to about 450 mg/L, about 450 to about 500 mg/L, about 500 to about 550 mg/L, about 550 to about 600 mg/L, about 600 to about 650 mg/L, about 650 to about 700 mg/L, about 700 to about 750 mg/L, about 750 to about 800 mg/L, about 800 to about 850 mg/L, about 850 to about 900 mg/L, about 900 to about 950 mg/L, about 950 to about 1000 mg/L, about 1000 to about 1050 mg/L, about 1050 to about 1100 mg/L, about 1100 to about 1150 mg/L, about 1150 to about 1200 mg/L, about 1200 to about 1250 mg/L, or about 1250 to about 1295 mg/L). In some cases, trehalose can be present in an amount less than about 6.67 mg/L (e.g., less than 6.6 mg/L, less than 6 mg/L, less than 5.5 mg/L, less than 5 mg/L, or less than 3 mg/L). In some cases, about 6.5% to about 100% by mass (e.g. about 6.5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90%, about 90% to about 95%, or about 95% to about 100%, by mass) of the one or more additional non-volatile compounds can be trehalose. In some cases, the one or more additional non-volatile compounds can include no trehalose.

In some cases, the one or more additional non-volatile compounds in a brandy-like alcoholic beverage can include 3-hydroxy-2-methylpyridine. The 3-hydroxy-2-methylpyridine can be present in an amount of, for example, about 0.002 to about 0.6 mg/L (e.g. about 0.002 to about 0.02 mg/L, about 0.02 to about 0.2 mg/L, about 0.2 to about 0.4 mg/L, or about 0.4 to about 0.6 mg/L). In some cases, 3-hydroxy-2-methylpyridine can be present in an amount greater than about 0.18 mg/L (e.g., greater than about 0.19 mg/L, greater than about 0.2 mg/L, greater than about 0.25 mg/L, or greater than about 0.3 mg/L). In some cases, about 0.0002% to about 5.6% by mass (e.g. about 0.0002% to about 0.002%, about 0.002% to about 0.02%, about 0.02% to about 0.2%, about 0.2% to about 2%, about 2% to about 4%, or about 4% to about 5.6%, by mass) of the one or more additional non-volatile compounds can be 3-hydroxy-2-methylpyridine. In some cases, greater than about 0.01% by mass (e.g., greater than about 0.02%, greater than about 0.05%, greater than about 0.1%, or greater than about 0.5%, by mass) of the one or more additional non-volatile compounds can be 3-hydroxy-2-methylpyridine. In some cases, the one or more additional non-volatile compounds can include no 3-hydroxy-2-methylpyridine.

In some cases, the one or more additional non-volatile compounds in a brandy-like alcoholic beverage can include diglycerol. The diglycerol can be present in an amount of, for example, about 0.001 to about 0.3 mg/L (e.g. about 0.001 to about 0.01 mg/L, about 0.01 to about 0.1 mg/L, or about 0.1 to about 0.3 mg/L). In some cases, about 0.0001% to about 1.6% by mass (e.g. about 0.0001% to about 0.001%, about 0.001% to about 0.01%, about 0.01% to about 0.1%, about 0.1% to about 1.0%, or about 1.0% to about 1.6%, by mass) of the one or more additional non-volatile compounds can be diglycerol. In some cases, the one or more additional non-volatile compounds can include no diglycerol.

In some cases, the one or more additional non-volatile compounds in a brandy-like alcoholic beverage can include 1-(2-hydroxyethyl)-2-imidazolidenethione. The 1-(2-hydroxyethyl)-2-imidazolidenethione can be present in an amount of, for example, about 0.03 to about 0.1 mg/L (e.g. about 0.03 to about 0.05 mg/L or about 0.05 to about 0.1 mg/L). In some cases, about 0.003% to about 1.2% by mass (e.g. about 0.003% to about 0.03%, about 0.03% to about 0.3%, about 0.3% to about 0.6%, about 0.6% to about 0.9%, or about 0.9% to about 1.2%, by mass) of the one or more additional non-volatile compounds can be 1-(2-hydroxyethyl)-2-imidazolidenethione. In some cases, the one or more additional non-volatile compounds can include no 1-(2-hydroxyethyl)-2-imidazolidenethione.

In some cases, the one or more additional non-volatile compounds in a brandy-like alcoholic beverage can include 2-aminobenzothiazole. The 2-aminobenzothiazole can be present in an amount of, for example, about 0.01 to about 0.1 mg/L (e.g. about 0.01 to about 0.05 mg/L or about 0.05 to about 0.1 mg/L). In some cases, about 0.001% to about 0.1% by mass (e.g. about 0.001% to about 0.01% or about 0.01% to about 0.1%, by mass) of the one or more additional non-volatile compounds can be 2-aminobenzothiazole. In some cases, the one or more additional non-volatile compounds can include no 2-aminobenzothiazole.

Because of the methods by which they are made, the brandy-like alcoholic beverages provided herein typically lack contaminants and other detrimental compounds that sometimes are encountered in traditional brandies. These include, without limitation, organisms such as Escherichia coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxvsporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

This document also provides methods for making brandy replicas. In some cases, the methods provided herein can be carried out by first mixing water with ethanol (e.g., a grain neutral spirit and a traditional brandy, where the traditional brandy is added in an amount such that it makes up about 10 wt % or less (e.g., about 1 wt % or less) of the brandy replica product), one or more fruit juices, and oak extract and/or one or more tannins, and then adding small quantities of diluted VOCs. In general, the water, ethanol, fruit juice(s), oak extract and/or tannin(s), and added VOCs are all used to generate a final product having the characteristics of a traditionally-produced brandy.

In some cases, a method of making a brandy replica provided herein can include providing an aqueous solution and adding to the aqueous solution ingredients including ethanol (e.g., a grain neutral spirit and a traditional brandy, where the traditional brandy is added in an amount such that it makes up about 10 wt % or less (e.g., about 1 wt % or less) of the brandy replica product), one or more fruit juices, a source of a tannin and/or an oak extract, one or more nonvolatile compounds (e.g., coloring agents), and one or more (e.g., one, two, three, four, five, six, seven, eight, nine, 10, 11, 12, or more than 12) additional VOCs, where the added VOCs include an ester, an alcohol, an aldehyde and/or a ketone, a terpene, and a furan. For example, the added VOCs that are combined with the other ingredients can be selected from the group consisting of phenethyl acetate, phenylacetaldehyde, 2-pentylfuran, phenethyl alcohol, ethyl laurate, eugenol, ethyl acetate, linalool, 2,3-pentanedione, tetrahydrofurfuryl acetate, methylcyclopentenolone, and vanillin erythro and threo-butan-2,3-diol acetal.

This document also provides methods for generating concentrated versions of any brandy-like alcoholic beverage, where the concentrated versions include the traditional brandy, fruit juice, oak extract and/or tannin, added VOCs and non-volatile components (if any) of the final product, and optionally the traditional brandy, but without the full bulk of the ethanol and water (and in some cases, without the traditional brandy). Such concentrates can be manufactured and then shipped to a second location, where water and ethanol (e.g., grain neutral spirits and, optionally, traditional brandy) can be added at the appropriate ABV and volume to create a finished product.

Any suitable concentration of traditional brandy, fruit juice, oak extract, tannins, and additional VOCs and (if present) non-volatile compounds can be used. For example, a concentrated brandy-like alcoholic beverage can include traditional brandy, fruit juice, oak extract, tannins, additional VOCs, and non-volatile components (if any) at concentrations that are at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold) greater than their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic components that are present in the final product. In general, such concentrates can be prepared in much the same way as a non-concentrated brandy-like alcoholic beverage, by combining the desired amounts of ingredients but omitting the water and the bulk of the ethanol. It is noted that in some cases, some amount of ethanol can be included in the concentrate in order to facilitate dissolution of the added VOCs and, if any, non-volatile compounds.

### EXEMPLARY EMBODIMENTS

Embodiment 1 is a brandy replica comprising water, a grain neutral spirit, an oak extract, one or more tannins, or an oak extract and one or more tannins, fruit juice, at least six added volatile compounds (VOCs), wherein the added VOCs comprise at least one ester, at least one additional alcohol, at least one aldehyde or ketone, and at least one terpene or isoprenoid, and wherein the added VOCs comprise about 0.001 wt % to about 0.1 wt % of the brandy replica.

Embodiment 2 is the brandy replica of embodiment 1, further comprising a traditional brandy, wherein the brandy replica comprises no more than about 10 wt % of the traditional brandy.

Embodiment 3 is the brandy replica of embodiment 1 or embodiment 2, wherein the at least one ester comprises one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate.

Embodiment 4 is the brandy replica of embodiment 1 or embodiment 2, wherein the at least one ester comprises one or more of ethyl acetate, ethyl laurate, phenethyl acetate, and tetrahydrofurfuryl acetate.

Embodiment 5 is the brandy replica of embodiment 1 or embodiment 2, wherein the at least one ester comprises one or more of butyl isobutyrate, ethyl butyrate, hexyl 2-methylbutanoate, isobutyl isobutyrate, isobutyl propionate, and propyl acetate.

Embodiment 6 is the brandy replica of any one of embodiments 1 to 5, wherein the at least one aldehyde or ketone comprises one or more of phenylacetaldehyde, 2,3-pentanedione, 2-heptanone, and methylcyclopentenolone.

Embodiment 7 is the brandy replica of any one of embodiments 1 to 5, wherein the at least one aldehyde or ketone comprises 2,3-pentanedione.

Embodiment 8 is the brandy replica of any one of embodiments 1 to 5, wherein the at least one aldehyde or ketone comprises 2-heptanone.

Embodiment 9 is the brandy replica of any one of embodiments 1 to 8, wherein the at least one additional alcohol comprises one or both of isoamyl alcohol and phenethyl alcohol.

Embodiment 10 is the brandy replica of any one of embodiments 1 to 8, wherein the at least one additional alcohol comprises phenethyl alcohol.

Embodiment 11 is the brandy replica of any one of embodiments 1 to 8, wherein the at least one additional alcohol comprises isoamyl alcohol.

Embodiment 12 is the brandy replica of any one of embodiments 1 to 11, wherein the at least one terpene or isoprenoid comprises linalool.

Embodiment 13 is the brandy replica of any one of embodiments 1 to 12, wherein the added VOCs further comprise at least one furan, at least one acid, at least one phenol, or a combination thereof.

Embodiment 14 is the brandy replica of embodiment 13, wherein the at least one furan comprises 2-pentylfuran.

Embodiment 15 is the brandy replica of embodiment 13, wherein the at least one acid comprises butyric acid.

Embodiment 16 is the brandy replica of embodiment 13, wherein the at least one phenol comprises eugenol.

Embodiment 17 is the brandy replica of embodiment 1 or embodiment 2, wherein the added VOCs comprise at least one ester, at least one additional alcohol, at least one aldehyde or ketone, at least one terpene or isoprenoid, at least one phenol, and at least one furan.

Embodiment 18 is the brandy replica of embodiment 17, wherein the added VOCs comprise ethyl laurate, phenethyl alcohol, 2-pentylfuran, linalool, 2,3-pentanedione, eugenol, and ethyl acetate.

Embodiment 19 is the brandy replica of embodiment 1 or embodiment 2, wherein the added VOCs comprise at least one ester, at least one acid, at least one additional alcohol, at least one aldehyde or ketone, and at least one terpene or isoprenoid.

Embodiment 20 is the brandy replica of embodiment 19, wherein the added VOCs comprise propyl acetate, ethyl butyrate, isobutyl isobutyrate, hexyl 2-methylbutanoate, butyl isobutyrate, 2-heptanone, linalool, butyric acid, and isoamyl alcohol.

Embodiment 21 is the brandy replica of any one of embodiments 1 to 20, further comprising at least one added non-volatile compound.

Embodiment 22 is the brandy replica of embodiment 21, wherein the at least one added non-volatile compound comprises a color compound.

Embodiment 23 is the brandy replica of embodiment 21, wherein the at least one added non-volatile compound is selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole.

Embodiment is the brandy replica of embodiment 21, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin.

Embodiment 25 is the brandy replica of embodiment 21, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin.

Embodiment 26 is the brandy replica of embodiment 21, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

Embodiment 27 is the brandy replica of any one of embodiments 1 to 26, comprising from about 5 wt % to about 70 wt % water, from about 30 wt % to about 95 wt % grain neutral spirits, from about 0.5 wt % to about 10 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs.

Embodiment 28 is a brandy replica comprising water, a grain neutral spirit, an oak extract, one or more tannins, or an oak extract and one or more tannins, fruit juice, and at least six added VOCs, wherein the added VOCs comprise about 0.001 wt % to about 0.1 wt % of the brandy replica.

Embodiment 29 is the brandy replica of embodiment 28, further comprising a traditional brandy, wherein the brandy replica comprises no more than about 10 wt % of the traditional brandy.

Embodiment 30 is the brandy replica of embodiment 28 or embodiment 29, wherein the added VOCs comprise at least one VOC selected from the group consisting of tetrahydrofurfuryl acetate, isobutyl propionate, isobutyl isobutyrate, hexyl 2-methylbutanoate, butyl isobutyrate, and 2-pentylfuran.

Embodiment 31 is the brandy replica of any one of embodiments 28 to 30, wherein the added VOCs comprise phenethyl alcohol, and wherein the phenethyl alcohol is present in the brandy replica at a concentration less than about 1.28 mg/L.

Embodiment 32 is the brandy replica of any one of embodiments 28 to 31, wherein the added VOCs comprise 2,3-pentanedione, and wherein the 2,3-pentanedione is present in the brandy replica at a concentration less than about 0.17 mg/L.

Embodiment 33 is the brandy replica of any one of embodiments 28 to 32, wherein the added VOCs comprise butyric acid, and wherein the butyric acid is present in the brandy replica at a concentration less than about 0.16 mg/L.

Embodiment 34 is the brandy replica of any one of embodiments 28 to 33, wherein the added VOCs comprise propyl acetate, and wherein propyl acetate is present in the brandy replica at a concentration of at least about 0.75 mg/L.

Embodiment 35 is the brandy replica of any one of embodiments 28 to 34, wherein the added VOCs comprise ethyl butyrate, and wherein the ethyl butyrate is present in the brandy replica at a concentration of at least about 5 mg/L.

Embodiment 36 is the brandy replica of any one of embodiments 28 to 35, wherein the added VOCs comprise 2-heptanone, and wherein the 2-heptanone is present in the brandy replica at a concentration of at least about 0.03 mg/L.

Embodiment 37 is the brandy replica of any one of embodiments 28 to 36, wherein the added VOCs comprise propyl acetate, and wherein the brandy replica comprises at least about 0.018% by mass of the propyl acetate.

Embodiment 38 is the brandy replica of any one of embodiments 28 to 37, wherein the added VOCs comprise ethyl butyrate, and wherein the brandy replica comprises at least about 0.11% by mass of the ethyl butyrate.

Embodiment 39 is the brandy replica of any one of embodiments 28 to 38, wherein the added VOCs comprise 2-heptanone, and wherein the brandy replica comprises at least about 0.00068% by mass of the 2-heptanone.

Embodiment 40 is the brandy replica of any one of embodiments 28 to 39, wherein the added VOCs comprise eugenol, and wherein the brandy replica comprises at least about 0.007% by mass of the eugenol.

Embodiment 41 is the brandy replica of any one of embodiments 28 to 40, further comprising an added non-volatile compound.

Embodiment 42 is the brandy replica of embodiment 41, wherein the added non-volatile compound comprises trehalose, and wherein the trehalose is present in the brandy replica at a concentration less than about 6.67 mg/L.

Embodiment 43 is the brandy replica of embodiment 41 or embodiment 42, wherein the added non-volatile compound comprises 3-hydroxy-2-methylpyridine, and wherein the 3-hydroxy-2-methylpyridine is present in the brandy replica at a concentration of at least about 0.18 mg/L.

Embodiment 44 is the brandy replica of any one of embodiments 41 to 43, wherein the added non-volatile compound comprises 3-hydroxy-2-methylpyridine, and wherein the brandy replica comprises at least about 0.01% by mass of the 3-hydroxy-2-methylpyridine.

Embodiment 45 is the brandy replica of any one of embodiments 41 to 44, wherein the added non-volatile compound comprises 4-methyl-2,3-dihydro-1H-pyrrolo[3,4-c]-quinoline, and wherein the brandy replica comprises at least about 0.00145% by mass of the 4-methyl-2,3-dihydro-1H-pyrrolo[3,4-c]-quinoline.

Embodiment 46 is the brandy replica of any one of embodiments 41 to 45, wherein the added non-volatile compound comprises azobenzene, and wherein the brandy replica comprises at least about 0.04% by mass of the azobenzene.

Embodiment 47 is the brandy replica of any one of embodiments 41 to 46, wherein the added non-volatile compound comprises furaneol, and wherein the brandy replica comprises at least about 0.07% by mass of the furaneol.

Embodiment 48 is the brandy replica of any one of embodiments 41 to 47, wherein the added non-volatile compound comprises 2,3-isopropylidene-D-ribonolactone, and wherein the brandy replica comprises at least about 0.02% by mass of the 2,3-isopropylidene-D-ribonolactone.

Embodiment 49 is the brandy replica of any one of embodiments 41 to 48, wherein the added non-volatile compound comprises homovanillic acid, and wherein the brandy replica comprises at least about 0.05% by mass of the homovanillic acid.

Embodiment 50 is a method for making a brandy replica, wherein the method comprises combining water, a grain neutral spirit, an oak extract, a tannin, or an oak extract and a tannin, a fruit juice, at least six VOCs, wherein the VOCs are provided as separate ingredients and comprise at least one ester, at least one additional alcohol, at least one aldehyde or ketone, and at least one terpene or isoprenoid, and wherein the added VOCs comprise about 0.001 wt % to about 0.1 wt % of the brandy replica, optionally, a traditional brandy, such that the brandy replica comprises no more than about 10 wt % of the traditional brandy.

Embodiment 51 is the method of embodiment 50, wherein the at least one ester comprises one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate.

Embodiment 52 is the method of embodiment 50, wherein the at least one ester comprises one or more of ethyl acetate, ethyl laurate, phenethyl acetate, and tetrahydrofurfuryl acetate.

Embodiment 53 is the method of embodiment 50, wherein the at least one ester comprises one or more of butyl isobutyrate, ethyl butyrate, hexyl 2-methylbutanoate, isobutyl isobutyrate, isobutyl propionate, and propyl acetate.

Embodiment 54 is the method of any one of embodiments 50 to 53, wherein the at least one aldehyde or ketone comprises one or more of phenylacetaldehyde, 2,3-pentanedione, 2-heptanone, and methylcyclopentenolone.

Embodiment 55 is the method of any one of embodiments 50 to 53, wherein the at least one aldehyde or ketone comprises 2,3-pentanedione.

Embodiment 56 is the method of any one of embodiments 50 to 53, wherein the at least one aldehyde or ketone comprises 2-heptanone.

Embodiment 57 is the method of any one of embodiments 50 to 56, wherein the at least one additional alcohol comprises one or both of isoamyl alcohol and phenethyl alcohol.

Embodiment 58 is the method of any one of embodiments 50 to 56, wherein the at least one additional alcohol comprises phenethyl alcohol.

Embodiment 59 is the method of any one of embodiments 50 to 56, wherein the at least one additional alcohol comprises isoamyl alcohol.

Embodiment 60 is the method of any one of embodiments 50 to 59, wherein the at least one terpene or isoprenoid comprises linalool.

Embodiment 61 is the method of any one of embodiments 50 to 60, wherein the added VOCs further comprise at least one furan, at least one acid, at least one phenol, or a combination thereof.

Embodiment 62 is the method of embodiment 61, wherein the at least one furan comprises 2-pentylfuran.

Embodiment 63 is the method of embodiment 61, wherein the at least one acid comprises butyric acid.

Embodiment 64 is the method of embodiment 61, wherein the at least one phenol comprises eugenol.

Embodiment 65 is the method of embodiment 50, wherein the added VOCs comprise at least one ester, at least one additional alcohol, at least one aldehyde or ketone, at least one terpene or isoprenoid, at least one phenol, and at least one furan.

Embodiment 66 is the method of embodiment 65, wherein the added VOCs comprise ethyl laurate, phenethyl alcohol, 2-pentylfuran, linalool, 2,3-pentanedione, eugenol, and ethyl acetate.

Embodiment 67 is the method of embodiment 50, wherein the added VOCs comprise at least one ester, at least one acid, at least one additional alcohol, at least one aldehyde or ketone, and at least one terpene or isoprenoid.

Embodiment 68 is the method of embodiment 67, wherein the added VOCs comprise propyl acetate, ethyl butyrate, isobutyl isobutyrate, hexyl 2-methylbutanoate, butyl isobutyrate, 2-heptanone, linalool, butyric acid, and isoamyl alcohol.

Embodiment 69 is the method of any one of embodiments 50 to 68, further comprising combining at least one added non-volatile compound with the water, grain neutral spirit, oak extract and/or tannin, fruit juice, at least six VOCs, and optional traditional brandy.

Embodiment 70 is the method of embodiment 69, wherein the at least one added non-volatile compound comprises a color compound.

Embodiment 71 is the method of embodiment 69, wherein the at least one added non-volatile compound is selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole.

Embodiment 72 is the method of embodiment 69, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin.

Embodiment is the method of embodiment 69, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin.

Embodiment is the method of embodiment 69, wherein the at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

Embodiment 75 is the method of any one of embodiments 50 to 74, wherein the brandy replica comprises from about 5 wt % to about 70 wt % water, from about 30 wt % to about 95 wt % grain neutral spirits, from about 0.5 wt % to about 10 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs.

Embodiment 76 is a method for making a brandy replica, wherein the method comprises combining water, a grain neutral spirit, an oak extract, a tannin, or an oak extract and a tannin, a fruit juice, at least six VOCs, wherein the VOCs are provided as separate ingredients, and wherein the VOCs comprise about 0.001 wt % to about 0.1 wt % of the brandy replica, and optionally, a traditional brandy, wherein the brandy replica comprises no more than about 10 wt % of the traditional brandy.

Embodiment 77 is the method of embodiment 76, wherein the added VOCs comprise at least one VOC selected from the group consisting of tetrahydrofurfuryl acetate, isobutyl propionate, isobutyl isobutyrate, hexyl 2-methylbutanoate, butyl isobutyrate, and 2-pentylfuran.

Embodiment 78 is the method of embodiment 76 or embodiment 77, wherein the added VOCs comprise phenethyl alcohol, and wherein the phenethyl alcohol is present in the brandy replica at a concentration less than about 1.28 mg/L.

Embodiment 79 is the method of any one of embodiments 76 to 78, wherein the added VOCs comprise 2,3-pentanedione, and wherein the 2,3-pentanedione is present in the brandy replica at a concentration less than about 0.17 mg/L.

Embodiment 80 is the method of any one of embodiments 76 to 79, wherein the added VOCs comprise butyric acid, and wherein the butyric acid is present in the brandy replica at a concentration less than about 0.16 mg/L.

Embodiment 81 is the method of any one of embodiments 76 to 80, wherein the added VOCs comprise propyl acetate, and wherein propyl acetate is present in the brandy replica at a concentration of at least about 0.75 mg/L.

Embodiment 82 is the method of any one of embodiments 76 to 81, wherein the added VOCs comprise ethyl butyrate, and wherein the ethyl butyrate is present in the brandy replica at a concentration of at least about 5 mg/L.

Embodiment 83 is the method of any one of embodiments 76 to 82, wherein the added VOCs comprise 2-heptanone, and wherein the 2-heptanone is present in the brandy replica at a concentration of at least about 0.03 mg/L.

Embodiment 84 is the method of any one of embodiments 76 to 83, wherein the added VOCs comprise propyl acetate, and wherein the brandy replica comprises at least about 0.018% by mass of the propyl acetate.

Embodiment 85 is the method of any one of embodiments 76 to 84, wherein the added VOCs comprise ethyl butyrate, and wherein the brandy replica comprises at least about 0.11% by mass of the ethyl butyrate.

Embodiment 86 is the method of any one of embodiments 76 to 85, wherein the added VOCs comprise 2-heptanone, and wherein the brandy replica comprises at least about 0.00068% by mass of the 2-heptanone.

Embodiment 87 is the method of any one of embodiments 76 to 86, wherein the added VOCs comprise eugenol, and wherein the brandy replica comprises at least about 0.007% by mass of the eugenol.

Embodiment 88 is the method of any one of embodiments 76 to 87, further comprising combining an added non-volatile compound with the water, grain neutral spirit, an oak extract and/or tannin, fruit juice, at least six VOCs, and optional traditional brandy.

Embodiment 89 is the method of embodiment 88, wherein the added non-volatile compound comprises trehalose, and wherein the trehalose is present in the brandy replica at a concentration less than about 6.67 mg/L.

Embodiment 90 is the method of embodiment 88 or embodiment 89, wherein the added non-volatile compound comprises 3-hydroxy-2-methylpyridine, and wherein the 3-hydroxy-2-methylpyridine is present in the brandy replica at a concentration of at least about 0.18 mg/L.

Embodiment 91 is the method of any one of embodiments 88 to 90, wherein the added non-volatile compound comprises 3-hydroxy-2-methylpyridine, and wherein the brandy replica comprises at least about 0.01% by mass of the 3-hydroxy-2-methylpyridine.

Embodiment 92 is the method of any one of embodiments 88 to 91, wherein the added non-volatile compound comprises 4-methyl-2,3-dihydro-1H-pyrrolo[3,4-c]-quinoline, and wherein the brandy replica comprises at least about 0.00145% by mass of the 4-methyl-2,3-dihydro-1H-pyrrolo[3,4-c]-quinoline.

Embodiment 93 is the method of any one of embodiments 88 to 92, wherein the added non-volatile compound comprises azobenzene, and wherein the brandy replica comprises at least about 0.04% by mass of the azobenzene.

Embodiment 94 is the method of any one of embodiments 88 to 93, wherein the added non-volatile compound comprises furaneol, and wherein the brandy replica comprises at least about 0.07% by mass of the furaneol.

Embodiment 95 is the method of any one of embodiments 88 to 94, wherein the added non-volatile compound comprises 2,3-isopropylidene-D-ribonolactone, and wherein the brandy replica comprises at least about 0.02% by mass of the 2,3-isopropylidene-D-ribonolactone.

Embodiment 96 is the method of any one of embodiments 88 to 95, wherein the added non-volatile compound comprises homovanillic acid, and wherein the brandy replica comprises at least about 0.05% by mass of the homovanillic acid.

Embodiment 97 is a brandy replica produced by the method of any one of embodiments 50 to 96.

Embodiment 98 is a brandy-like alcoholic beverage concentrate comprising an oak extract, fruit juice, tannins, at least six added VOCs, wherein the added VOCs comprise at least one ester, at least one additional alcohol, at least one aldehyde or ketone, and at least one terpene or isoprenoid, and wherein at least one of the added VOCs is present in a concentration of at least about 2-fold the concentration of the same VOC in a corresponding traditional brandy, and optionally, a traditional brandy, wherein the alcoholic beverage, after dilution to produce a final product, comprises no more than about 10 wt % of the traditional brandy.

Embodiment 99 is the brandy-like alcoholic beverage concentrate of embodiment 98, wherein at least one of the added VOCs is present in the concentrate in a concentration of at least about 5-fold the concentration of the same VOCs in a corresponding traditional brandy.

Embodiment 100 is the brandy-like alcoholic beverage concentrate of embodiment 98, wherein at least one of the added VOCs is present in the concentrate in a concentration of at least about 10-fold the concentration of the same VOCs in a corresponding traditional brandy.

Embodiment 101 is the brandy-like alcoholic beverage concentrate of embodiment 98, wherein at least one of the added VOCs is present in the concentrate in a concentration of at least about 15-fold the concentration of the same VOCs in a corresponding traditional brandy.

Embodiment 102 is the brandy-like alcoholic beverage of any one of embodiments 98 to 101, wherein upon dilution of the brandy-like beverage concentrate to a brandy-like alcoholic beverage, the brandy-like alcoholic beverage is the brandy replica of any one of embodiments 1 to 49.

Embodiment 103 is a method of making a brandy-like alcoholic beverage concentrate, the method comprising combining an oak extract, fruit juice, tannins, at least six added VOCs, wherein the added VOCs comprise at least one ester, at least one additional alcohol, at least one aldehyde or ketone, and at least one terpene or isoprenoid, and wherein at least one of the added VOCs is present in a concentration of at least about 2-fold the concentration of the same VOC in a corresponding traditional brandy, optionally, a traditional brandy, wherein the alcoholic beverage, after dilution to produce a final product, comprises no more than about 10 wt % of the traditional brandy.

Embodiment 104 is the method of embodiment 103, wherein at least one of the added VOCs is present in the concentrate in a concentration of at least about 5-fold the concentration of the same VOCs in a corresponding traditional brandy.

Embodiment 105 is the method of embodiment 103, wherein at least one of the added VOCs is present in the concentrate in a concentration of at least about 10-fold the concentration of the same VOCs in a corresponding traditional brandy.

Embodiment 106 is the method of embodiment 103, wherein at least one of the added VOCs is present in the concentrate in a concentration of at least about 15-fold the concentration of the same VOCs in a corresponding traditional brandy.

Embodiment 107 is the method of any one of embodiments 103 to 106, wherein upon dilution of the brandy-like beverage concentrate to a brandy-like alcoholic beverage, the brandy-like alcoholic beverage is the brandy replica of any one of embodiments 1 to 49.

Embodiment 108 is an alcoholic beverage comprising (or consisting essentially of or consisting of) water, a grain neutral spirit, a traditional brandy (where the alcoholic beverage comprises no more than about 10 wt % of the traditional brandy), an oak extract, fruit juice, tannins, and at least six added VOCs, where the added VOCs comprise at least one ester, at least one aldehyde, at least one furan, at least one additional alcohol, at least one terpene, and at least one ketone, and wherein the added VOCs comprise about 0.001 wt % to about 0.1 wt % of the alcoholic beverage.

Embodiment 109 is the alcoholic beverage of embodiment 108, wherein the at least one ester comprises one or more of phenethyl acetate, ethyl laurate, ethyl acetate, and tetrahydrofurfuryl acetate.

Embodiment 110 is the alcoholic beverage of embodiment 108 or embodiment 109, wherein the at least one aldehyde comprises phenylacetaldehyde.

Embodiment 111 is the alcoholic beverage of any one of embodiments 108 to 110, wherein the at least one furan comprises 2-pentylfuran.

Embodiment 112 is the alcoholic beverage of any one of embodiments 108 to 111, wherein the at least one additional alcohol comprises one or both of phenethyl alcohol and eugenol.

Embodiment 113 is the alcoholic beverage of any one of embodiments 108 to 112, wherein the at least one terpene comprises linalool.

Embodiment 114 is the alcoholic beverage of any one of embodiments 108 to 113, wherein the at least one ketone comprises one or both of 2,3-pentanedione and methylcyclopentenolone.

Embodiment 115 is the alcoholic beverage of any one of embodiments 108 to 114, wherein the added VOCs comprise vanillin erythro and threo-butan-2,3-diol acetal.

Embodiment 116 is the alcoholic beverage of any one of embodiments 108 to 115, further comprising a color compound.

Embodiment 117 is the alcoholic beverage of any one of embodiments 108 to 116, wherein the added VOCs comprise phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 118 is the alcoholic beverage of any one of embodiments 108 to 117, comprising from about 5 wt % to about 70 wt % water, from about 30 wt % to about 95 wt % grain neutral spirits, not more than about 1 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs, where the added VOCs comprise phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 119 is the alcoholic beverage of embodiment 118, where the added VOCs consist of phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 120 is a method for making an alcoholic beverage, where the method comprises combining water, a grain neutral spirit, a traditional brandy (where the alcoholic beverage comprises no more than about 10 wt % of the traditional brandy), an oak extract, fruit juice, tannins, and at least six VOCs, where the VOCs are provided as separate ingredients and comprise at least one ester, at least one aldehyde, at least one furan, at least one additional alcohol, at least one terpene, and at least one ketone, and wherein the added VOCs comprise about 0.001 wt % to about 0.1 wt % of the alcoholic beverage.

Embodiment 121 is the method of embodiment 120, wherein the at least one ester comprises one or more of phenethyl acetate, ethyl laurate, ethyl acetate, and tetrahydrofurfuryl acetate.

Embodiment 122 is the method of embodiment 120 or embodiment 121, wherein the at least one aldehyde comprises phenylacetaldehyde.

Embodiment 123 is the method of any one of embodiments 120 to 122, wherein the at least one furan comprises 2-pentylfuran.

Embodiment 124 is the method of any one of embodiments 120 to 123 wherein the at least one additional alcohol comprises one or both of phenethyl alcohol and eugenol.

Embodiment 125 is the method of any one of embodiments 120 to 124, wherein the at least one terpene comprises linalool.

Embodiment 126 is the method of any one of embodiments 120 to 125, wherein the at least one ketone comprises one or both of 2,3-pentanedione and methylcyclopentenolone.

Embodiment 127 is the method of any one of embodiments 120 to 126, wherein the added VOCs comprise vanillin erythro and threo-butan-2,3-diol acetal.

Embodiment 128 is the method of any one of embodiments 120 to 127, further comprising adding a color compound.

Embodiment 129 is the method of any one of embodiments 120 to 128, wherein the added VOCs comprise phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 130 is the method of any one of embodiments 120 to 129, where the alcoholic beverage comprises from about 5 wt % to about 70 wt % water, from about 30 wt % to about 95 wt % grain neutral spirits, not more than about 1 wt % traditional brandy, from about 0.1 wt % to about 10 wt % oak extract, from about 0.1 wt % to about 10 wt % fruit juice, from about 0.001 wt % to about 1 wt % tannins, from about 0.01 wt % to about 1 wt % color, and from about 0.001 wt % to about 0.1 wt % added VOCs, where the added VOCs comprise phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 131 is the method of embodiment 130, where the added VOCs consist of phenethyl acetate, ethyl laurate, ethyl acetate, tetrahydrofurfuryl acetate, phenylacetaldehyde, 2-pentylfuran, phenethyl alcohol, eugenol, linalool, 2,3-pentanedione, methylcyclopentenolone, and vanillin erythro and threo-butan-2,3-diol acetal.

Embodiment 132 is an alcoholic beverage produced by the method of any one of embodiments 120 to 131.

Embodiment 133 is a brandy-like alcoholic beverage concentrate comprising a traditional brandy (where the alcoholic beverage, after dilution to produce a final product, comprises no more than about 10 wt % of the traditional brandy), an oak extract, fruit juice, tannins, and at least six added VOCs, where the added VOCs comprise at least one ester, at least one aldehyde, at least one furan, at least one additional alcohol, at least one terpene, and at least one ketone, and where at least one of the added VOCs is present in a concentration of at least about 2-fold the concentration of the same VOC in a corresponding traditional brandy.

Embodiment 134 is the brandy-like alcoholic beverage concentrate of embodiment 133, wherein at least one of the added VOCs is present in the concentrate in a concentration of at least about 5-fold the concentration of the same VOCs in a corresponding traditional brandy.

Embodiment 135 is the brandy-like alcoholic beverage concentrate of embodiment 133, wherein at least one of the added VOCs is present in the concentrate in a concentration of at least about 10-fold the concentration of the same VOCs in a corresponding traditional brandy.

Embodiment 136 is the brandy-like alcoholic beverage concentrate of embodiment 133, wherein at least one of the added VOCs is present in the concentrate in a concentration of at least about 15-fold the concentration of the same VOCs in a corresponding traditional brandy.

Embodiment 137 is the brandy-like alcoholic beverage of any one of embodiments 133 to 136, wherein upon dilution of the brandy-like beverage concentrate to a brandy-like alcoholic beverage, the brandy-like alcoholic beverage is the alcoholic beverage of any one of embodiments 108-119.

Embodiment 138 is a method of making a brandy-like alcoholic beverage concentrate, where the method comprises combining a traditional brandy (where the alcoholic beverage, after dilution to produce a final product, comprises no more than about 10 wt % of the traditional brandy), an oak extract, fruit juice, tannins, and at least six added VOCs, where the added VOCs comprise at least one ester, at least one aldehyde, at least one furan, at least one additional alcohol, at least one terpene, and at least one ketone, and where at least one of the added VOCs is present in a concentration of at least about 2-fold the concentration of the same VOC in a corresponding traditional brandy.

Embodiment 139 is the method of embodiment 138, wherein at least one of the added VOCs is present in the concentrate in a concentration of at least about 5-fold the concentration of the same VOCs in a corresponding traditional brandy.

Embodiment 140 is the method of embodiment 138, wherein at least one of the added VOCs is present in the concentrate in a concentration of at least about 10-fold the concentration of the same VOCs in a corresponding traditional brandy.

Embodiment 141 is the method of embodiment 138, wherein at least one of the added VOCs is present in the concentrate in a concentration of at least about 15-fold the concentration of the same VOCs in a corresponding traditional brandy.

Embodiment 142 is the method of any one of embodiments 138 to 141, wherein upon dilution of the brandy-like beverage concentrate to a brandy-like alcoholic beverage, the brandy-like alcoholic beverage is the alcoholic beverage of any one of embodiments 108-119.

The invention will be further described in the following examples, which do not limit the scope of the invention described in the claims.

### EXAMPLES

### Example 1—Exemplary Flavored Brandy-Like Alcoholic Beverage

Brandy replicas were prepared using the components listed in TABLE 1A. In some cases, the ingredients included the exemplary VOCs listed in TABLES 1B-1D. The ingredients were added to a mixing tank in no particular order, and were mixed for 15-20 minutes and then held until being placed into the desired containers (e.g., bottles or cans).

The brandy replica had a final ABV of 40%, and was comparable to brandy crafted by traditional methods in terms of its flavor, aroma, fruit characteristics, mouthfeel and overall sensory experience.

It also is to be noted that while brandy replicas can include added VOCs and, in some cases, non-volatile compounds, the added compounds may react with one another to generate additional compounds, or to change the effective amount of one or more of the added compounds within the brandy replica formulation.

TABLE 1A
Exemplary brandy replica formulation

| | Exemplary |
|---|---|
| Ingredient | wt % |
| Water | 5-70 |
| Alcohol (grain neutral spirits and traditional brandy) | 30-95 |
| Oak Extract | 0.1-10 |
| Fruit Juice(s) | 0.1-10 |
| Tannins | 0.001-1 |
| Colors | 0.01-1 |
| Total VOCs: | 0.0000001-0.1 |
| Ester(s) | 0-0.1 |
| Aldehyde(s) | 0-0.1 |
| Furan(s) | 0-0.1 |
| Alcohol(s) | 0-0.1 |
| Terpene(s) | 0-0.1 |
| Ketone(s) | 0-0.1 |
| Acetal(s) | 0-0.1 |

TABLE 1B
Exemplary VOCs in brandy replica

| | Exemplary wt % |
|---|---|
| VOC | (in replica) |
| phenethyl acetate | 0.00000049-0.00000091 |
| phenylacetaldehyde | 0.00000021-0.00000039 |
| 2-pentylfuran | 0.00000049-0.00000091 |
| phenethyl alcohol | 0.00000049-0.00000091 |
| ethyl laurate | 0.00000147-0.00000273 |
| eugenol | 0.00000056-0.00000104 |
| ethyl acetate | 0.00001477-0.00002743 |
| linalool | 0.00000007-0.00000013 |
| 2,3-pentanedione | 0.00000077-0.00000143 |
| tetrahydrofurfuryl acetate | 0.00000035-0.00000065 |
| methylcyclopentenolone | 0.00000441-0.00000819 |
| vanillin erythro and threo- | 0.00000294-0.00000546 |
| butan-2,3-diol acetal | |

TABLE 1C
Exemplary VOCs in brandy replica

| VOC | Exemplary wt % (in replica) |
|---|---|
| phenethyl acetate | 0.000009%-0.000036% |
| tetrahydrofurfuryl acetate | 0.000007%-0.000026% |
| ethyl laurate | 0.000026%-0.000104% |
| phenethyl alcohol | 0.000009%-0.000036% |
| 2-pentylfuran | 0.000009%-0.000036% |
| linalool | 0.000002%-0.000006% |
| 2,3-pentanedione | 0.000013%-0.000052% |
| eugenol | 0.000011%-0.000042% |
| ethyl acetate | 0.000258%-0.001030% |

TABLE 1D
Exemplary VOCs in brandy replica

| VOC | Exemplary wt % (in replica) |
|---|---|
| isobutyl propionate | 0,000041%-0.000164% |
| propyl acetate | 0.000123%-0.000490% |
| ethyl butyrate | 0.000196%-0.000782% |
| isobutyl isobutyrate | 0.000049%-0.000196% |
| hexyl 2-methylbutanoate | 0.000033%-0.000130% |
| butyl isobutyrate | 0.000123%-0.000490% |
| 2-heptanone | 0.000014%-0.000054% |
| linalool | 0.000001%-0.000004% |
| butyric acid | 0.000008%-0.000032% |
| isoamyl alcohol | 0.000652%-0.002608% |

### Example 2—Scaled Up Production and Generation of Concentrated Brandy Replicas

It is to be noted that the above process, and similar processes using variations of the ingredient list, are scaled up for commercial production of a brandy-like alcoholic beverage. Such scaled up processes (e.g., to generate 1000 L or more) can utilize tanks or vat., for example.

Brandy replica concentrates are made in ˜100 L test batches and held for a minimum of 8 weeks, with periodic sampling at 1, 2, 4, 6, and 8 weeks. Density measurements are taken each week, and three replicate bottles of brandy replicas are produced by adding 43% ABV neutral grain spirits prior to filtering through a 0.45 PVDF vacuum filter. Samples are then submitted for analytical testing versus a corresponding non-concentrated brandy replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

To find the appropriate volume of concentrate (5×, 10×, or 20×) to add to create a finished product, the following formulas are used:

$$( {C}_{concentrate} ) ( {V}_{concentrate} ) = ( {C}_{final product} ) ( {V}_{final product} )$$

$${V}_{concentrate} = \frac{( 1 ) ( {V}_{final product} )}{( {C}_{concentrate} )}$$

$$Where :$$

$${C}_{final product} = concentration of final product = 1 ( i . e . , 1 X )$$

$${V}_{final product} = desired volume of finised product$$

$${C}_{concentrate} = concentration of the concentrate ( 5 X , 10 X , or 20 X )$$

$${V}_{concentrate} = volume of concentrate to add to create finished product$$

### Example 3—VOCs and Non-VOCs in Reference Brandy Samples

GC-MS/MS and GC-LECO-TOF-MS were used to assess the amounts of various VOCs in traditional brandies.

GC-MS/MS Conditions: All analyses were performed using an Agilent 7890B GC interfaced with a 7000D Triple Quadrupole mass spectrometer, and equipped with a PAL RSI 85 autosampler with syringe attachment. The injection volume was 1.0 μL. Liquid injections had a split ratio of 1:20, with a desorption temperature of 250° C. The column was a 30 m×0.25 mm×0.25 Agilent DB-WAX (ultra inert). Helium was used as the carrier gas at a constant flow rate of 1.3 mL/min. The MS ion source temperature and interface temperature were 250° C. The temperature program was as follows: initial temperature 40° C., held for 2 minutes, then increased to 210° C. at a rate of 10° C./min, and held for 5 minutes, for a total run time of 24 minutes.

GC-LECO-70′-MS Conditions: All analyses were performed using an Agilent 7890B GC interfaced with a 7820 LECO-TOF mass spectrometer and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, PA). HS-SPME autosampler conditions were as follows: pre-incubation time of 5 minutes, incubation temperature of 60° C., extraction time of 15 minutes, and desorption time 5 minutes. Post-desorption fiber conditioning time was 30 minutes. SPME injections had a split ratio of 1:20, with a desorption temperature of 250° C. The columns were a 29.69 m×0.25 mm×0.25 Agilent Rxi-5MS column attached to a 1.09 m×0.25 mm×0.25 Agilent Rxi-17 Sil MS column. Helium was used as the carrier gas at a constant flow rate of 1 mL/min. The MS ion source temperature and interface temperature were 250° C. The temperature program was as follows: initial temperature 40° C., held for 2 minutes, then increased to 90° C. at a rate of 10° C./min and held for 2 min, then increased to 132° C. at a rate of 10° C./min and held for 2 min, then increased to 145° C. at a rate of 10° C./min and held for 2 min, and finally increased to 240° C. at a rate of 10° C./min held for 5 minutes, for a total run time of 33 minutes.

Selection of target compounds and MRM method development: An outline of the general workflow for GC-MS analyses is as follows. Real samples were first analyzed in full scan mode (m/z 15-550) on the GC/MS-LECO to identify potential target compounds. Collected data were analyzed manually using LECO ChromaTOF Software. Multiple Reaction Monitoring (MRM) optimization was performed for commercially available standards. First, full scan experiments were repeated with liquid injection (10 mg/L in either pure MeOH or DCM) to verify retention time and potential precursor ions. Product ion scans were performed using liquid injection and collision energy of 30 V. Optimized MRM transitions and collision energies were selected and are displayed in TABLES 2A and 2B. A dynamic MRM (dMRM) method was developed for the generation of calibration curves, as described below. Compounds were divided into nine methods (TABLES 2A and 2B respectively) to minimize simultaneous transitions (no greater than 6).

Preparation of calibration curves for GC-MS/MS: All calibration solutions were prepared as 1 mL in either pure MeOH or DCM in 2-mL amber vials. The concentration range was originally 1-1000 μg/L and then varied based on LOD and expected concentration per compound.

Preparation of calibration curves for GC-LECO-TOF-MS: All calibration solutions were prepared as 10 mL of 10% EtOH in milli-Q water in 20-mL amber vials, with 3 g of salt added to enhance volatility. This concentration of EtOH minimized swelling of the SPME fiber to maximize signal despite the dilution factor. The concentration range was 0.1-50 mg/L.

Quantification in real samples for GC-MS/MS: All samples (15 mL initial volume) were extracted with 3×5 mL DCM and the combined extract was dried with anhydrous magnesium sulfate. Then 1 mL of dried extract was transferred to a 2 mL amber auto vial and were analyzed using Agilent Quantitative Analysis (for QQQ). Values reported as not detected (ND) may are considered to be below the limits of detection (LODs) listed in TABLE 2A. LODs were approximated based on S/N ratios as generated by the MassHunter software.

Quantification in real samples for GC-LECO-TOF-MS: All samples (reference samples and replica samples) were prepared as 10 mL in 20-mL amber vials with 3 g of salt and were diluted (4×) in milli-Q water to achieve a final concentration of 10% EtOH. Concentrations were later corrected to account for the dilution factor of the sample. All data were collected in triplicate and were analyzed using Chroma-TOF software. Values reported as not detected (ND) are considered to be below the limits of detection (LODs) listed in TABLE 2B. LODs were approximated based on S/N ratios as generated by the Chroma-TOF software.

Various reference brandy samples were assayed by GC-MS; the levels of VOCs therein are shown in TABLES 3A and 3B. In these tables, each column is designated by a numeral that refers to a particular brandy.

TABLE 2A
GC/MS/MS Method Transitions and Figures of Merit

| Compound Method | | | | Calibration | |
|---|---|---|---|---|---|
| | RT | | Collision | Range | LOD |
| Name | (min) | Transition | Energy | (mg/L) | (mg/L) |
| phenethyl acetate | 15.01 | 104.0 → 103.0 | 30 | 0.02-1.0 | 0.02 |
| tetrahydrofurfuryl acetate | 12.221 | 70.0 → 41.0 | 30 | 0.1-1.0 | 0.1 |
| isobutyl propionate | 5.171 | 57.0 → 27.0 | 30 | 0.02-1.0 | 0.02 |
| propyl acetate | 3.649 | 61.0 → 43.0 | 30 | 0.02-1.0 | 0.02 |
| ethyl laurate | 15.271 | 88.0 → 61.0 | 30 | 0.02-1.0 | 0.02 |
| ethyl butyrate | 4.503 | 71.0 → 41.0 | 30 | 0.01-0.5 | 0.01 |
| phenethyl alcohol | 15.974 | 91.0 → 65.0 | 30 | 0.005-1.0 | 0.005 |
| isobutyl isobutyrate | 5.331 | 71.0 → 41.0 | 30 | 0.01-0.5 | 0.01 |
| hexyl 2-methylbutanoate | 10.263 | 103.0 → 43.0 | 30 | 0.01-0.5 | 0.01 |
| butyl isobutyrate | 6.188 | 89.0 → 43.0 | 30 | 0.01-0.5 | 0.01 |
| 2-pentylfuran | 7.464 | 81.0 → 53.0 | 30 | 0.01-0.5 | 0.01 |
| 2-heptanone | 6.68 | 58.0 → 43.0 | 30 | 0.005-0.5 | 0.005 |
| linalool | 11.786 | 93.0 → 51.0 | 30 | 0.001-1.00 | 0.001 |
| 2,3-pentanedione | 4.903 | 100.0 → 29.0 | 30 | 0.1-1.0 | 0.1 |
| methylcyclopentenolone | NA | NA | NA | NA | NA |
| eugenol | 18.559 | 164.0 → 77.0 | 30 | 0.02-1.0 | 0.02 |
| butyric acid | 12.926 | 60.0 → 42.0 | 30 | 0.05-1.0 | 0.05 |

TABLE 2B
GC-LECO-TOF-MS Figures of Merit
Compound Method

| | RT | Collision | Calibration | LOD |
|---|---|---|---|---|
| Name | (min) | Energy | Range (mg/L) | (mg/L) |
| phenylacetaldehyde | 10.267 | 70 | 0.1-50.0 | 0.1 |
| ethyl acetate | 2.590 | 70 | 0.1-50.0 | 0.1 |
| isoamyl alcohol | 4.079 | 70 | 0.1-50.0 | 0.1 |

TABLE 3A
VOCs in reference Brandies

| | Round 1 assays | | | | | | | |
|---|---|---|---|---|---|---|---|---|
| | (values in mg/L) | | | | | | | |
| | 1 | 2 | 3 | 4 | 5 | 6 | 7 | 8 |
| phenethyl acetate | 2.04E−01 | 2.10E−01 | 4.96E−01 | 9.80E−01 | 3.80E−01 | 2.71E−01 | 4.08E−01 | 1.58E+00 |
| tetrahydrofurfuryl acetate | ND | ND | ND | ND | ND | ND | ND | ND |
| isobutyl propionate | ND | ND | ND | ND | ND | ND | ND | ND |
| propyl acetate | 5.11E−02 | 1.93E−01 | 1.57E−01 | 2.44E−01 | 9.49E−02 | 7.45E−02 | 1.60E−01 | 3.73E−01 |
| ethyl laurate | 1.39E−01 | 1.44E+00 | 3.99E+00 | 5.51E+00 | 4.33E−01 | 4.33E−01 | 2.86E−01 | 1.07E+01 |
| ethyl butyrate | 7.23E−01 | 1.01E+00 | 1.15E+00 | 7.92E−01 | 6.51E−01 | 4.73E−01 | 8.49E−01 | 2.50E+00 |
| phenethyl alcohol | 8.27E+00 | 2.40E+01 | 1.82E+01 | 1.79E+01 | 4.80E+00 | 6.48E+00 | 7.85E+00 | 3.91E+01 |
| isobutyl isobutyrate | ND | ND | ND | ND | ND | ND | ND | ND |
| hexyl 2-methylbutanoate | ND | ND | ND | ND | ND | ND | ND | ND |
| butyl isobutyrate | ND | ND | ND | ND | ND | ND | ND | ND |
| 2-pentylfuran | ND | ND | ND | ND | ND | ND | ND | ND |
| 2-heptanone | ND | ND | ND | 9.10E−03 | ND | ND | ND | 1.41E−02 |
| linalool | 1.80E−01 | 1.20E−01 | 1.13E−01 | 9.67E−01 | 1.23E−01 | 1.09E−01 | 6.11E−02 | 3.29E−01 |
| 2,3-pentanedione | ND | ND | ND | ND | ND | ND | ND | 3.44E−01 |
| methylcyclopentenolone | BC | BC | BC | BC | BC | BC | BC | BC |
| eugenol | ND | ND | 5.22E−02 | 1.45E−01 | ND | ND | ND | 3.43E−02 |
| butyric acid | 3.27E−01 | 3.03E+00 | 2.56E+00 | 3.77E+00 | 1.42E+00 | 1.25E+00 | 7.57E−01 | 8.22E+00 |
| phenylacetaldehyde | ND | ND | ND | ND | ND | ND | ND | 5.60E−01 |
| ethyl acetate | 1.50E+00 | 2.61E+02 | 1.89E+02 | 2.43E+02 | 6.33E+01 | 6.60E+01 | 6.12E+01 | 2.90E+02 |
| isoamyl alcohol | 3.55E+01 | 2.62E+02 | 2.94E+02 | 2.89E+02 | 1.39E+02 | 4.08E+01 | 1.03E+02 | 2.12E+02 |

TABLE 3B
VOCs in reference Brandies

| | Round 1 assays | | | | | | | |
|---|---|---|---|---|---|---|---|---|
| | (values in mg/L) | | | | | | | |
| | 9 | 10 | 11 | 12 | 13 | 14 | 15 | 16 |
| phenethyl acetate | 4.82E−02 | 2.90E−01 | 1.72E−01 | ND | 1,42E−01 | 9.54E−01 | 3.07E−01 | 1.11E−01 |
| tetrahydrofurfuryl acetate | ND | ND | ND | ND | ND | ND | ND | ND |
| isobutyl propionate | ND | ND | ND | ND | ND | ND | ND | ND |
| propyl acetate | 7.93E−02 | 5.85E−02 | 4.79E−02 | 6.54E−02 | 1.26E−01 | 6.21E−02 | 6.99E−02 | 5.67E−02 |
| ethyl laurate | 8.12E+00 | 1.27E+00 | 1.28E+00 | 2.09E−01 | 7.50E−02 | 1.35E+00 | 1.21E+00 | 5.57E+00 |
| ethyl butyrate | 6.42E−01 | 4.88E−01 | 4.55E−01 | 5.35E−01 | 6.15E−01 | 5.97E−01 | 3.24E−01 | 5.33E−01 |
| phenethyl alcohol | 8.41E+00 | 6.26E+00 | 6.56E+00 | 1.23E+01 | 1.70E+01 | 6.66E+00 | 2.57E+00 | 9.38E+00 |
| isobutyl isobutyrate | ND | ND | ND | ND | ND | ND | ND | ND |
| hexyl 2-methylbutanoate | ND | ND | ND | ND | ND | ND | ND | ND |
| butyl isobutyrate | ND | ND | ND | ND | ND | ND | ND | ND |
| 2-pentylfuran | ND | ND | ND | ND | ND | ND | ND | ND |
| 2-heptanone | ND | 1.11E−02 | ND | ND | ND | ND | ND | ND |
| linalool | 1.18E−01 | 4.82E−02 | 6.87E−02 | 7.45E−02 | 4.78E−02 | 7.13E−02 | 1.13E−01 | 6.61E−02 |
| 2,3-pentanedione | ND | ND | ND | ND | ND | ND | ND | ND |
| methylcyclopentenolone | BC | BC | BC | BC | BC | BC | BC | BC |
| eugenol | ND | ND | ND | 2.14E−02 | ND | ND | ND | ND |
| butyric acid | 2.04E+00 | 2.65E+00 | 1.12E+00 | 3.64E−01 | 5.41E−01 | 1.26E+00 | 1.61E+00 | 5.19E+00 |
| phenylacetaldehyde | ND | ND | ND | ND | ND | ND | ND | ND |
| ethyl acetate | 1.69E+02 | 2.65E+00 | 2.05E+02 | 3.11E+00 | 2.60E+00 | 1.35E+02 | 7.48E+01 | 1.73E+02 |
| isoamyl alcohol | 3.46E+02 | 1.46E+02 | 3.84E+02 | 8.83E+01 | 3.83E+01 | 3.17E+02 | 1.66E+02 | 3.05E+02 |

BC = bad curve
ND = not detected or below limit of detection

LC-MS was used to measure the levels of various non-volatile compounds in several reference brandy samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods

Isolation window: 1.5 m/z

MS/MS collision energy: 30

Preparation of analytical standards: Stock solutions at a concentration of 10,000 mg/L were made for each compound in 50% methanol. Serial dilutions were then made of each compound to create a 6-point standard curve, ranging from 1-100 μg/L. Standard curves were run in combinations of 3-27 compounds from each category per set, so long as there were no overlaps in retention time, which would have hindered quantitation.

Retention times were pre-determined for each compound by running the analytical standard at a 20 μg/L dilution, and identifying the compound based on its accurate mass.

In all cases, 5 μL of each standard mix was injected through the autosampler and LC to the MS. Separation took place on a chromatographic column that was specific to each class of compounds (TABLE 4). The conditions for each chromatographic method are described below, including the column, mobile phase and gradient used for each method.

TABLE 4
List of compounds quantified by each method

| C18 positive | C18 negative |
|---|---|
| 3-hydroxypyridine | Quinic acid |
| Mannitol | Gallic acid |
| Mannoheptulose | Isoferulic acid |
| Trebalose | Scopoletin |
| 3-hydroxy-2-methylpyridine | Ethyl Paraben |
| diglycerol | |
| 1-(2-hydroxyethyl)-2-imidazolidenethione | |
| 2-aminobenzothiazole | |
| 2-mercapto-4,6-dimethylnicotinonitrile | |
| 4,4-dihydroxybenzophenone | |
| 4-methyl-2,3-dihydro-1H-pyrrolo[3,4-c]-quinoline | |
| Azobenzene | |
| Carnosine | |
| Choline | |
| Betaine | |
| Trigonelline | |
| Pyridoxal | |
| Nicotinic acid | |
| Furaneol | |
| 2,3-isopropylidene-D-ribonolactone | |
| 3-methylglutaric acid | |
| homovanillic acid | |
| Fraxetin | |
| Coniferyl aldehyde | |
| Cyclohexyl thiourea | |
| Cyanazine | |
| Dimethyl phthalate | |
| Isophorone | |
| 2,6-dimethyl-gamma-pyrone | |
| Vanillin | |

Quantitation of Non-Polar Compounds: A C18 column was used to assess all compounds. This method was run in both positive and negative modes (TABLE 4), depending on each compound and whether it ionizes better with a positive or negative charge, respectively. The mobile phases used for this method were A: H₂O+0.1% FA, and B: Methanol (TABLE 5), and the temperature of the column was held at 50° C. The column used was an Agilent Pursuit XRs, 5 C18, 4.6×150 mm (Product #A6000150X046).

TABLE 5
C18 positive/negative mode gradient conditions

| Time | Flow Rate (mL/min) | % A | % B |
|---|---|---|---|
| 0 | 0.5 | 90 | 10 |
| 1.5 | 0.5 | 90 | 10 |
| 11.5 | 0.5 | 0 | 100 |
| 16.5 | 0.5 | 0 | 100 |
| 16.6 | 0.5 | 90 | 10 |
| 19.0 | 0.5 | 90 | 10 |

Data analysis: Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected (TABLE 6).

TABLE 6
LODs for standards being quantified (in ug/mL)

| Cassette | Compound | LOD |
|---|---|---|
| 1 | 3-hydroxypyridine | 0.001 |
| 1 | Mannitol | 0.002 |
| 1 | Mannoheptulose | 0.002 |
| 1 | Trehalose | 0.002 |
| 1 | 3-hydroxy-2-methylpyridine | 0.001 |
| 1 | diglycerol | 0.001 |
| 1 | 1-(2-hydroxyethyl)-2-imidazolidenethione | 0.01 |
| 1 | 2-aminobenzothiazole | 0.002 |
| 1 | 2-mercapto-4,6-dimethylnicotinonitrile | 0.02 |
| 1 | 4,4-dihydroxybenzophenone | 0.002 |
| 1 | 4-methyl-2,3-dihydro-1H-pyrrolo[3,4-c]-quinoline | 0.001 |
| 1 | Azobenzene | 0.001 |
| 1 | 2,6-dimethyl-gamma-pyrone | 0.1 |
| 2 | Carnosine | 0.01 |
| 2 | Choline | 0.01 |
| 2 | Betaine | 0.001 |
| 2 | Trigonelline | 0.001 |
| 2 | Pyridoxal | 0.005 |
| 2 | Nicotinic acid | 0.001 |
| 2 | Furancol | 0.1 |
| 2 | 2,3-isopropylidene-D-ribonolactone | 0.02 |
| 2 | 3-methylglutaric acid | 0.05 |
| 2 | homovanillic acid | 0.05 |
| 2 | Fraxetin | 0.01 |
| 2 | Coniferyl aldehyde | 0.001 |
| 2 | Cyclohexyl thiourea | 0.002 |
| 2 | Cyanazine | 0.001 |
| 2 | Dimethyl phthalate | 0.005 |
| 2 | Isophorone | 0.001 |
| 3 | Quinic acid | 0.02 |
| 3 | Gallic acid | 0.01 |
| 4 | Isoferulic acid | 0.05 |
| 4 | Scopoletin | 0.001 |
| 4 | Ethyl Paraben | 0.001 |
| 5 | Vanillin | 0.5 |

TABLE 7A
LC-MS of reference Brandies
The average levels of the non-volatile compounds measured in reference Brandy samples are shown in TABLES 7A and 7B.

| | Round 1 assays | | | | | | | |
|---|---|---|---|---|---|---|---|---|
| | (values in mg/L) | | | | | | | |
| | 1 | 2 | 3 | 4 | 5 | 6 | 7 | 8 |
| 3-hydroxypyridine | 1.30E−01 | 1.22E−02 | 2.80E−01 | 1.45E−01 | 1.44E−02 | 1.04E−02 | 1.17E−02 | 6.85E−04 |
| Mannitol | 3.68E+00 | 4.04E+00 | 4.47E+00 | 2.10E+00 | 2.33E+00 | 1.09E+00 | 3.16E+00 | 4.59E−01 |
| Mannoheptulose | 2.00E−01 | 1.52E−01 | 4.76E−01 | 4.51E−01 | 1.31E−01 | 5.98E−01 | 1.25E−01 | 5.83E−01 |
| Trehalose | 7.36E+02 | 7.89E+01 | 1.44E+02 | 1.33E+01 | 6.32E+02 | 8.78E+01 | 6.39E+02 | 9.95E+02 |
| 3-hydroxy-2-methylpyridine | 1.97E−02 | 4.17E−03 | 8.84E−03 | 8.66E−03 | 4.65E−02 | 9.16E−02 | 4.82E−02 | 2.68E−03 |
| diglycerol | 1.80E−02 | 2.17E−03 | 2.44E−02 | 4.67E−03 | 5.94E−03 | 7.31E−02 | 4.97E−03 | 2.36E−01 |
| 1-(2-hydroxyethyl)-2- | 6.47E−02 | ND | 4.97E−02 | 5.59E−02 | 5.79E−02 | 5.10E−02 | 5.94E−02 | 5.89E−02 |
| imidazolidenethione | | | | | | | | |
| 2-aminobenzothiazole | 1.74E−02 | ND | ND | ND | 1.83E−02 | ND | 1.71E−02 | ND |
| 2-mercapto-4,6- | 7.31E−02 | ND | ND | 6.48E−02 | ND | ND | 7.48E−02 | ND |
| dimethylnicotinonitrile | | | | | | | | |
| 4,4-dihydroxy benzophenone | ND | ND | ND | ND | ND | ND | ND | ND |
| 4-methyl-2,3-dihydro-1H- | ND | 1.11E−02 | 1.34E−02 | 1.17E−02 | 1.13E−02 | ND | 1.02E−02 | ND |
| pyrrolo[3,4-c]-quinoline | | | | | | | | |
| Azobenzene | ND | ND | ND | 3.39E−01 | 3.58E−01 | ND | ND | ND |
| Carnosine | 2.92E+00 | 1.35E+00 | 2.19E+00 | 1.01E+00 | 1.34E+00 | 1.19E+00 | 1.10E+00 | 2.75E+00 |
| Choline | 8.33E−02 | 5.42E−01 | 2.50E+00 | 3.02E−01 | ND | 2.30E−01 | 1.36E−01 | ND |
| Betaine | 1.56E−02 | 3.73E−02 | 1.84E−01 | 1.05E−02 | ND | 9.17E−03 | ND | 1.27E−01 |
| Trigonelline | ND | 3.04E−01 | 1.33E+00 | 9.99E−03 | 3.68E−03 | 1.44E−01 | 7.82E−03 | ND |
| Pyridoxal | 2.04E−02 | 2.02E−02 | ND | ND | ND | 2.09E−02 | ND | ND |
| Nicotinic acid | 8.87E−02 | 1.07E−01 | 2.06E−01 | 3.25E−01 | 2.18E−02 | 2.31E−02 | 2.91E−02 | ND |
| Furaneol | 5.43E−01 | ND | 3.66E−01 | 3.13E−01 | 5.88E−01 | ND | 6.58E−01 | 4.96E−01 |
| 2,3-isopropylidene-D- | ND | 1.75E−01 | ND | 1.36E−01 | 1.57E−01 | 1.42E−01 | 1.46E−01 | ND |
| ribonolactone | | | | | | | | |
| 3-methylglutaric acid | ND | ND | ND | 4.26E−01 | 6.28E−01 | 4.61E−01 | ND | 5.04E−01 |
| homovanillic acid | 2.90E−01 | 3.70E−01 | ND | ND | ND | 3.44E−01 | 3.20E−01 | ND |
| Fraxetin | 9.91E−01 | 4.12E−01 | 3.92E+00 | 7.55E−01 | ND | 6.19E−01 | 9.37E−02 | 1.76E−01 |
| Coniferyl aldehyde | 1.25E+00 | 3.33E−01 | 1.61E+00 | 1.90E+00 | 4.87E−02 | 4.83E−02 | 2.73E−02 | 1.04E−02 |
| Cyclohexyl thiourea | 4.08E−02 | 3.30E−02 | 1.16E−01 | 5.23E−02 | ND | 4.23E−02 | ND | 3.10E−02 |
| Cyanazine | 1.27E−02 | 1.28E−02 | 1.76E−02 | 2.17E−02 | ND | ND | 1.55E−02 | 1.39E−02 |
| Dimethyl phthalate | ND | 6.29E−02 | ND | 6.16E−02 | ND | ND | ND | ND |
| Isophorone | 1.06E−01 | 1.13E−01 | 5.02E−02 | 8.17E−02 | 1.31E−01 | 8.08E−02 | 9.11E−02 | 1.35E−01 |
| 2,6-dimethyl-gamma-pyrone | ND | ND | ND | ND | ND | ND | ND | ND |
| Vanillin | 1.45E+00 | ND | 2.32E+00 | 4.41E+00 | 5.94E+01 | ND | 1.66E+01 | ND |
| Quinic acid | 1.27E+00 | 5.72E−01 | 5.70E−01 | 4.88E−01 | 4.16E−01 | 3.45E−01 | ND | ND |
| Gallic acid | 1.93E+00 | 2.55E+00 | 4.11E+00 | 5.34E+00 | 4.22E−01 | 5.80E−01 | 2.48E−01 | ND |
| Isoferulic acid | ND | ND | ND | ND | ND | ND | ND | ND |
| Scopoletin | 6.32E−03 | 2.17E−02 | 3.09E−02 | 8.47E−02 | 4.97E−03 | 6.07E−03 | ND | ND |
| Ethyl Paraben | ND | ND | 2.07E−02 | ND | ND | 1.54E−02 | 1.19E−02 | ND |

TABLE 7B
LC-MS of reference Brandies

| | Round 1 assays | | | | | | | |
|---|---|---|---|---|---|---|---|---|
| | (values in mg/L) | | | | | | | |
| | 9 | 10 | 11 | 12 | 13 | 14 | 15 | 16 |
| 3-hydroxypyridine | 1.16E−01 | 1.28E−01 | 8.29E−02 | 4.70E−02 | 1.20E−01 | 7.36E−02 | 2.02E−02 | 8.87E−02 |
| Mannitol | 2.03E+00 | 3.89E+00 | 1.93E+00 | 1.08E+00 | 2.44E+01 | 2.22E+00 | 1.99E+00 | 2.18E+00 |
| Mannoheptulose | 3.29E−01 | 1.39E−01 | 5.73E−01 | 7.33E−01 | 7.40E−01 | 3.45E−01 | 1.36E−01 | 3.33E−01 |
| Trehalose | 6.52E+02 | 5.11E+02 | 6.62E+02 | 2.90E+02 | 4.12E+02 | 7.03E+02 | 8.24E+02 | 6.14E+02 |
| 3-hydroxy-2-methylpyridine | 8.66E−03 | 1.05E−02 | 8.27E−03 | 4.59E−03 | 1.97E−02 | 1.10E−02 | 1.69E−02 | 7.32E−03 |
| diglycerol | 1.74E−03 | 7.87E−03 | 2.10E−03 | 1.95E−03 | 1.80E−02 | 8.15E−03 | 2.04E−02 | 1.78E−03 |
| 1-(2-hydroxyethyl)-2- | 6.17E−02 | 5.46E−02 | 5.98E−02 | ND | 5.47E−02 | 8.93E−02 | 5.29E−02 | 5.86E−02 |
| imidazolidenethione | | | | | | | | |
| 2-aminobenzothiazole | 1.72E−02 | ND | 1.78E−02 | 1.86E−02 | 1.74E−02 | 1.73E−02 | ND | 1.74E−02 |
| 2-mercapto-4,6- | ND | ND | 7.88E−02 | ND | ND | ND | ND | ND |
| dimethylnicotinonitrile | | | | | | | | |
| 4,4-dihydroxybenzophenone | 5.64E−02 | 5.05E−02 | 6.54E−02 | 4.27E−02 | ND | 4.42E−02 | 8.97E−02 | 4.99E−02 |
| 4-methyl-2,3-dihydro-1H- | ND | 1.33E−02 | ND | ND | ND | 1.21E−02 | 1.13E−02 | 9.67E−03 |
| pyrrolo[3,4-c]-quinoline | | | | | | | | |
| Azobenzene | ND | ND | 3.35E−01 | ND | ND | ND | ND | ND |
| Carnosine | 6.33E−01 | 1.22E+00 | 2.78E+00 | 2.68E+00 | 2.19E+00 | 1.98E+00 | 8.91E−01 | 4.20E+00 |
| Choline | ND | 1.40E−01 | 9.60E−02 | ND | 4.02E+00 | ND | ND | ND |
| Betaine | 1.74E−03 | 4.59E−02 | 2.44E−01 | 6.08E−02 | 4.96E−01 | 4.40E−01 | 4.62E−01 | 3.76E−01 |
| Trigonelline | ND | ND | ND | ND | 1.79E+00 | ND | ND | ND |
| Pyridoxal | ND | ND | ND | 2.79E−02 | 5.13E−02 | 1.87E−02 | 4.28E−02 | ND |
| Nicotinic acid | 1.43E−01 | 2.77E−01 | 1.29E−01 | 1.53E−01 | 4.18E−01 | 8.45E−02 | 5.27E−02 | 1.05E−01 |
| Furaneol | 5.92E−01 | 3.65E−01 | 5.21E−01 | ND | 4.49E−01 | ND | ND | ND |
| 2,3-isopropylidene-D- | 1.33E−01 | 1.52E−01 | ND | ND | 1.53E−01 | ND | 1.68E−01 | 1.57E−01 |
| ribonolactone | | | | | | | | |
| 3-methylglutaric acid | ND | ND | ND | 4.36E−01 | ND | ND | ND | 4.36E−01 |
| homovanillic acid | ND | 4.20E−01 | ND | 4.27E−01 | ND | 4.12E−01 | 4.08E−01 | 3.42E−01 |
| Fraxetin | 2.50E−01 | 7.44E−01 | 3.91E−01 | 4.76E−01 | 8.40E+00 | 1.82E−01 | 3.51E−01 | 2.92E−01 |
| Coniferyl aldehyde | 1.11E+00 | 1.88E+00 | 1.12E+00 | 1.45E+00 | 1.43E+00 | 3.88E−01 | 4.25E−02 | 1.05E+00 |
| Cyclohexyl thiourea | 3.08E−02 | 3.62E−02 | 3.11E−02 | 3.61E−02 | 3.02E−01 | ND | ND | ND |
| Cyanazine | 1.47E−02 | 3.52E−02 | 1.62E−02 | 3.00E−02 | 1.23E−01 | 1.92E−02 | 1.21E−02 | 2.31E−02 |
| Dimethyl phthalate | ND | ND | 6.86E−02 | ND | ND | ND | ND | ND |
| Isophorone | 6.75E−02 | 1.39E−01 | 1.10E−01 | 1.11E−01 | 9.98E−02 | 1.24E−01 | 1.18E−01 | 1.02E−01 |
| 2,6-dimethyl-gamma-pyrone | ND | ND | ND | ND | ND | ND | ND | ND |
| Vanillin | ND | 3.69E+00 | ND | 1.83E+00 | 8.73E+00 | ND | ND | ND |
| Quinic acid | 3.17E−01 | 6.36E+00 | 2.28E−01 | 5.56E−01 | 2.95E+00 | 4.23E+00 | 3.15E−01 | 9.14E−01 |
| Gallic acid | 4.42E+00 | 1.24E+01 | 4.57E+00 | 8.83E+00 | 5.06E+00 | 2.54E+00 | 1.39E+00 | 4.12E+00 |
| Isoferulic acid | ND | ND | ND | ND | ND | ND | ND | ND |
| Scopoletin | 7.95E−03 | 1.26E−02 | 5.66E−03 | 8.63E−03 | 5.29E−02 | ND | ND | 7.16E−03 |
| Ethyl Paraben | ND | ND | ND | ND | 1.13E−01 | ND | ND | ND |

ND = not detected or below limit of detection

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A brandy replica comprising:
water,
a grain neutral spirit,
an oak extract, one or more tannins, or an oak extract and one or more tannins,
fruit juice, and
at least six added volatile compounds (VOCs), wherein said added VOCs comprise at least one ester, at least one additional alcohol, at least one aldehyde or ketone, and at least one terpene or isoprenoid, and wherein said added VOCs comprise about 0.001 wt % to about 0.1 wt % of said brandy replica.

2. The brandy replica of claim 1, further comprising a traditional brandy, wherein said brandy replica comprises no more than about 10 wt % of said traditional brandy.

3. The brandy replica of claim 1 or claim 2, wherein said at least one ester comprises one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate.

4. The brandy replica of claim 1 or claim 2, wherein said at least one ester comprises one or more of ethyl acetate, ethyl laurate, phenethyl acetate, and tetrahydrofurfuryl acetate.

5. The brandy replica of claim 1 or claim 2, wherein said at least one ester comprises one or more of butyl isobutyrate, ethyl butyrate, hexyl 2-methylbutanoate, isobutyl isobutyrate, isobutyl propionate, and propyl acetate.

6. The brandy replica of any one of claims 1 to 5, wherein said at least one aldehyde or ketone comprises one or more of phenylacetaldehyde, 2,3-pentanedione, 2-heptanone, and methylcyclopentenolone.

7. The brandy replica of any one of claims 1 to 5, wherein said at least one aldehyde or ketone comprises 2,3-pentanedione.

8. The brandy replica of any one of claims 1 to 5, wherein said at least one aldehyde or ketone comprises 2-heptanone.

9. The brandy replica of any one of claims 1 to 8, wherein said at least one additional alcohol comprises one or both of isoamyl alcohol and phenethyl alcohol.

10. The brandy replica of any one of claims 1 to 8, wherein said at least one additional alcohol comprises phenethyl alcohol.

11. The brandy replica of any one of claims 1 to 8, wherein said at least one additional alcohol comprises isoamyl alcohol.

12. The brandy replica of any one of claims 1 to 11, wherein said at least one terpene or isoprenoid comprises linalool.

13. The brandy replica of any one of claims 1 to 12, wherein said added VOCs further comprise at least one furan, at least one acid, at least one phenol, or a combination thereof.

14. The brandy replica of claim 13, wherein said at least one furan comprises 2-pentylfuran.

15. The brandy replica of claim 13, wherein said at least one acid comprises butyric acid.

16. The brandy replica of claim 13, wherein said at least one phenol comprises eugenol.

17. The brandy replica of claim 1 or claim 2, wherein said added VOCs comprise at least one ester, at least one additional alcohol, at least one aldehyde or ketone, at least one terpene or isoprenoid, at least one phenol, and at least one furan.

18. The brandy replica of claim 17, wherein said added VOCs comprise ethyl laurate, phenethyl alcohol, 2-pentylfuran, linalool, 2,3-pentanedione, eugenol, and ethyl acetate.

19. The brandy replica of claim 1 or claim 2, wherein said added VOCs comprise at least one ester, at least one acid, at least one additional alcohol, at least one aldehyde or ketone, and at least one terpene or isoprenoid.

20. The brandy replica of claim 19, wherein said added VOCs comprise propyl acetate, ethyl butyrate, isobutyl isobutyrate, hexyl 2-methylbutanoate, butyl isobutyrate, 2-heptanone, linalool, butyric acid, and isoamyl alcohol.

21. The brandy replica of any one of claims 1 to 20, further comprising at least one added non-volatile compound.

22. The brandy replica of claim 21, wherein said at least one added non-volatile compound comprises a color compound.

23. The brandy replica of claim 21, wherein said at least one added non-volatile compound is selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole.

24. The brandy replica of claim 21, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin.

25. The brandy replica of claim 21, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin.

26. The brandy replica of claim 21, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

27. The brandy replica of any one of claims 1 to 26, comprising:
from about 5 wt % to about 70 wt % water,
from about 30 wt % to about 95 wt % grain neutral spirits,
from about 0.5 wt % to about 10 wt % traditional brandy,
from about 0.1 wt % to about 10 wt % oak extract,
from about 0.1 wt % to about 10 wt % fruit juice,
from about 0.001 wt % to about 1 wt % tannins,
from about 0.01 wt % to about 1 wt % color, and
from about 0.001 wt % to about 0.1 wt % added VOCs.

28. A brandy replica comprising:
water,
a grain neutral spirit,
an oak extract, one or more tannins, or an oak extract and one or more tannins,
fruit juice, and
at least six added VOCs, wherein said added VOCs comprise about 0.001 wt % to about 0.1 wt % of said brandy replica.

29. The brandy replica of claim 28, further comprising a traditional brandy, wherein said brandy replica comprises no more than about 10 wt % of said traditional brandy.

30. The brandy replica of claim 28 or claim 29, wherein said added VOCs comprise at least one VOC selected from the group consisting of tetrahydrofurfuryl acetate, isobutyl propionate, isobutyl isobutyrate, hexyl 2-methylbutanoate, butyl isobutyrate, and 2-pentylfuran.

31. The brandy replica of any one of claims 28 to 30, wherein said added VOCs comprise phenethyl alcohol, and wherein said phenethyl alcohol is present in said brandy replica at a concentration less than about 1.28 mg/L.

32. The brandy replica of any one of claims 28 to 31, wherein said added VOCs comprise 2,3-pentanedione, and wherein said 2,3-pentanedione is present in said brandy replica at a concentration less than about 0.17 mg/L.

33. The brandy replica of any one of claims 28 to 32, wherein said added VOCs comprise butyric acid, and wherein said butyric acid is present in said brandy replica at a concentration less than about 0.16 mg/L.

34. The brandy replica of any one of claims 28 to 33, wherein said added VOCs comprise propyl acetate, and wherein propyl acetate is present in said brandy replica at a concentration of at least about 0.75 mg/L.

35. The brandy replica of any one of claims 28 to 34, wherein said added VOCs comprise ethyl butyrate, and wherein said ethyl butyrate is present in said brandy replica at a concentration of at least about 5 mg/L.

36. The brandy replica of any one of claims 28 to 35, wherein said added VOCs comprise 2-heptanone, and wherein said 2-heptanone is present in said brandy replica at a concentration of at least about 0.03 mg/L.

37. The brandy replica of any one of claims 28 to 36, wherein said added VOCs comprise propyl acetate, and wherein said brandy replica comprises at least about 0.018% by mass of said propyl acetate.

38. The brandy replica of any one of claims 28 to 37, wherein said added VOCs comprise ethyl butyrate, and wherein said brandy replica comprises at least about 0.11% by mass of said ethyl butyrate.

39. The brandy replica of any one of claims 28 to 38, wherein said added VOCs comprise 2-heptanone, and wherein said brandy replica comprises at least about 0.00068% by mass of said 2-heptanone.

40. The brandy replica of any one of claims 28 to 39, wherein said added VOCs comprise eugenol, and wherein said brandy replica comprises at least about 0.007% by mass of said eugenol.

41. The brandy replica of any one of claims 28 to 40, further comprising an added non-volatile compound.

42. The brandy replica of claim 41, wherein said added non-volatile compound comprises trehalose, and wherein said trehalose is present in said brandy replica at a concentration less than about 6.67 mg/L.

43. The brandy replica of claim 41 or claim 42, wherein said added non-volatile compound comprises 3-hydroxy-2-methylpyridine, and wherein said 3-hydroxy-2-methylpyridine is present in said brandy replica at a concentration of at least about 0.18 mg/L.

44. The brandy replica of any one of claims 41 to 43, wherein said added non-volatile compound comprises 3-hydroxy-2-methylpyridine, and wherein said brandy replica comprises at least about 0.01% by mass of said 3-hydroxy-2-methylpyridine.

45. The brandy replica of any one of claims 41 to 44, wherein said added non-volatile compound comprises 4-methyl-2,3-dihydro-1H-pyrrolo[3,4-c]-quinoline, and wherein said brandy replica comprises at least about 0.00145% by mass of said 4-methyl-2,3-dihydro-1H-pyrrolo[3,4-c]-quinoline.

46. The brandy replica of any one of claims 41 to 45, wherein said added non-volatile compound comprises azobenzene, and wherein said brandy replica comprises at least about 0.04% by mass of said azobenzene.

47. The brandy replica of any one of claims 41 to 46, wherein said added non-volatile compound comprises furaneol, and wherein said brandy replica comprises at least about 0.07% by mass of said furaneol.

48. The brandy replica of any one of claims 41 to 47, wherein said added non-volatile compound comprises 2,3-isopropylidene-D-ribonolactone, and wherein said brandy replica comprises at least about 0.02% by mass of said 2,3-isopropylidene-D-ribonolactone.

49. The brandy replica of any one of claims 41 to 48, wherein said added non-volatile compound comprises homovanillic acid, and wherein said brandy replica comprises at least about 0.05% by mass of said homovanillic acid.

50. A method for making a brandy replica, wherein said method comprises combining:
water,
a grain neutral spirit,
an oak extract, a tannin, or an oak extract and a tannin,
a fruit juice,
at least six VOCs, wherein said VOCs are provided as separate ingredients and comprise at least one ester, at least one additional alcohol, at least one aldehyde or ketone, and at least one terpene or isoprenoid, and wherein said added VOCs comprise about 0.001 wt % to about 0.1 wt % of said brandy replica, and
optionally, a traditional brandy, such that said brandy replica comprises no more than about 10 wt % of said traditional brandy.

51. The method of claim 50, wherein said at least one ester comprises one or more of phenethyl acetate, ethyl laurate, ethyl acetate, tetrahydrofurfuryl acetate butyl isobutyrate, ethyl butyrate, hexyl 2-methylbutanoate, isobutyl isobutyrate, isobutyl propionate, and propyl acetate.

52. The method of claim 50, wherein said at least one ester comprises one or more of ethyl acetate, ethyl laurate, phenethyl acetate, and tetrahydrofurfuryl acetate.

53. The method of claim 50, wherein said at least one ester comprises one or more of butyl isobutyrate, ethyl butyrate, hexyl 2-methylbutanoate, isobutyl isobutyrate, isobutyl propionate, and propyl acetate.

54. The method of any one of claims 50 to 53, wherein said at least one aldehyde or ketone comprises one or more of phenylacetaldehyde, 2,3-pentanedione, 2-heptanone, and methylcyclopentenolone.

55. The method of any one of claims 50 to 53, wherein said at least one aldehyde or ketone comprises 2,3-pentanedione.

56. The method of any one of claims 50 to 53, wherein said at least one aldehyde or ketone comprises 2-heptanone.

57. The method of any one of claims 50 to 56, wherein said at least one additional alcohol comprises one or both of isoamyl alcohol and phenethyl alcohol.

58. The method of any one of claims 50 to 56, wherein said at least one additional alcohol comprises phenethyl alcohol.

59. The method of any one of claims 50 to 56, wherein said at least one additional alcohol comprises isoamyl alcohol.

60. The method of any one of claims 50 to 59, wherein said at least one terpene or isoprenoid comprises linalool.

61. The method of any one of claims 50 to 60, wherein said added VOCs further comprise at least one furan, at least one acid, at least one phenol, or a combination thereof.

62. The method of claim 61, wherein said at least one furan comprises 2-pentylfuran.

63. The method of claim 61, wherein said at least one acid comprises butyric acid.

64. The method of claim 61, wherein said at least one phenol comprises eugenol.

65. The method of claim 50, wherein said added VOCs comprise at least one ester, at least one additional alcohol, at least one aldehyde or ketone, at least one terpene or isoprenoid, at least one phenol, and at least one furan.

66. The method of claim 65, wherein said added VOCs comprise ethyl laurate, phenethyl alcohol, 2-pentylfuran, linalool, 2,3-pentanedione, eugenol, and ethyl acetate.

67. The method of claim 50, wherein said added VOCs comprise at least one ester, at least one acid, at least one additional alcohol, at least one aldehyde or ketone, and at least one terpene or isoprenoid.

68. The method of claim 67, wherein said added VOCs comprise propyl acetate, ethyl butyrate, isobutyl isobutyrate, hexyl 2-methylbutanoate, butyl isobutyrate, 2-heptanone, linalool, butyric acid, and isoamyl alcohol.

69. The method of any one of claims 50 to 68, further comprising combining at least one added non-volatile compound with said water, grain neutral spirit, oak extract and/or tannin, fruit juice, at least six VOCs, and optional traditional brandy.

70. The method of claim 69, wherein said at least one added non-volatile compound comprises a color compound.

71. The method of claim 69, wherein said at least one added non-volatile compound is selected from the group consisting of 2-mercapto-4,6-dimethylnicotinonitrile, 4,4-dihydroxybenzophenone, 4-methyl-2,3-dihydro-1h-pyrrolo[3,4-c]-quinoline, azobenzene, carnosine, choline, betaine, trigonelline, pyridoxal, nicotinic acid, furaneol, 2,3-isopropylidene-d-ribonolactone, 3-methylglutaric acid, homovanillic acid, fraxetin, coniferyl aldehyde, cyclohexyl thiourea, cyanazine, dimethyl phthalate, isophorone, 2,6-dimethyl-gamma-pyrone, vanillin, quinic acid, gallic acid, isoferulic acid, scopoletin, ethyl paraben, 3-hydroxypyridine, mannitol, mannoheptulose, trehalose, 3-hydroxy-2-methylpyridine, diglycerol, 1-(2-hydroxyethyl)-2-imidazolidenethione, and 2-aminobenzothiazole.

72. The method of claim 69, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 2-mercapto-4,6-dimethylnicotinonitrile, 4,4-dihydroxybenzophenone, carnosine, choline, betaine, nicotinic acid, furaneol, 2,3-isopropylidene-D-ribonolactone, 3-methylglutaric acid, fraxetin, coniferyl aldehyde, dimethyl phthalate, isophorone, vanillin, and scopoletin.

73. The method of claim 69, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, 4-methyl-2,3-dihydro-1H-pyrrolo[3,4-c]-quinoline, azobenzene, choline, betaine, nicotinic acid, furaneol, 2,3-isopropylidene-D-ribonolactone, homovanillic acid, coniferyl aldehyde, isophorone, and scopoletin.

74. The method of claim 69, wherein said at least one added non-volatile compound is selected from the group consisting of 3-hydroxypyridine, mannitol, mannoheptulose, trehalose, 3-hydroxy-2-methylpyridine, diglycerol, 1-(2-hydroxyethyl)-2-imidazolidenethione, choline, betaine, nicotinic acid, furaneol, 2,3-isopropylidene-D-ribonolactone, coniferyl aldehyde, isophorone, and scopoletin.

75. The method of any one of claims 50 to 74, wherein said brandy replica comprises:
from about 5 wt % to about 70 wt % water,
from about 30 wt % to about 95 wt % grain neutral spirits,
from about 0.5 wt % to about 10 wt % traditional brandy,
from about 0.1 wt % to about 10 wt % oak extract,
from about 0.1 wt % to about 10 wt % fruit juice,
from about 0.001 wt % to about 1 wt % tannins,
from about 0.01 wt % to about 1 wt % color, and
from about 0.001 wt % to about 0.1 wt % added VOCs.

76. A method for making a brandy replica, wherein said method comprises combining:
water,
a grain neutral spirit,
an oak extract, a tannin, or an oak extract and a tannin,
a fruit juice,
at least six VOCs, wherein said VOCs are provided as separate ingredients, and wherein said VOCs comprise about 0.001 wt % to about 0.1 wt % of said brandy replica, and
optionally, a traditional brandy, wherein said brandy replica comprises no more than about 10 wt % of said traditional brandy.

77. The method of claim 76, wherein said added VOCs comprise at least one VOC selected from the group consisting of tetrahydrofurfuryl acetate, isobutyl propionate, isobutyl isobutyrate, hexyl 2-methylbutanoate, butyl isobutyrate, and 2-pentylfuran.

78. The method of claim 76 or claim 77, wherein said added VOCs comprise phenethyl alcohol, and wherein said phenethyl alcohol is present in said brandy replica at a concentration less than about 1.28 mg/L.

79. The method of any one of claims 76 to 78, wherein said added VOCs comprise 2,3-pentanedione, and wherein said 2,3-pentanedione is present in said brandy replica at a concentration less than about 0.17 mg/L.

80. The method of any one of claims 76 to 79, wherein said added VOCs comprise butyric acid, and wherein said butyric acid is present in said brandy replica at a concentration less than about 0.16 mg/L.

81. The method of any one of claims 76 to 80, wherein said added VOCs comprise propyl acetate, and wherein propyl acetate is present in said brandy replica at a concentration of at least about 0.75 mg/L.

82. The method of any one of claims 76 to 81, wherein said added VOCs comprise ethyl butyrate, and wherein said ethyl butyrate is present in said brandy replica at a concentration of at least about 5 mg/L.

83. The method of any one of claims 76 to 82, wherein said added VOCs comprise 2-heptanone, and wherein said 2-heptanone is present in said brandy replica at a concentration of at least about 0.03 mg/L.

84. The method of any one of claims 76 to 83, wherein said added VOCs comprise propyl acetate, and wherein said brandy replica comprises at least about 0.018% by mass of said propyl acetate.

85. The method of any one of claims 76 to 84, wherein said added VOCs comprise ethyl butyrate, and wherein said brandy replica comprises at least about 0.11% by mass of said ethyl butyrate.

86. The method of any one of claims 76 to 85, wherein said added VOCs comprise 2-heptanone, and wherein said brandy replica comprises at least about 0.00068% by mass of said 2-heptanone.

87. The method of any one of claims 76 to 86, wherein said added VOCs comprise eugenol, and wherein said brandy replica comprises at least about 0.007% by mass of said eugenol.

88. The method of any one of claims 76 to 87, further comprising combining an added non-volatile compound with said water, grain neutral spirit, oak extract and/or tannin, fruit juice, at least six VOCs, and optional traditional brandy.

89. The method of claim 88, wherein said added non-volatile compound comprises trehalose, and wherein said trehalose is present in said brandy replica at a concentration less than about 6.67 mg/L.

90. The method of claim 88 or claim 89, wherein said added non-volatile compound comprises 3-hydroxy-2-methylpyridine, and wherein said 3-hydroxy-2-methylpyridine is present in said brandy replica at a concentration of at least about 0.18 mg/L.

91. The method of any one of claims 88 to 90, wherein said added non-volatile compound comprises 3-hydroxy-2-methylpyridine, and wherein said brandy replica comprises at least about 0.01% by mass of said 3-hydroxy-2-methylpyridine.

92. The method of any one of claims 88 to 91, wherein said added non-volatile compound comprises 4-methyl-2,3-dihydro-1H-pyrrolo[3,4-c]-quinoline, and wherein said brandy replica comprises at least about 0.00145% by mass of said 4-methyl-2,3-dihydro-1H-pyrrolo[3,4-c]-quinoline.

93. The method of any one of claims 88 to 92, wherein said added non-volatile compound comprises azobenzene, and wherein said brandy replica comprises at least about 0.04% by mass of said azobenzene.

94. The method of any one of claims 88 to 93, wherein said added non-volatile compound comprises furaneol, and wherein said brandy replica comprises at least about 0.07% by mass of said furaneol.

95. The method of any one of claims 88 to 94, wherein said added non-volatile compound comprises 2,3-isopropylidene-D-ribonolactone, and wherein said brandy replica comprises at least about 0.02% by mass of said 2,3-isopropylidene-D-ribonolactone.

96. The method of any one of claims 88 to 95, wherein said added non-volatile compound comprises homovanillic acid, and wherein said brandy replica comprises at least about 0.05% by mass of said homovanillic acid.

97. An brandy replica produced by the method of any one of claims 50 to 96.

98. A brandy-like alcoholic beverage concentrate comprising:
an oak extract,
fruit juice,
tannins,
at least six added VOCs, wherein said added VOCs comprise at least one ester, at least one additional alcohol, at least one aldehyde or ketone, and at least one terpene or isoprenoid, and wherein at least one of said added VOCs is present in a concentration of at least about 2-fold the concentration of the same VOC in a corresponding traditional brandy, and
optionally, a traditional brandy, wherein said alcoholic beverage, after dilution to produce a final product, comprises no more than about 10 wt %4 of said traditional brandy.

99. The brandy-like alcoholic beverage concentrate of claim 98, wherein at least one of said added VOCs is present in the concentrate in a concentration of at least about 5-fold the concentration of the same VOCs in a corresponding traditional brandy.

100. The brandy-like alcoholic beverage concentrate of claim 98, wherein at least one of said added VOCs is present in the concentrate in a concentration of at least about 10-fold the concentration of the same VOCs in a corresponding traditional brandy.

101. The brandy-like alcoholic beverage concentrate of claim 98, wherein at least one of said added VOCs is present in the concentrate in a concentration of at least about 15-fold the concentration of the same VOCs in a corresponding traditional brandy.

102. The brandy-like alcoholic beverage of any one of claims 98 to 101, wherein upon dilution of said brandy-like beverage concentrate to a brandy-like alcoholic beverage, the brandy-like alcoholic beverage is the brandy replica of any one of claims 1 to 49.

103. A method of making a brandy-like alcoholic beverage concentrate, the method comprising combining:
an oak extract,
fruit juice,
tannins,
at least six added VOCs, wherein said added VOCs comprise at least one ester, at least one additional alcohol, at least one aldehyde or ketone, and at least one terpene or isoprenoid, and wherein at least one of said added VOCs is present in a concentration of at least about 2-fold the concentration of the same VOC in a corresponding traditional brandy, and
optionally, a traditional brandy, wherein said alcoholic beverage, after dilution to produce a final product, comprises no more than about 10 wt % of said traditional brandy.

104. The method of claim 103, wherein at least one of said added VOCs is present in the concentrate in a concentration of at least about 5-fold the concentration of the same VOCs in a corresponding traditional brandy.

105. The method of claim 103, wherein at least one of said added VOCs is present in the concentrate in a concentration of at least about 10-fold the concentration of the same VOCs in a corresponding traditional brandy.

106. The method of claim 103, wherein at least one of said added VOCs is present in the concentrate in a concentration of at least about 15-fold the concentration of the same VOCs in a corresponding traditional brandy.

107. The method of any one of claims 103 to 106, wherein upon dilution of the brandy-like beverage concentrate to a brandy-like alcoholic beverage, the brandy-like alcoholic beverage is the brandy replica of any one of claims 1 to 49.
